(19) United States
(12) Patent Application Publication
(10) Pub. No.: US 2024/0180136 A1
(43) Pub. Date: Jun. 6, 2024

(54) FOOT OPERATED FISHING REEL & FIGHTING CHAIR

(71) Applicant: Cristopher Scott Southers, Port Aransas, TX (US)

(72) Inventor: Cristopher Scott Southers, Port Aransas, TX (US)

(21) Appl. No.: 18/487,221

(22) Filed: Oct. 16, 2023

Related U.S. Application Data
(60) Provisional application No. 63/416,245, filed on Oct. 14, 2022.

(51) Int. Cl. A01K 97/22; A01K 89/06

(52) U.S. Cl. CPC A01K 97/22; A01K 89/06

(57) ABSTRACT

An adapter designed with and around chains, belts and gears connects to conventional fishing reel to retrieve fishing line using foot pedal rotation. The pedals may be attached to a fighting chair that couples rotational energy from rotating pedals in only one direction to cause the fishing reel to retrieve line.

### CROSS-REFERENCES TO RELATED APPLICATIONS

Benefit is claimed from U.S. provisional patent application No. 63/416,245 filed Oct. 14, 2022, incorporated by reference.

### STATEMENT REGARDING FEDERALLY SPONSORED RESEARCH OR DEVELOPMENT

### Background

A fighting chair is typically fastened to the deck of a fishing boat for use by an angler to catch large fish. A good description of the structure, use and operation of a prior art fighting chair can be found in U.S. Pat. No. 5,647,161, now in the public domain and incorporated herein by reference in its entirety for all purposes.

Generally, an angler sits in and is often strapped into the fighting chair. The angler typically holds a rod and reel combination that is mounted to a rod holder often located between the legs of the angler and retained by straps. The rod holder is gimbal-mounted to the fighting chair so the angler can change the angle of the rod relative to horizontal to apply leverage to a fishing line threaded through eyelets of the rod. The fighting chair is rotatable about at least a vertical axis on its pedestal so an assistant can rotate the fighting chair toward the direction of a fish that is running astern of the boat (the chair thus is said to “follow the fish”). Some fighting chairs are also gimbaled to be rotatable forward and back to provide adjustable pitch (i.e., deviation from horizontal) so the angler can shift their weight forward and backwards to change the horizontal angle of the chair and thus the rod.

To fish from a fighting chair, an assistant can throw a hooked (and baited or lured) fishing line attached to a spool of a fishing reel attached to the rod, into the water behind the stern of the boat to troll for fish. Once a fish is hooked, it runs against the drag provide by the fishing reel and tires. When the fishing line goes slack, the angler begins rotating the reel's handle to retrieve the fishing line onto the spool and continue to “fight” with the fish to eventually bring the fish up to the boat where it can be gaffed or netted.

The '161 patent recognizes that most fighting chairs rely primarily on the muscles of the upper body including the arms and back to pull the fish toward the boat. However, some combat veterans have lost one or both arms due to injuries. Conditions other than amputation can also prevent or impede a person from using their upper body to reel in a fish when the person is seated in a fighting chair.

There are many examples of power-assisted (“electric”) fishing reels that use an electric motor to retrieve fishing line. See e.g., U.S. Pat. No. 7,886,478. However, a big part of the fun of fighting and landing a fish is manually controlling the rate at which the fishing line is retrieved in order to slowly tire the fish as it is running behind the boat. Activating an electric motor power-assist fishing line retrieval feature on a reel is not at all the same as manually retrieving the fishing line. Moreover, tournaments that operate under the International Game Fish Association require power accessories to be physically removed from the reel before the act of hooking or fighting a fish. Under those guidelines, any fish that strikes a bait or lure being fished with a reel with power accessories still attached-whether or not under electric operation—will not be eligible for record consideration. See e.g., igfa.org/2021/02/24/igfa-adopts-new-language-for-electric-reels/

See Additional References: see U.S. Pat. Nos. 3,196,571 and 5,647,161.

Accordingly, while much work has been done in the past to assist disabled or physically challenged people to fish, further improvements are needed. A chair is needed that will allow a physically challenged person to obtain their passion back for fishing and/or create a new passion that they had possibly accepted could never be possible in their future. With our veterans' suicide rate at an all-time high, we need to show that there are still people willing to sacrifice everything for them just like they did for us.

### BRIEF DESCRIPTION OF THE DRAWINGS

FIG. 1 shows a prior art offshore fishing reel.

FIG. 2A is a schematic illustration of a foot-pedal-operated fishing apparatus.

FIG. 2B shows an example mechanical coupling of a fishing reel spool to a pedal-operated gear external of the fishing reel.

FIG. 2C shows an adapter assembly for an example fishing reel.

FIG. 2D shows an example arrangement for mechanically directly coupling a pedal apparatus to a fishing reel.

FIG. 2E shows a cross-section of a directly coupled fishing reel and internal line spool.

FIG. 3A is a top perspective view of a leg powered fighting chair.

FIG. 3B is a side perspective view of the leg powered fighting chair.

FIG. 3C is a side perspective view of a pedal operated mechanism.

FIG. 3D is another side perspective view of the pedal operated mechanism.

FIGS. 4A, 4B, 4C show a further embodiment of a pedal operated mechanism coupled to a fishing reel.

FIGS. 5A and 5B show arrangements for coupling external manual rotation to a conventional fishing reel.

FIG. 6 shows alternative mounting of a fighting chair for dock or shoreline use.

FIGS. 7-51 are together a flip chart animation of an example operation of a foot operated fishing reel.

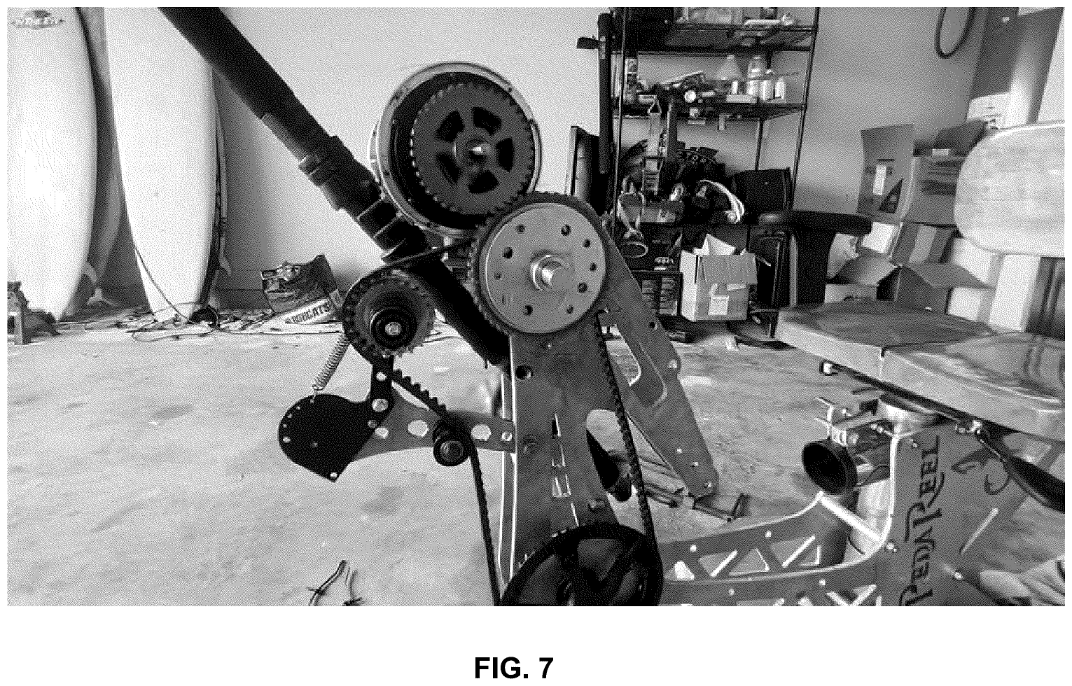

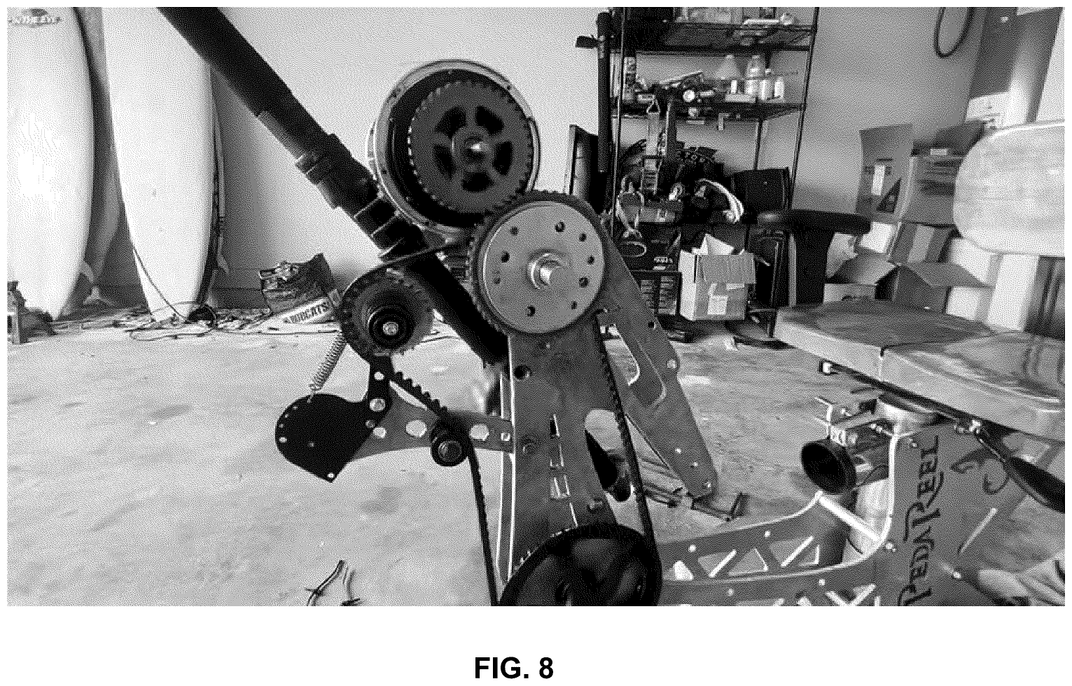

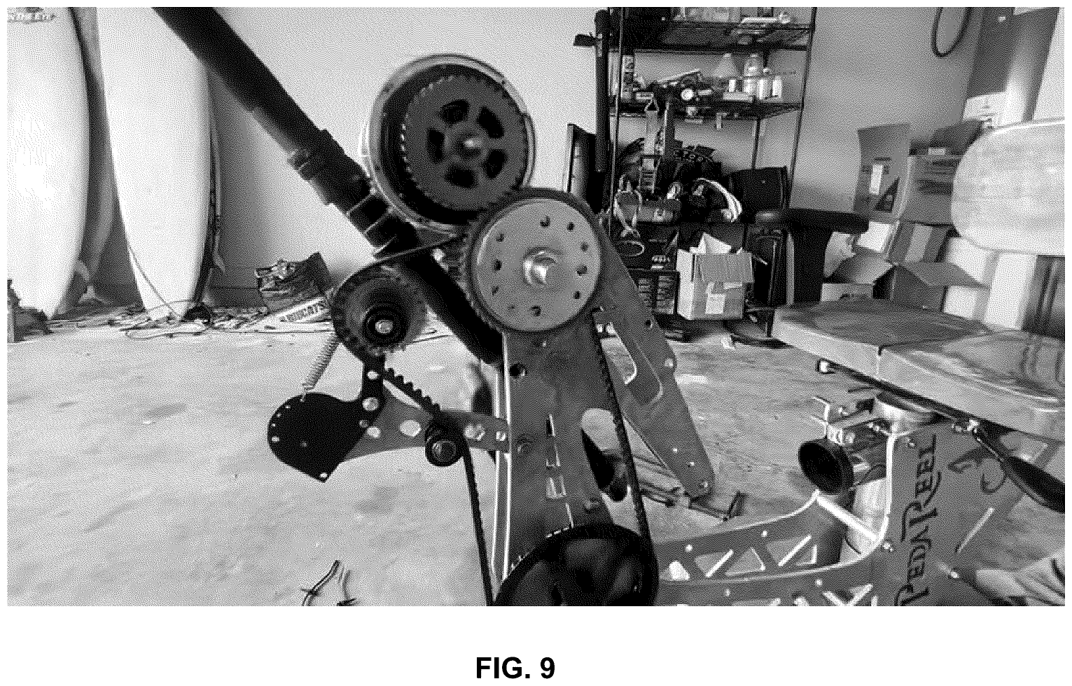

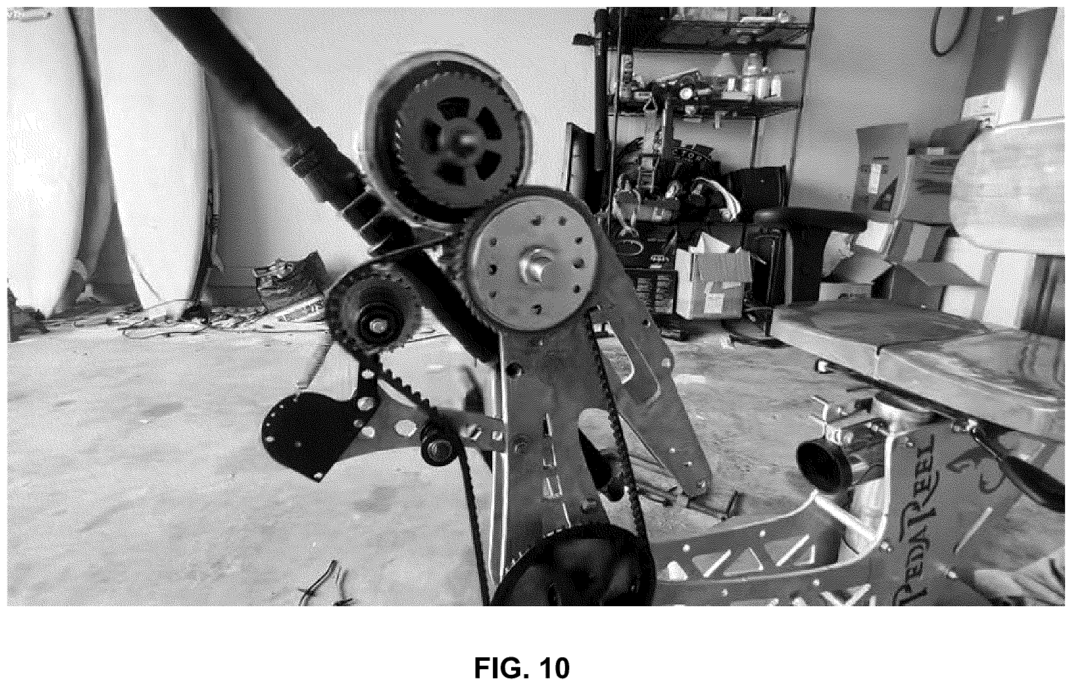

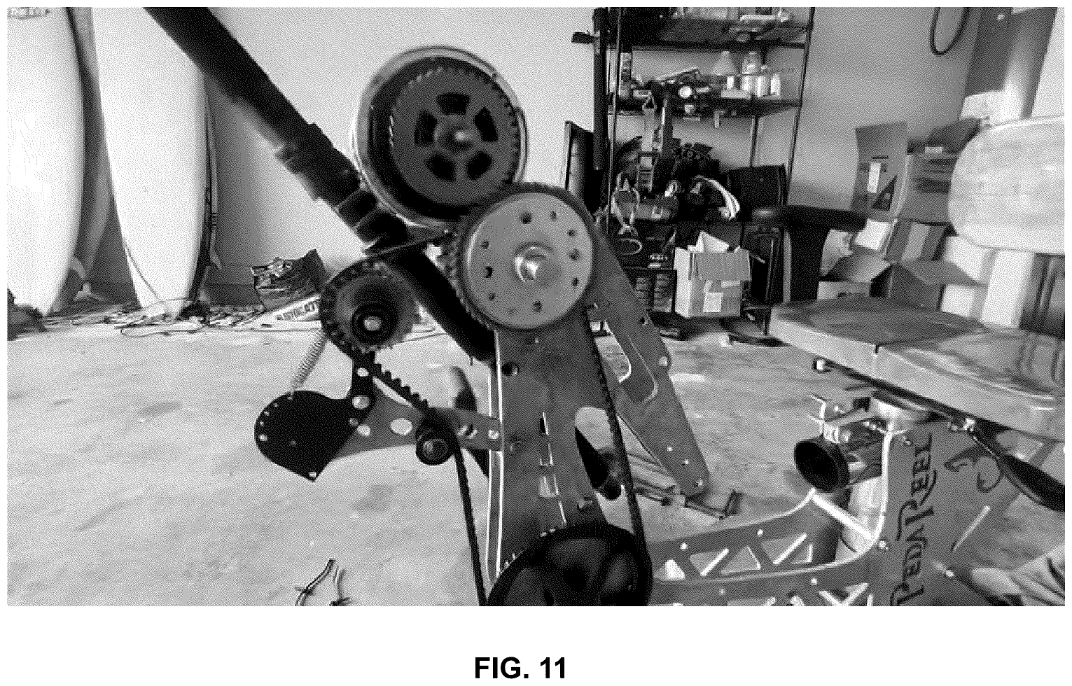

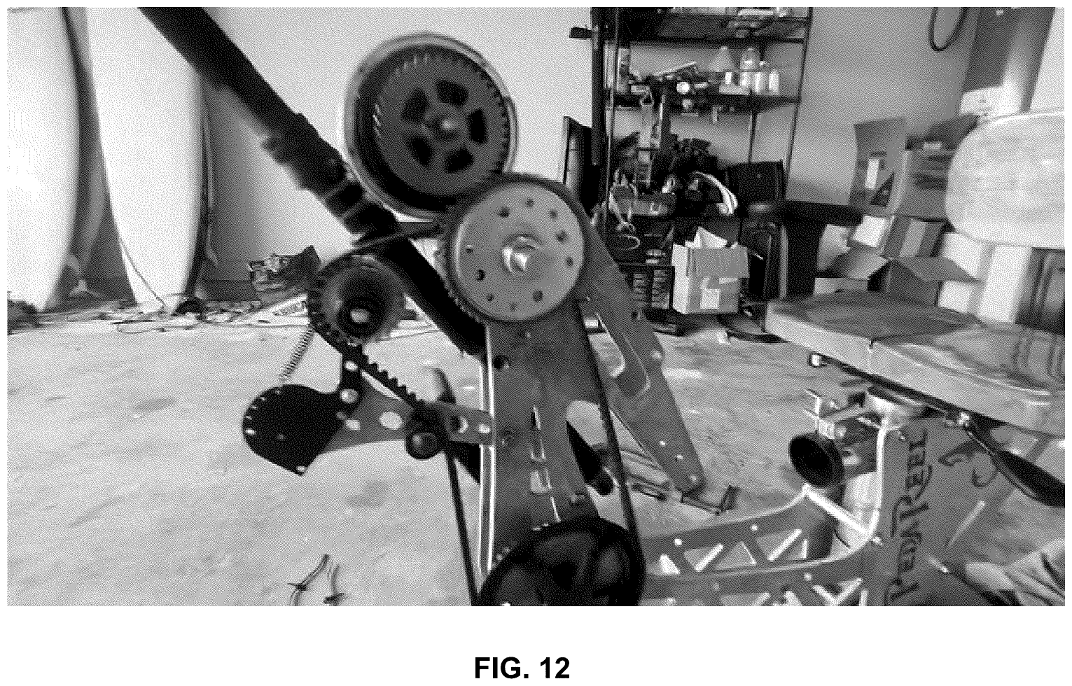

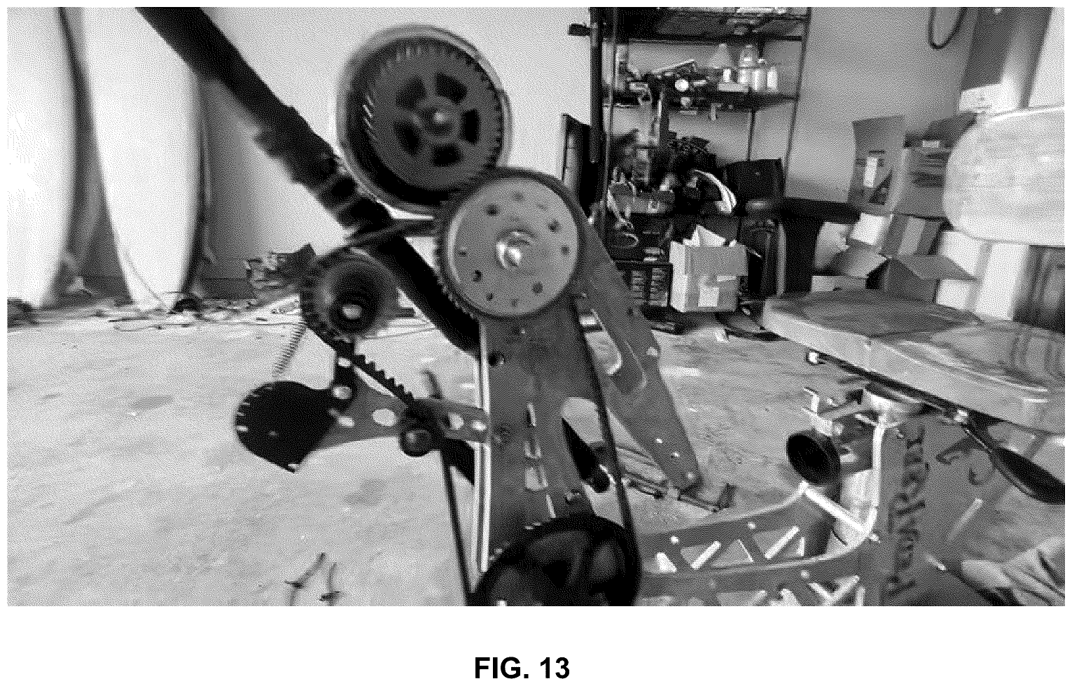

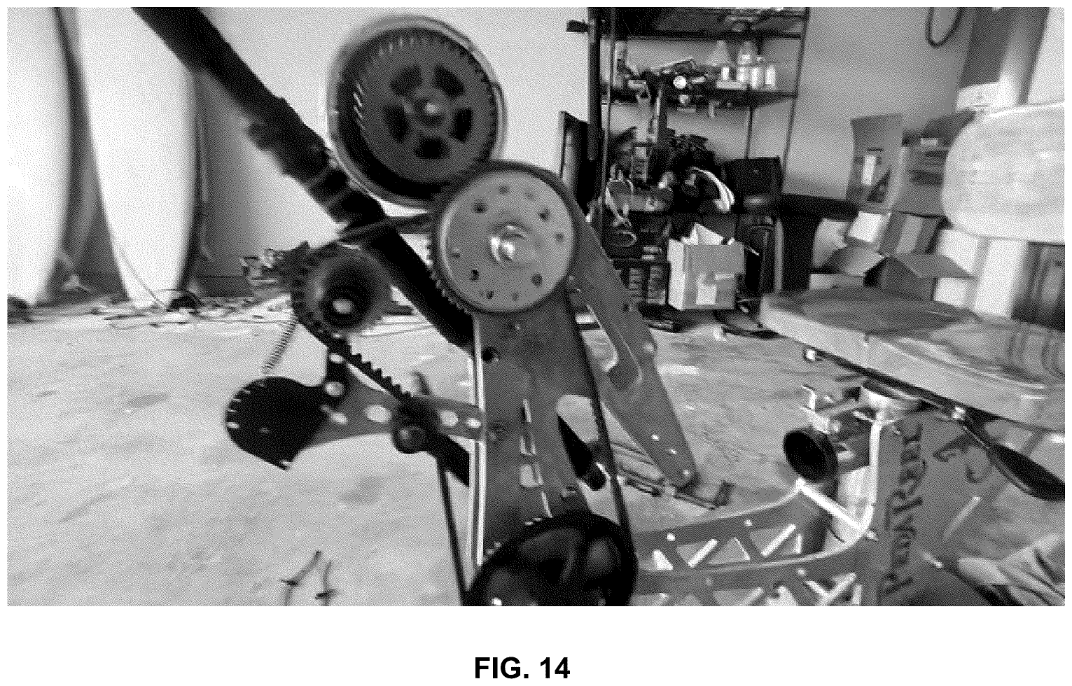

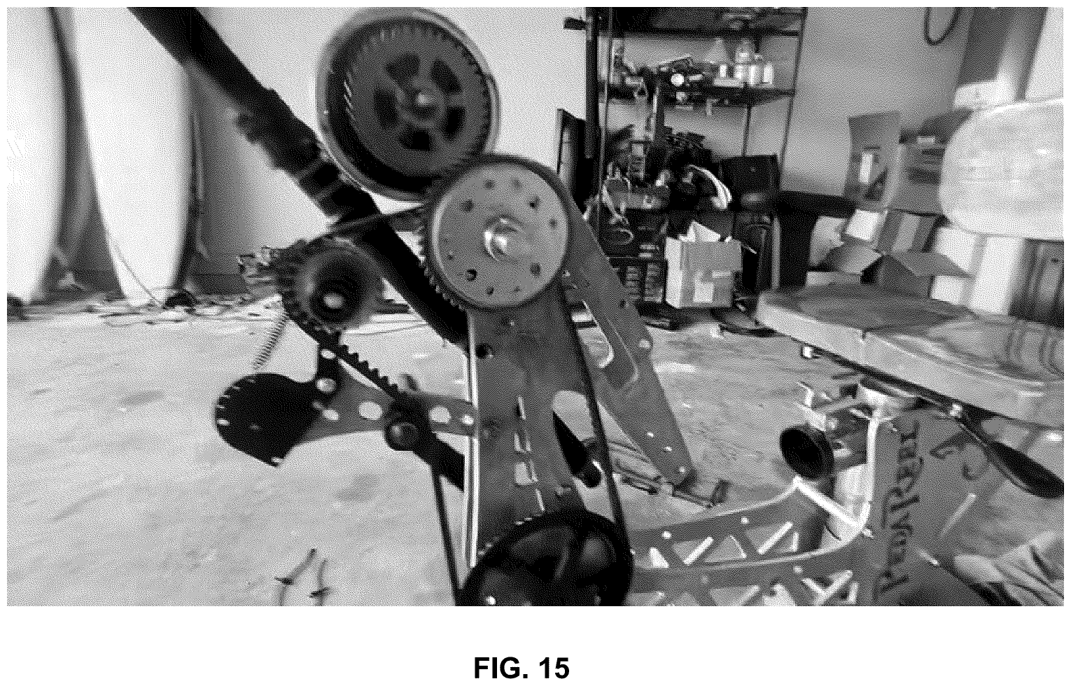

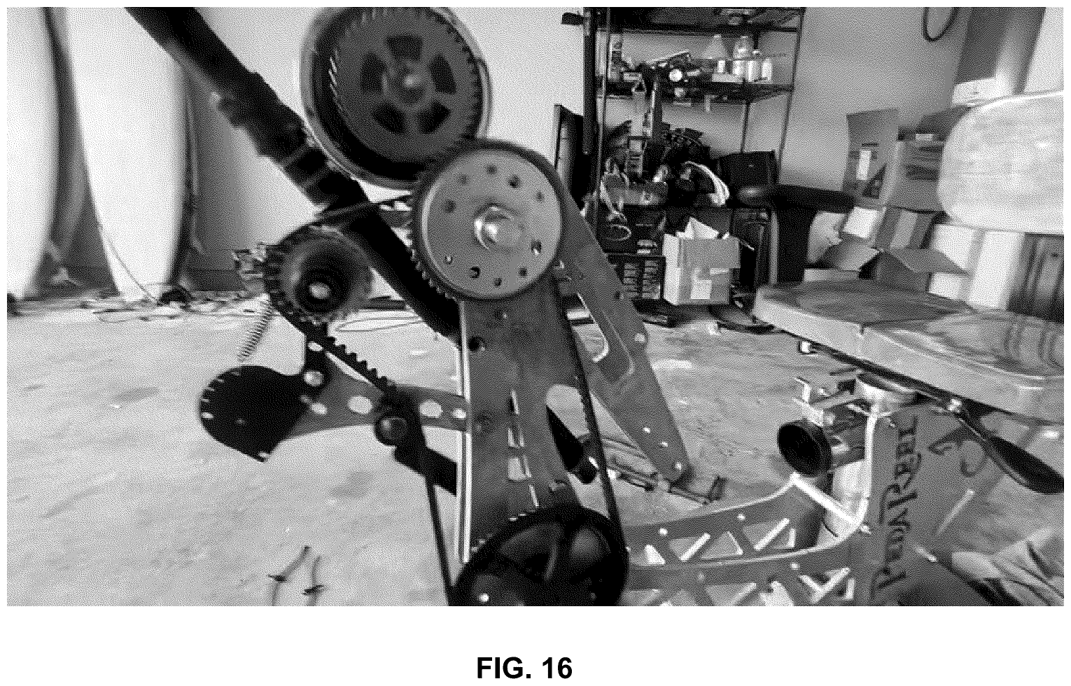

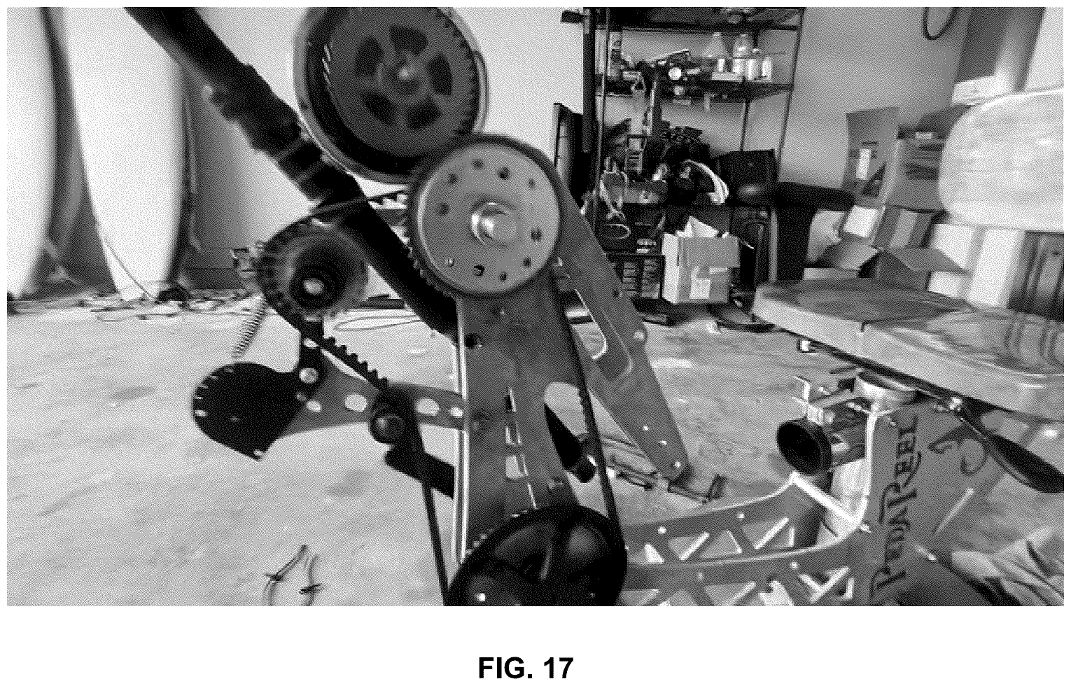

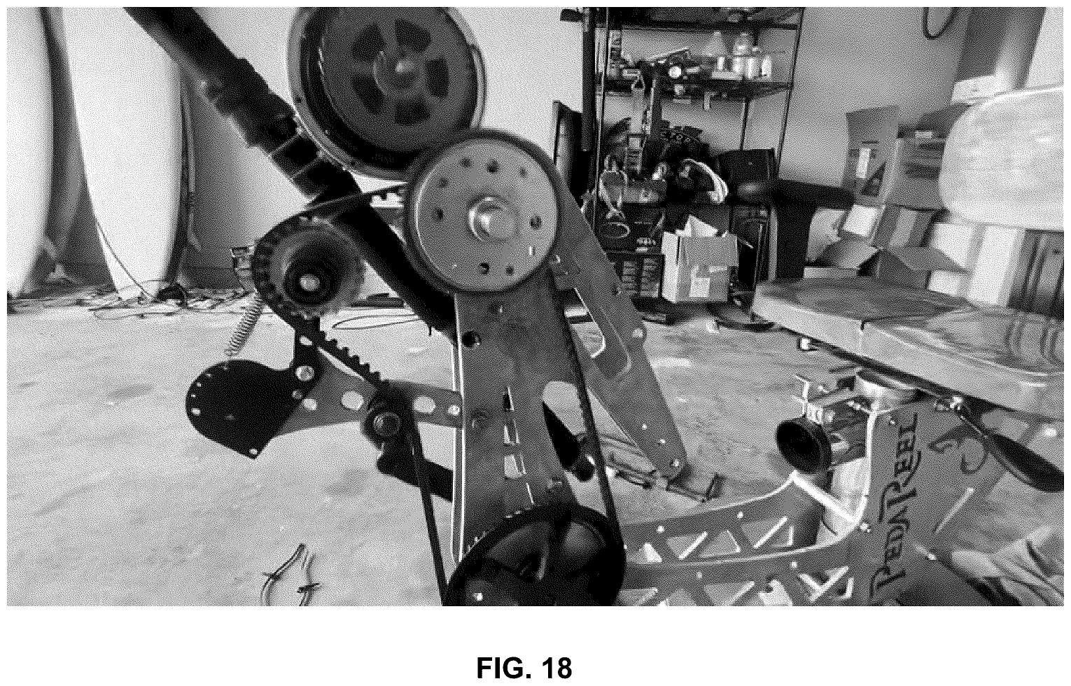

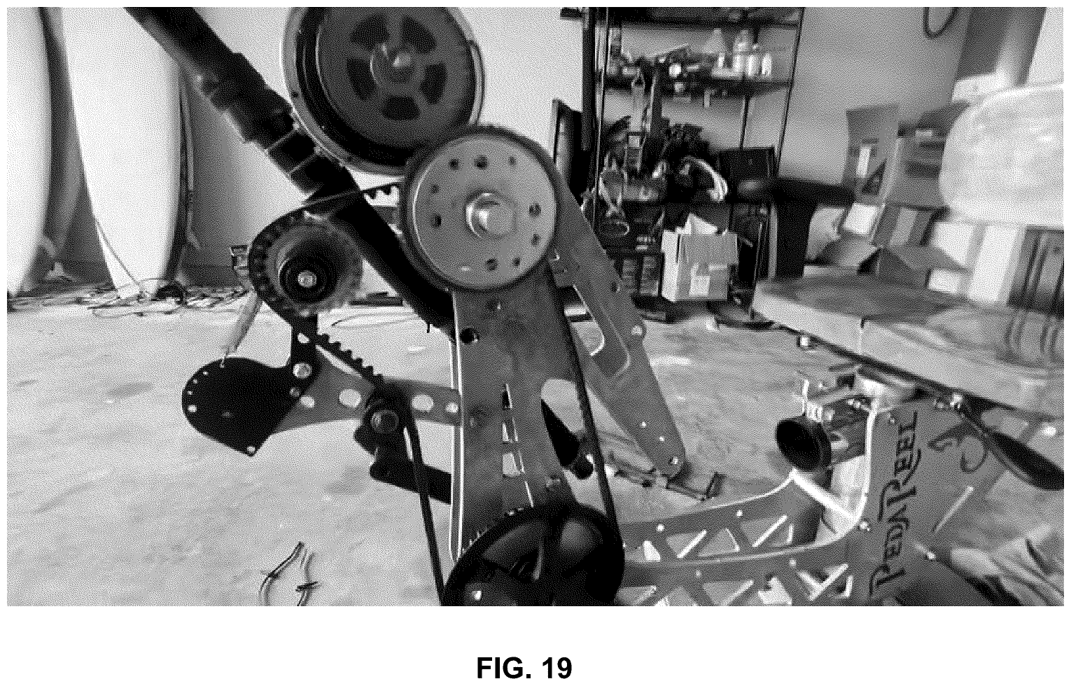

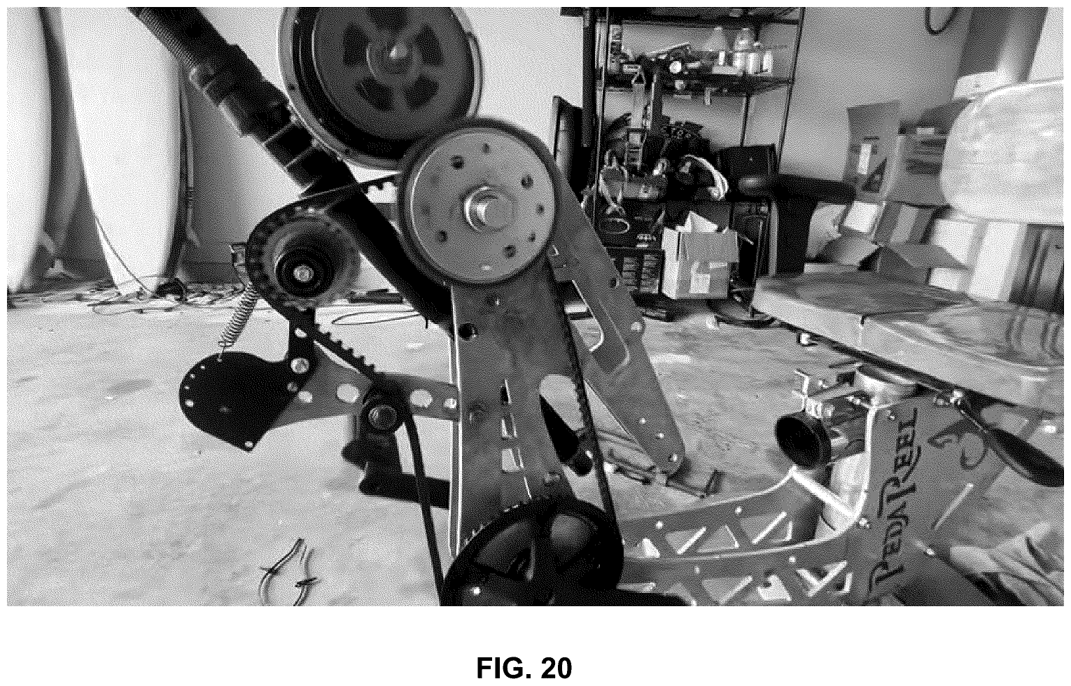

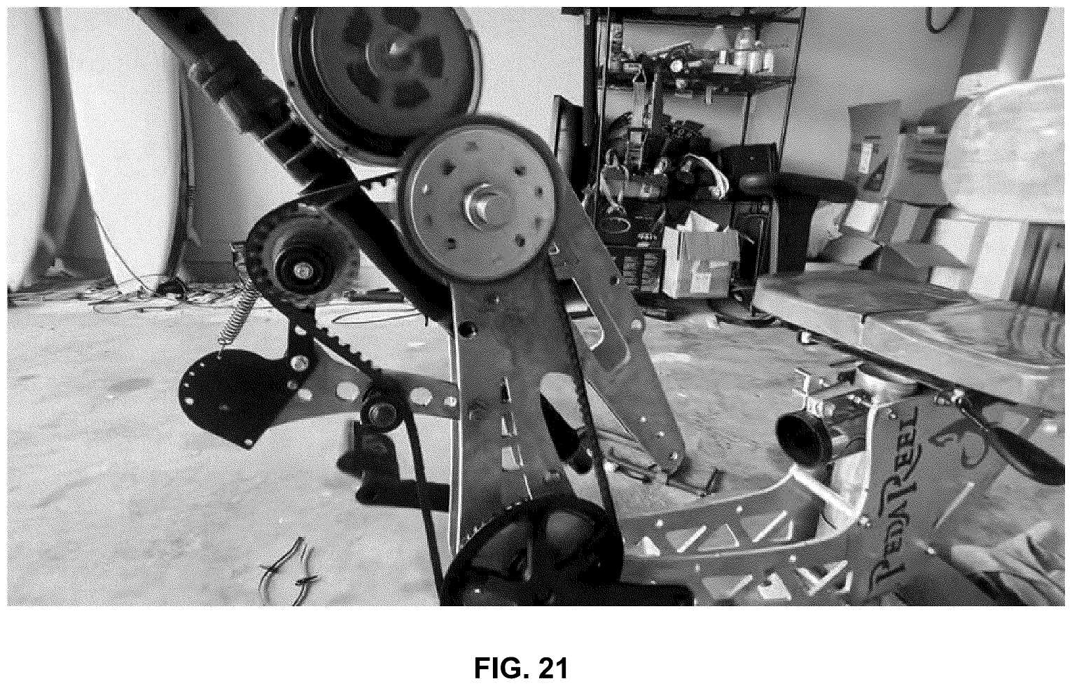

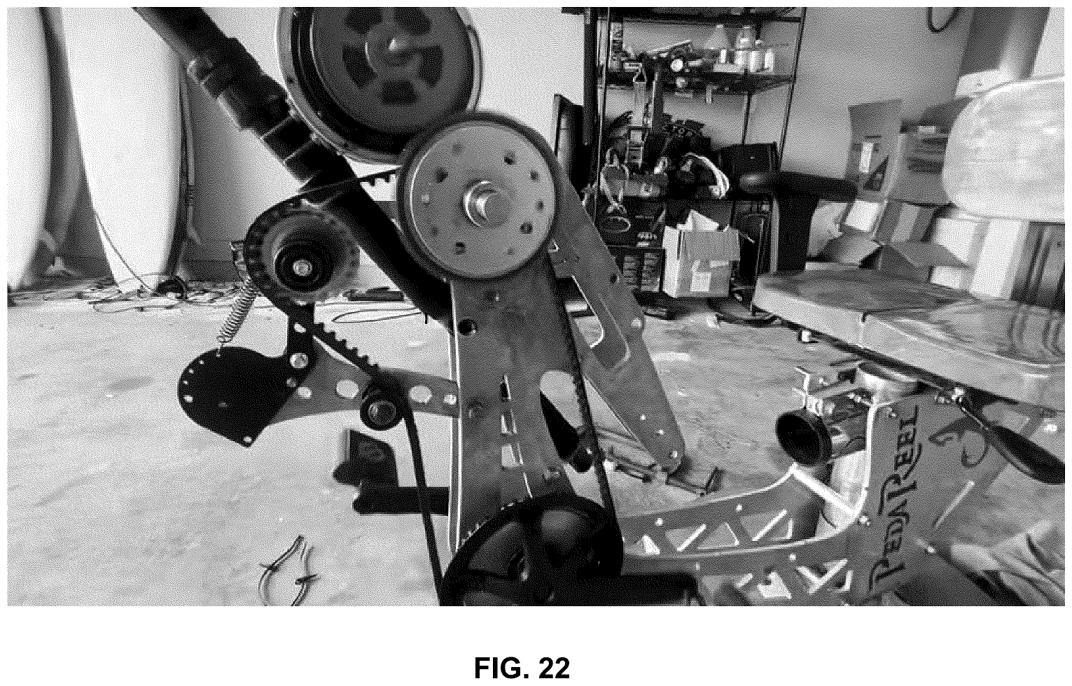

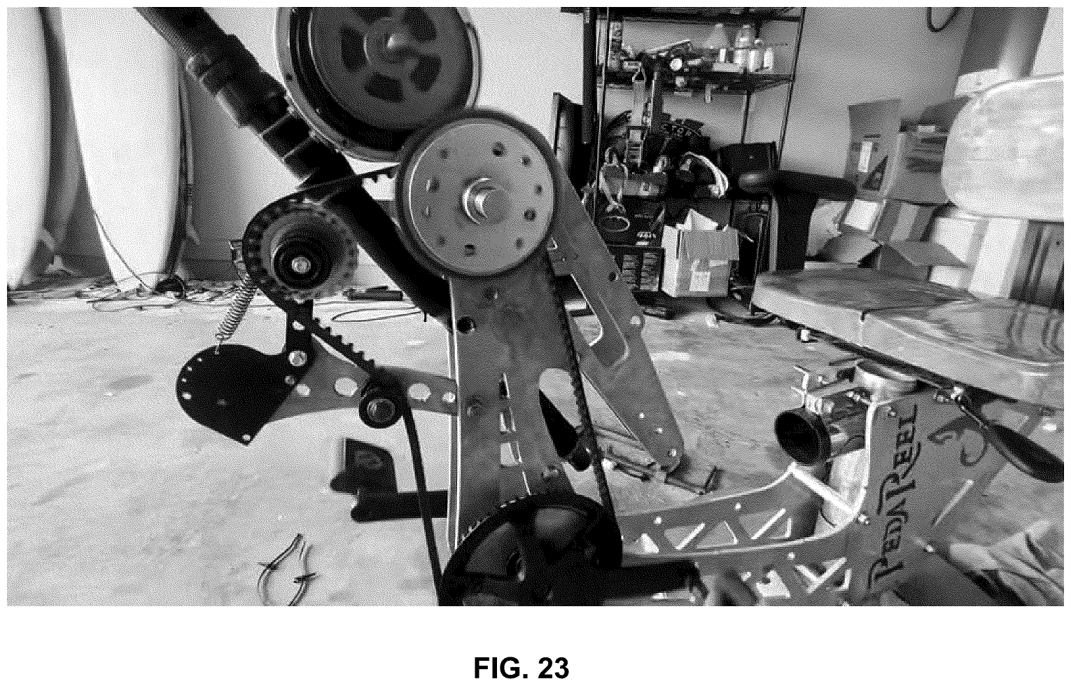

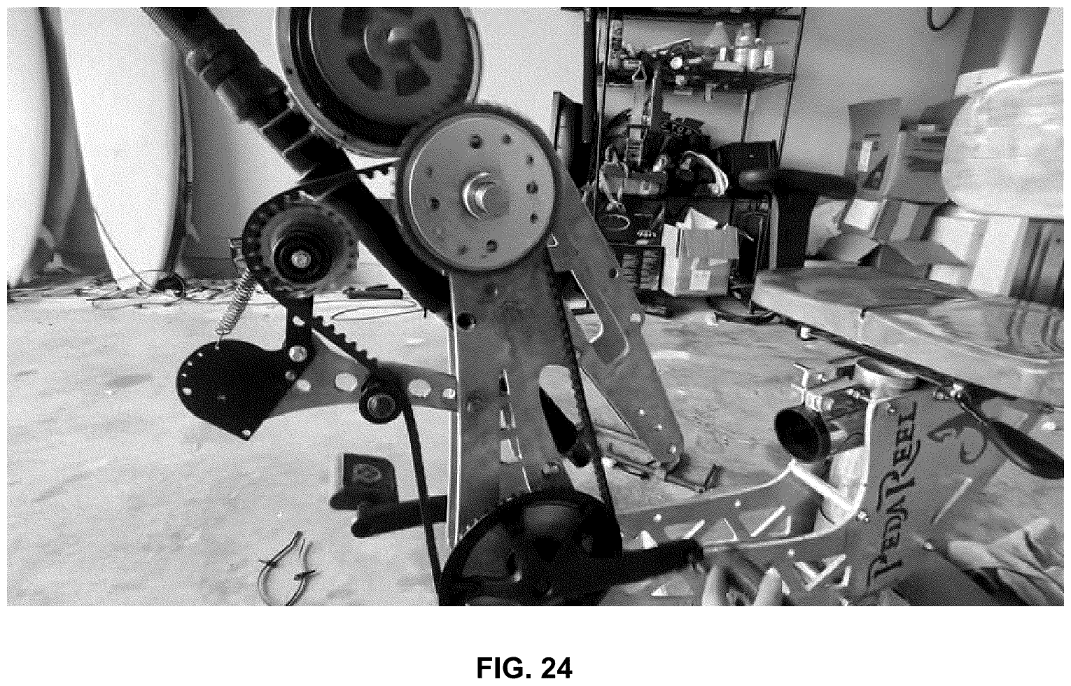

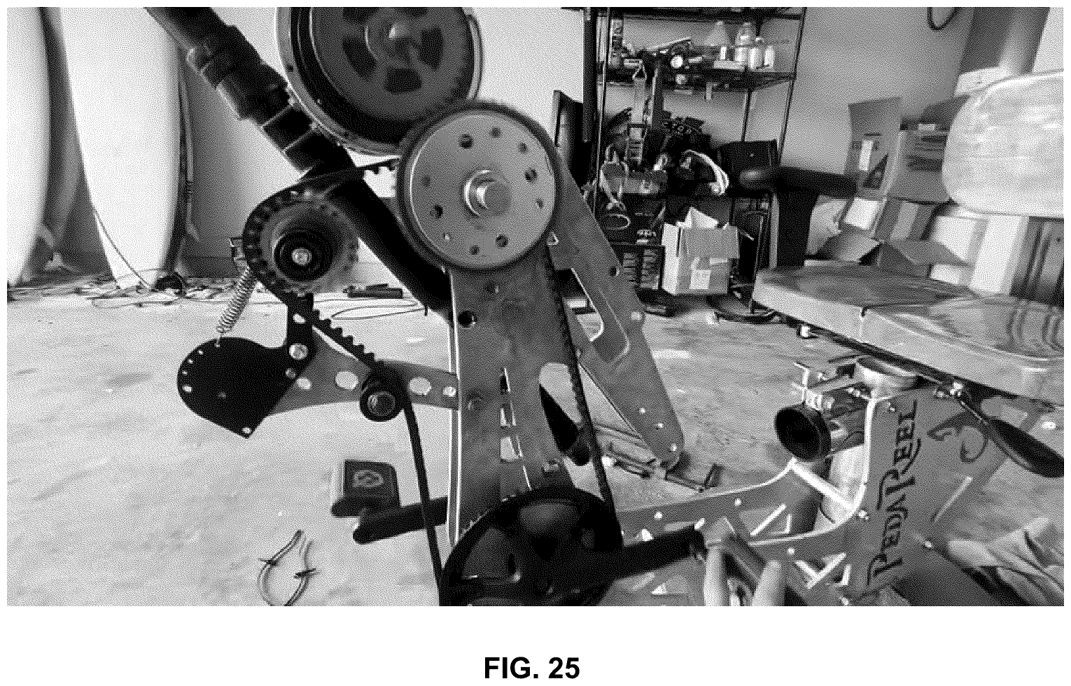

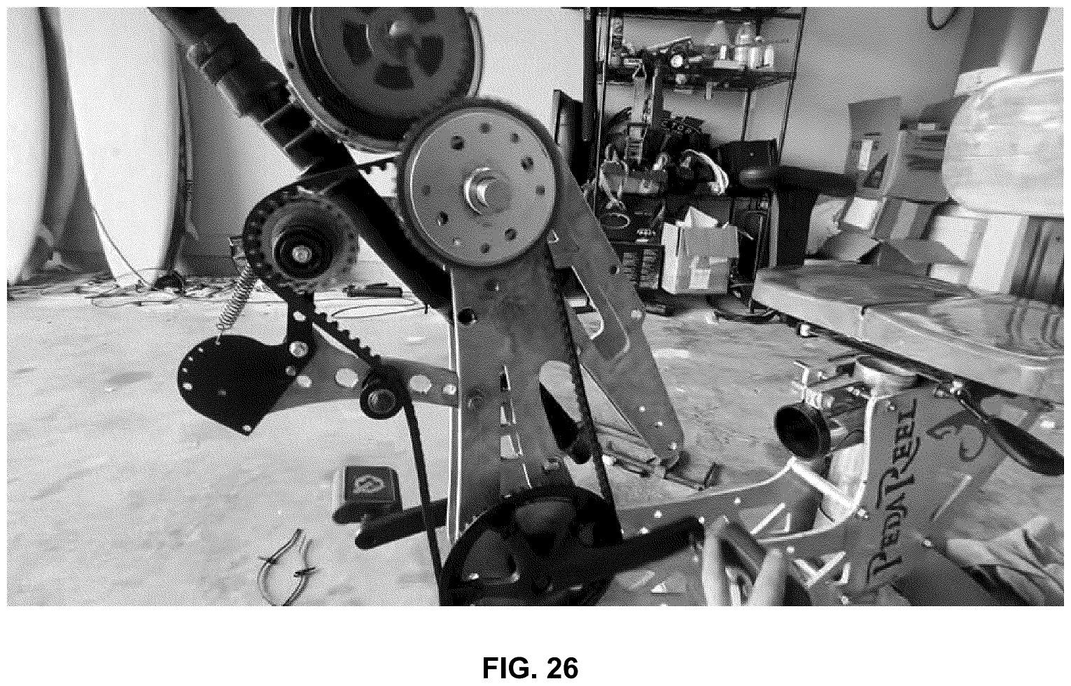

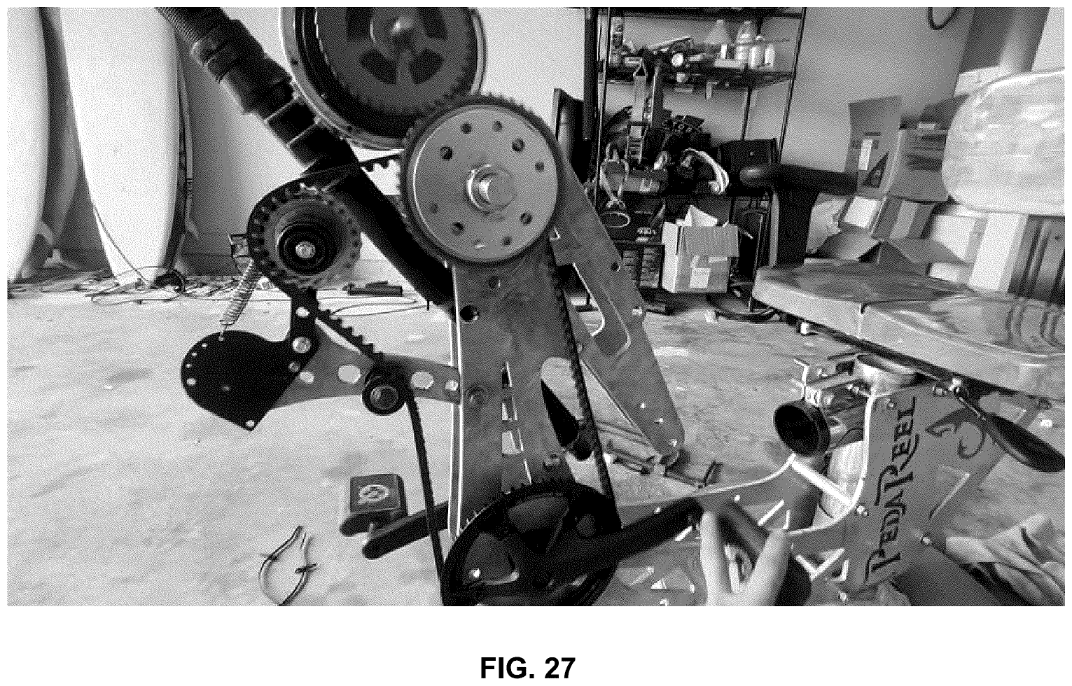

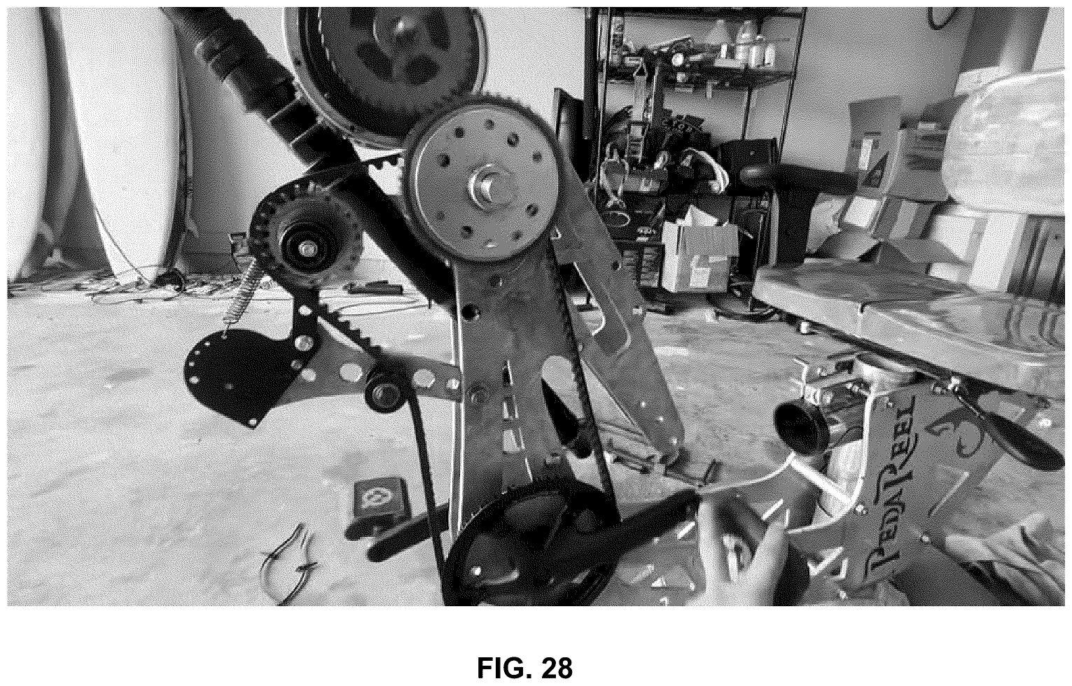

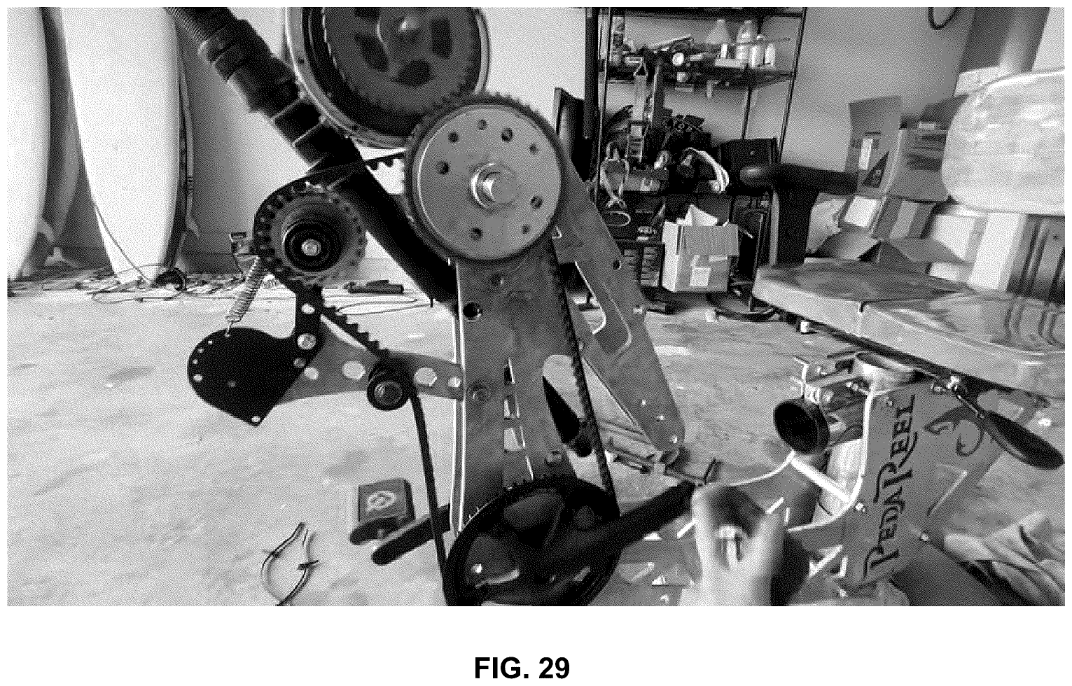

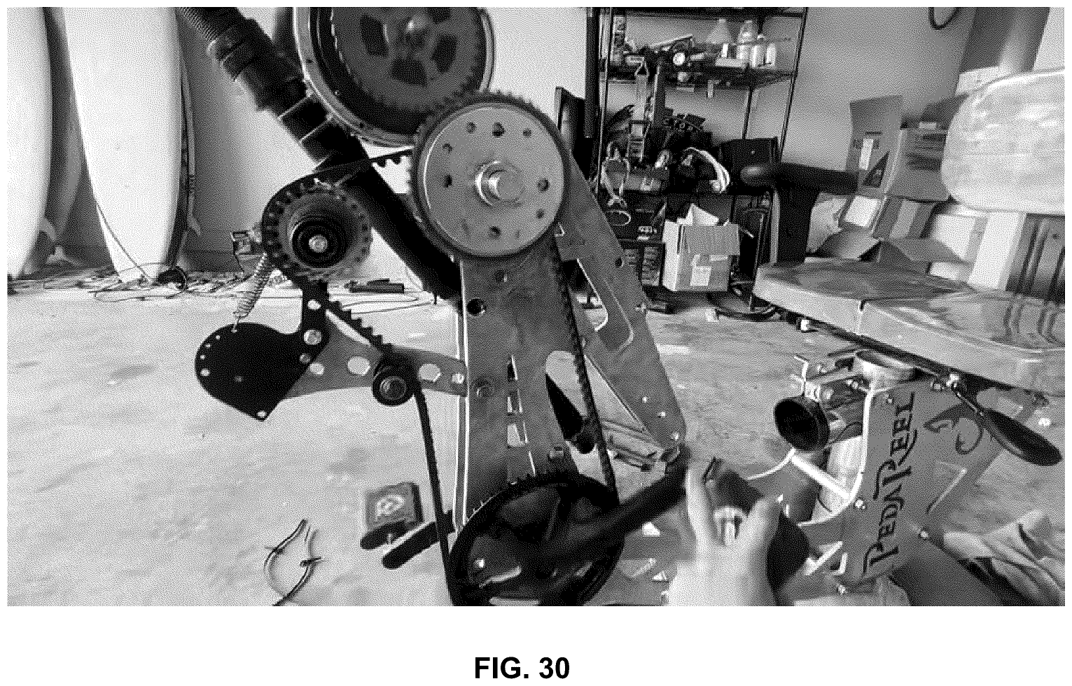

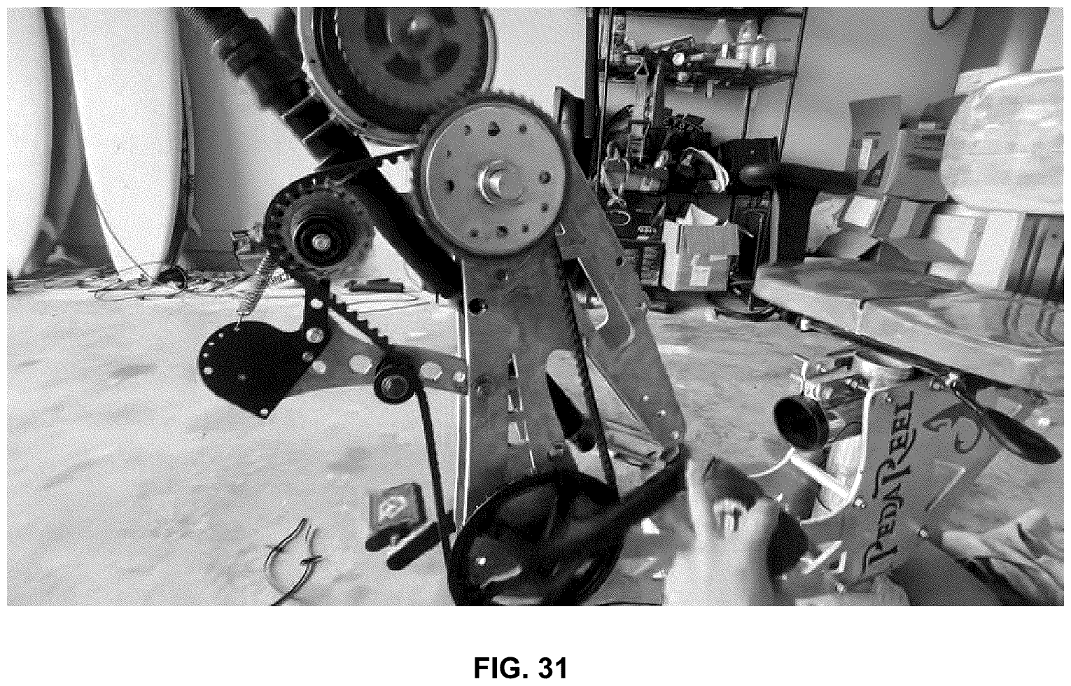

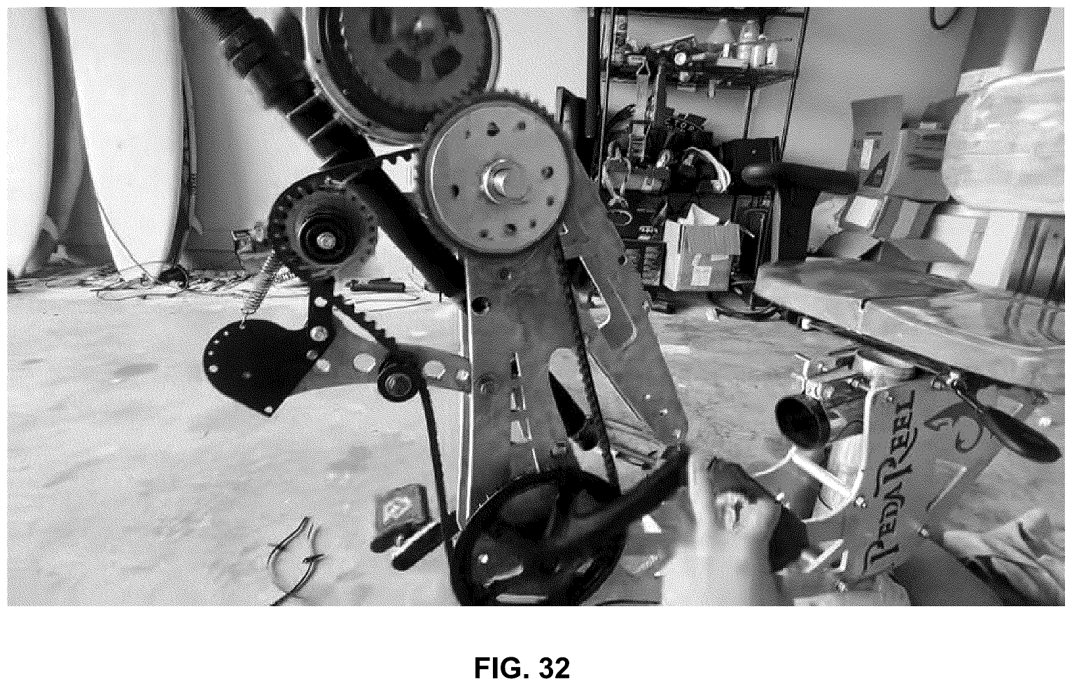

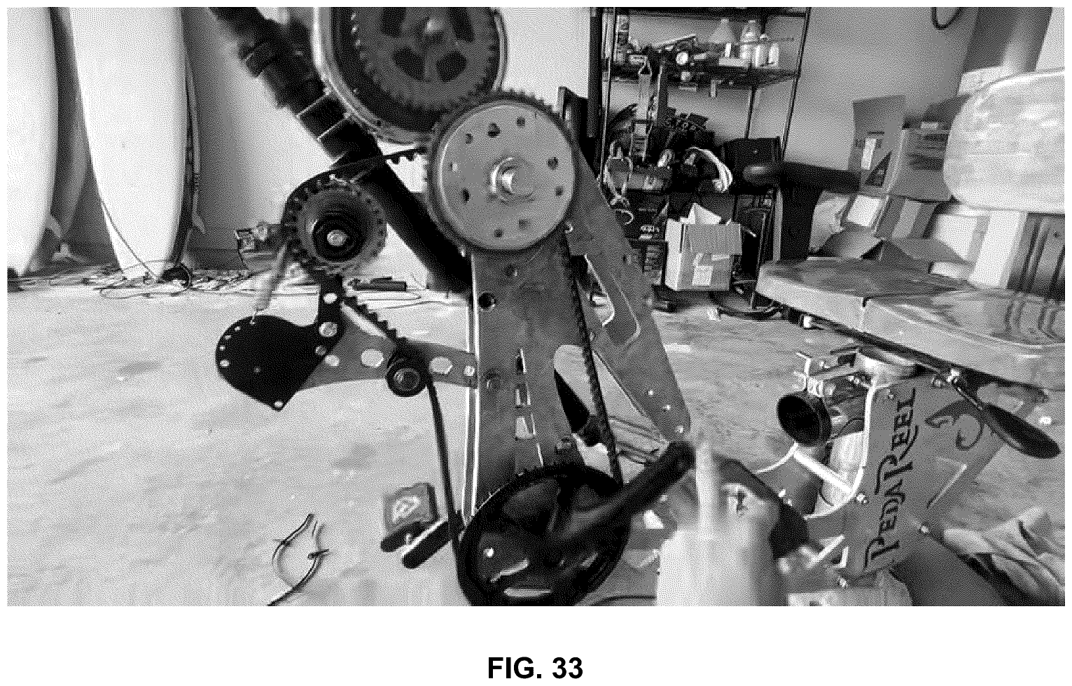

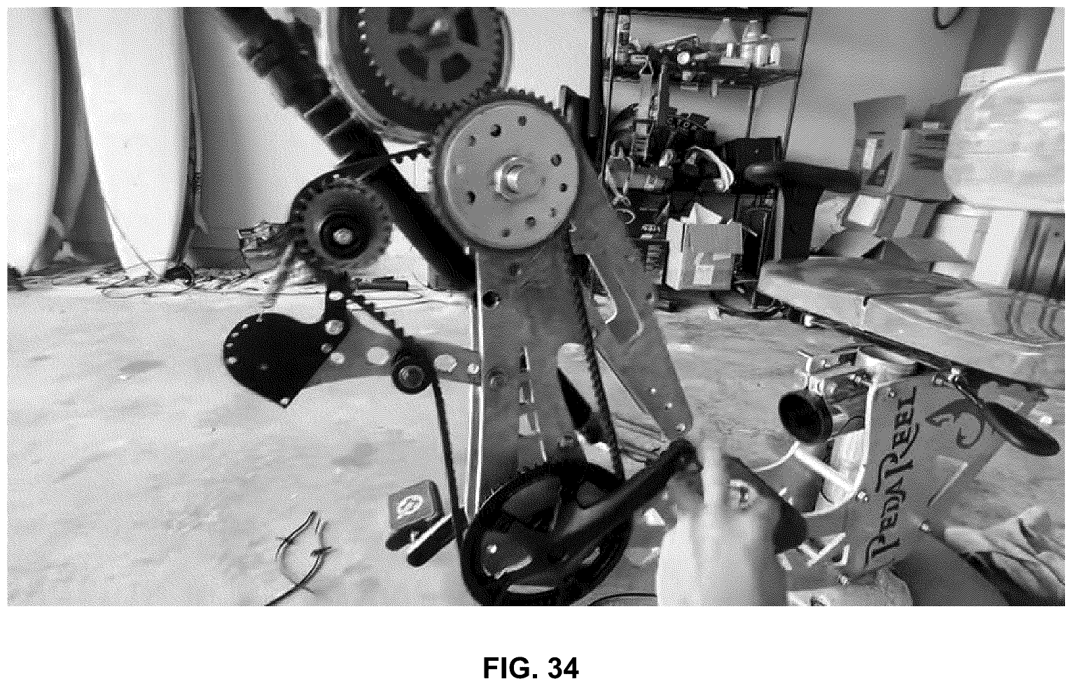

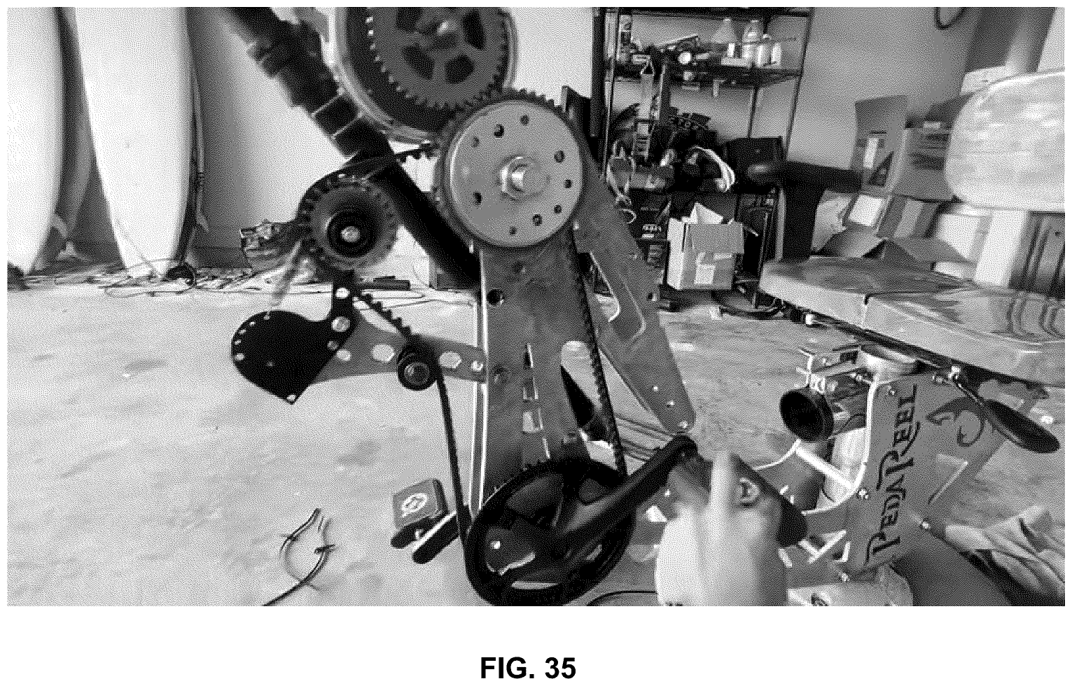

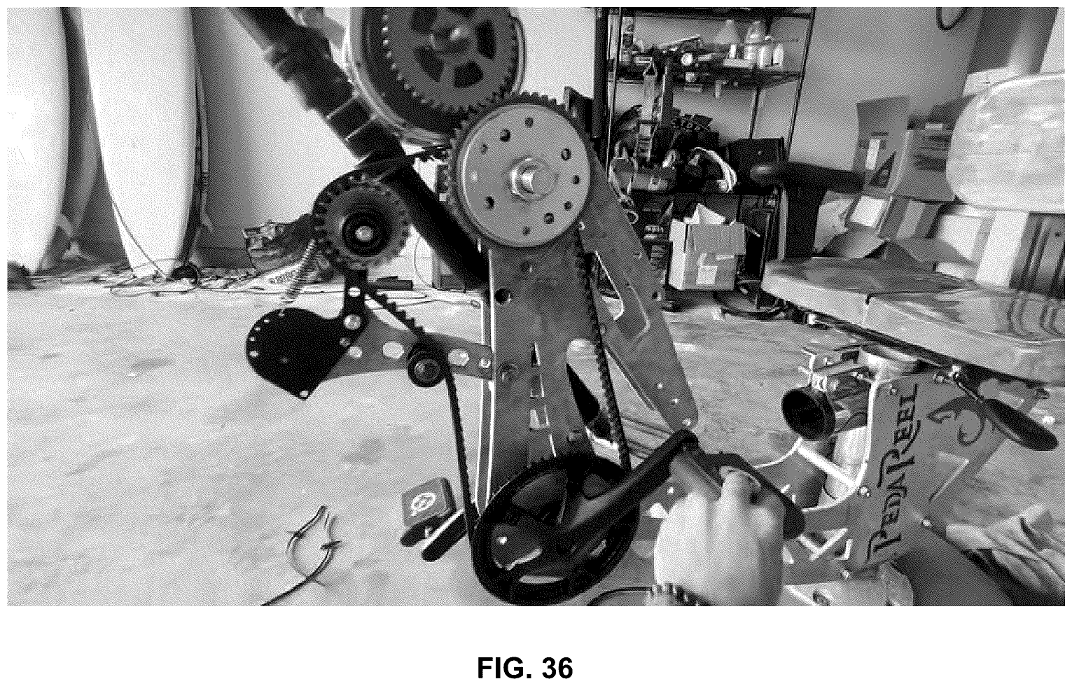

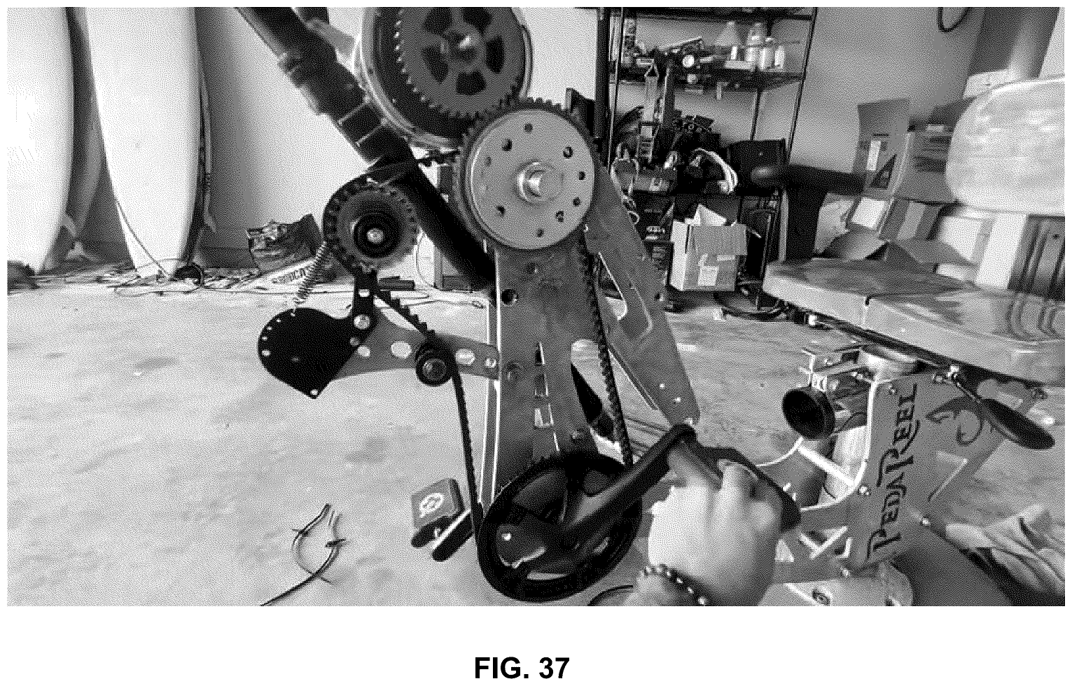

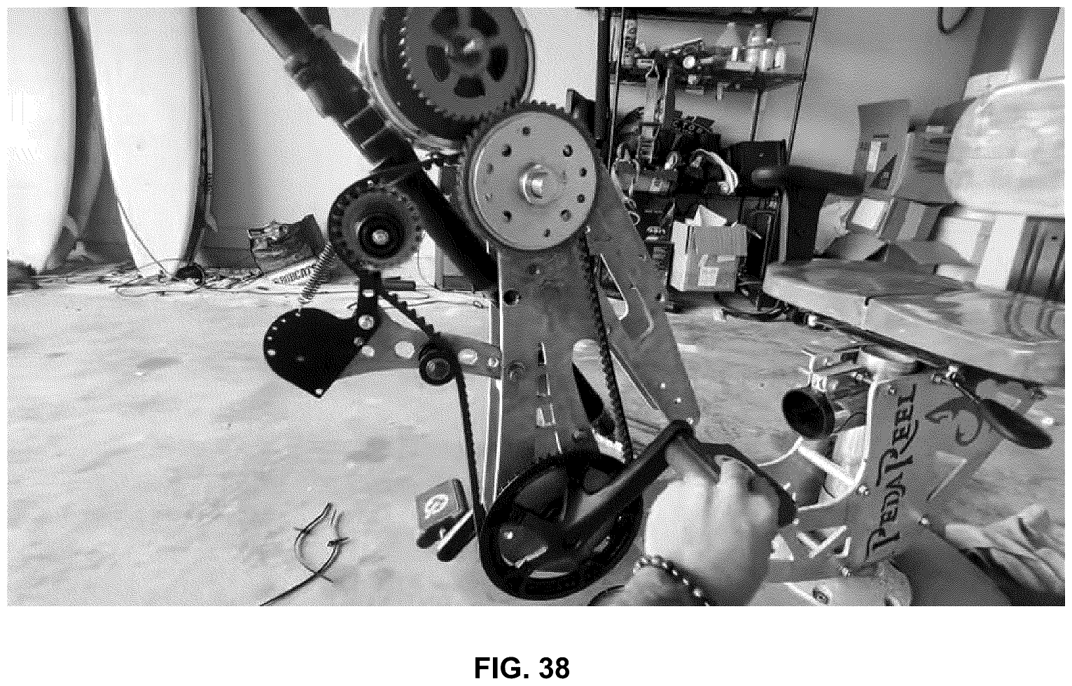

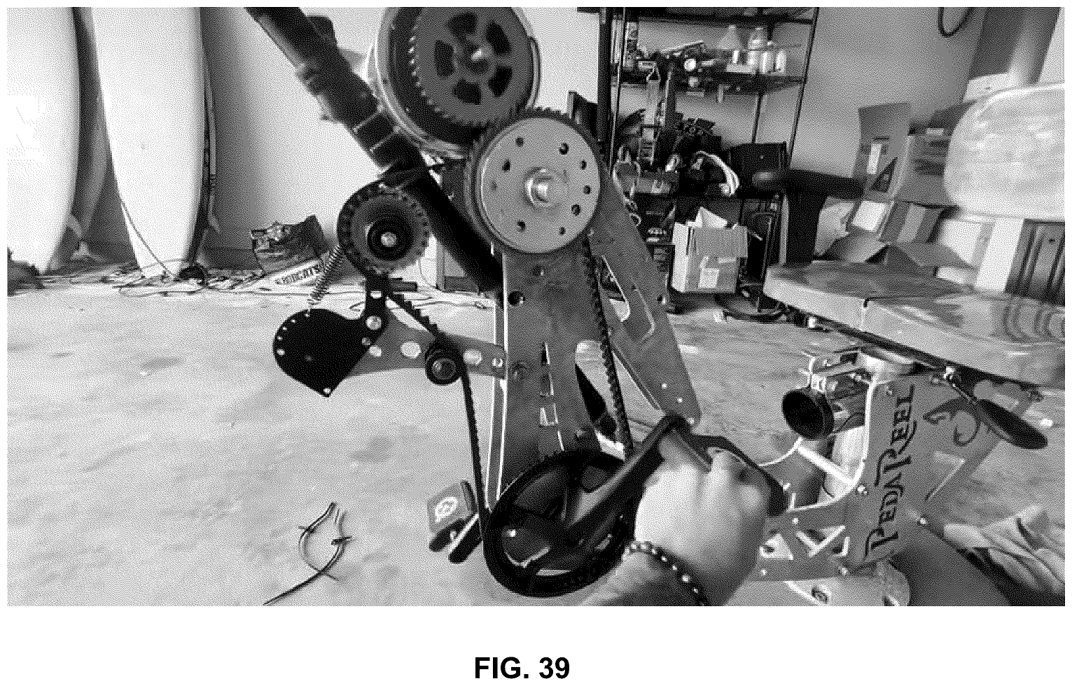

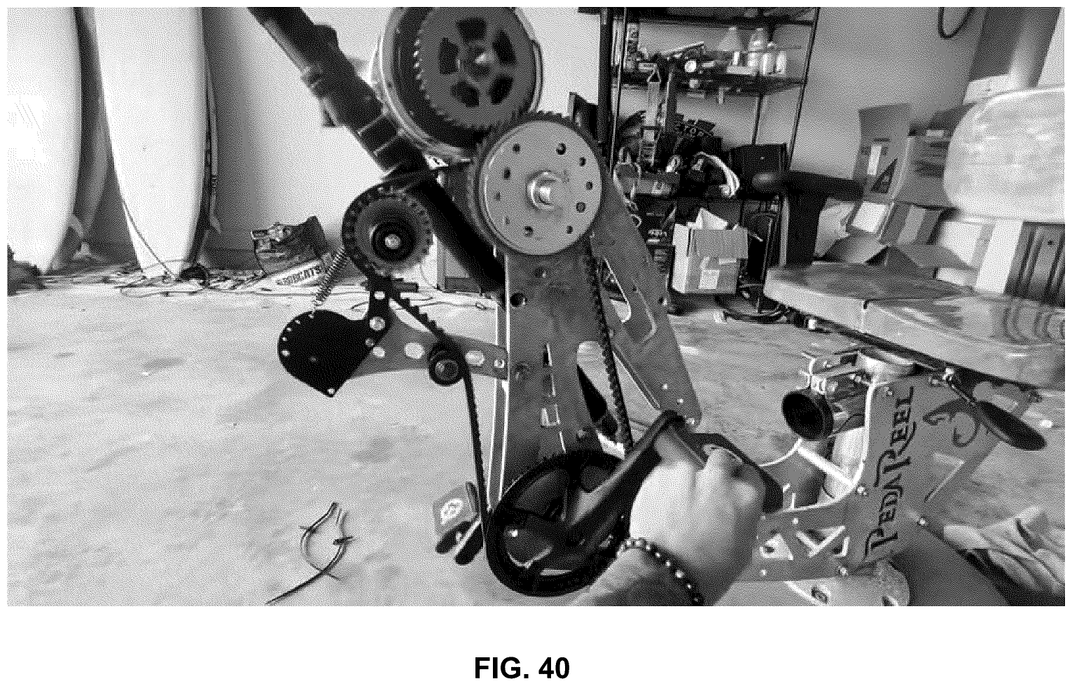

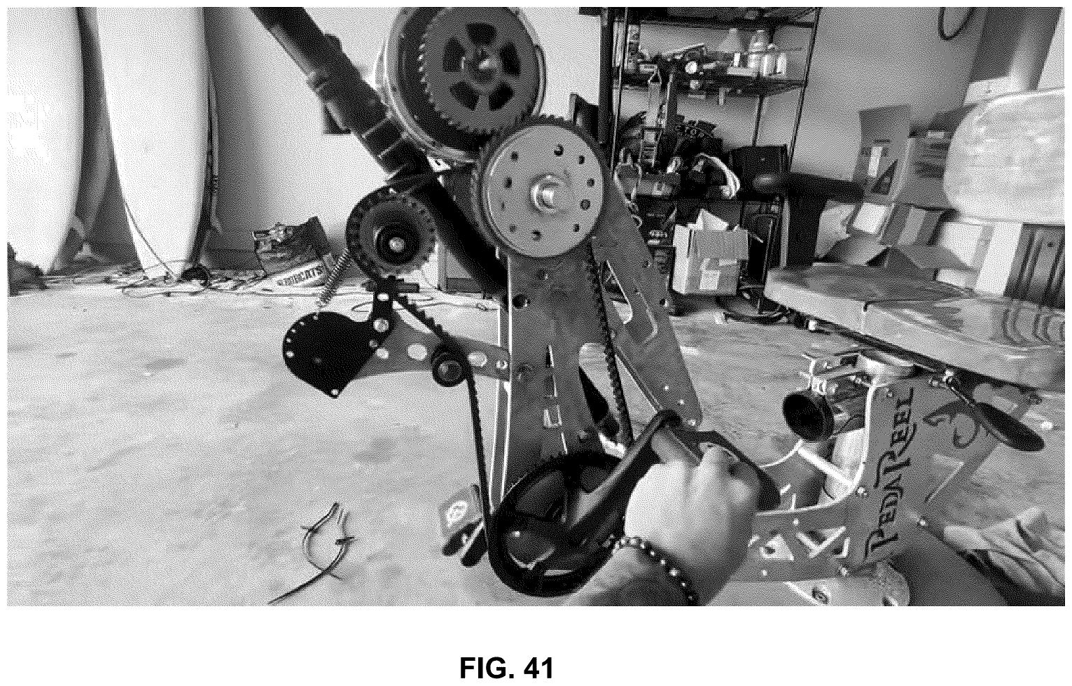

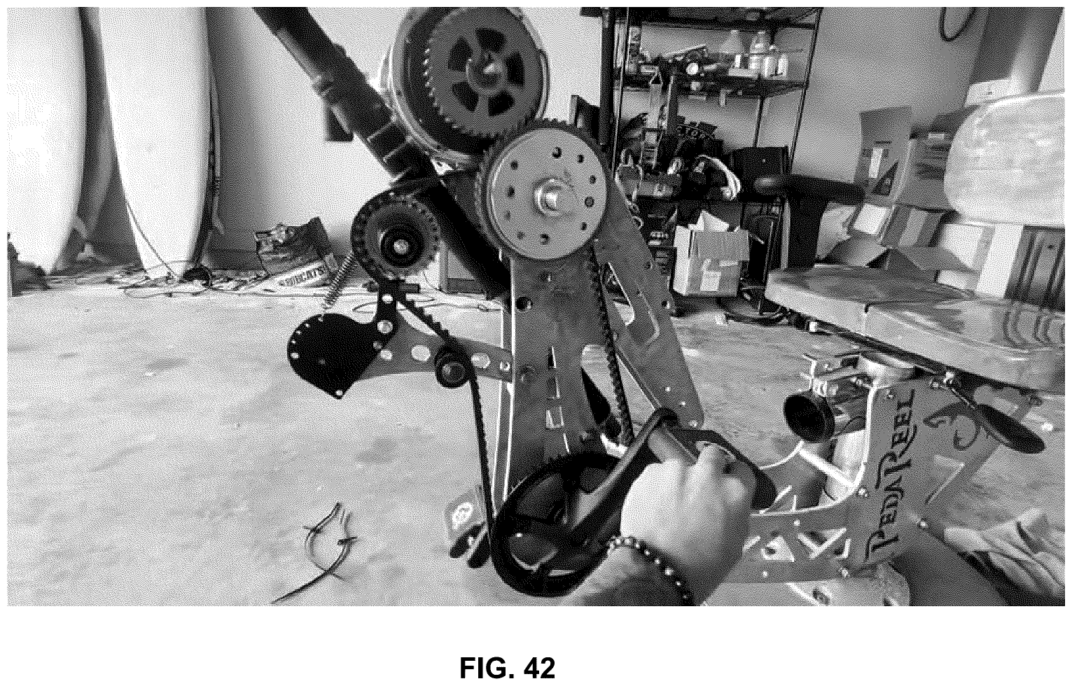

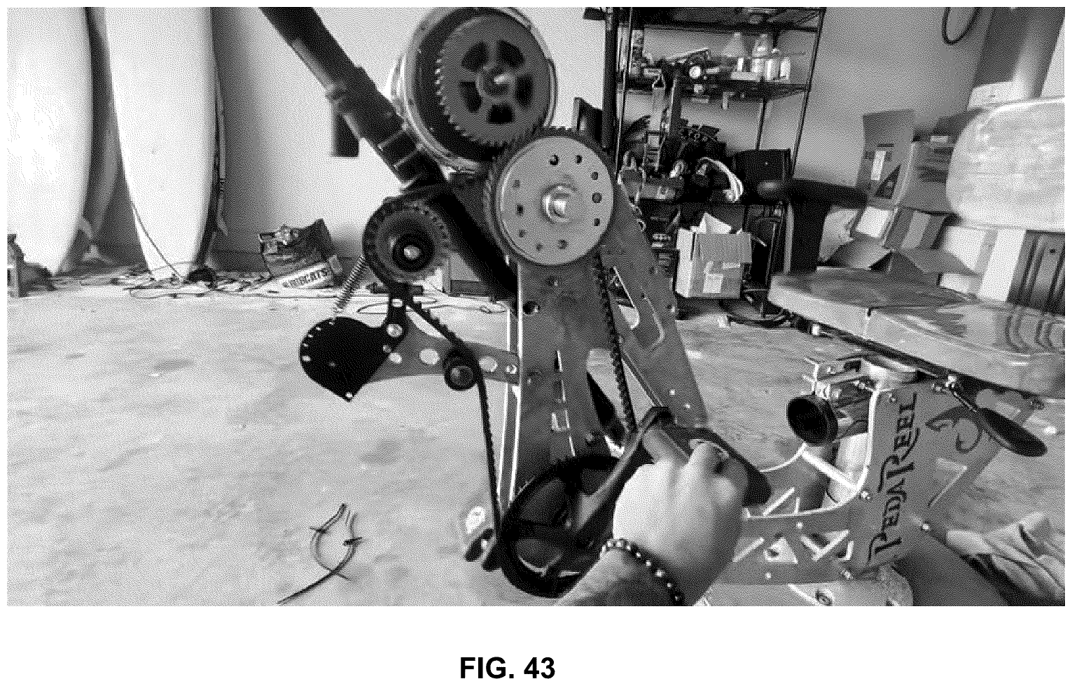

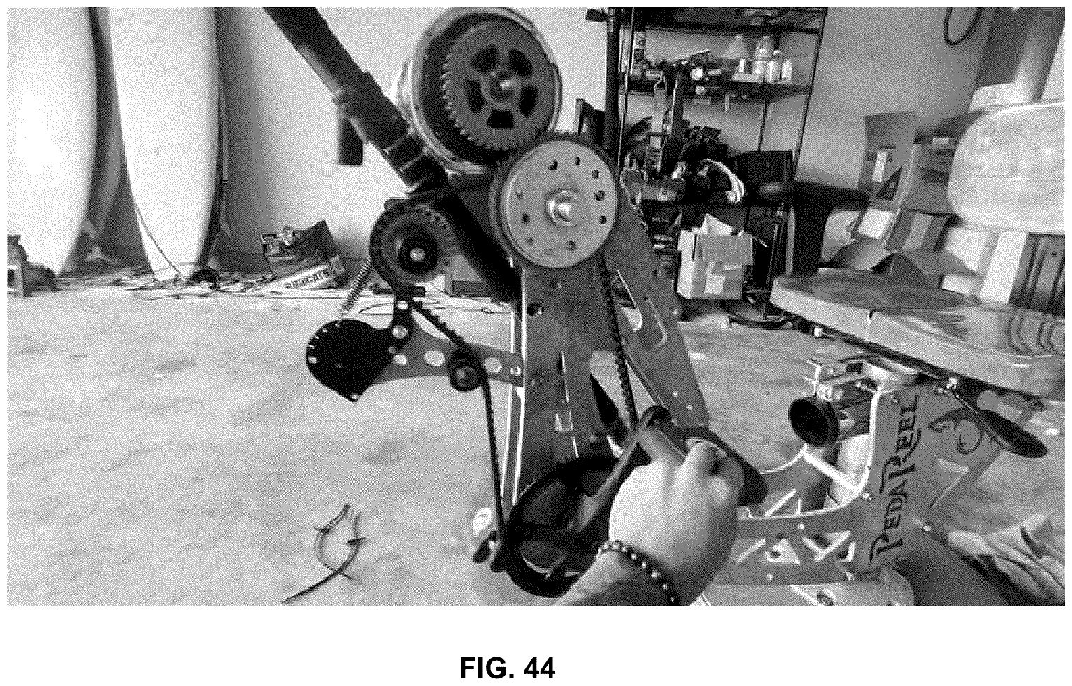

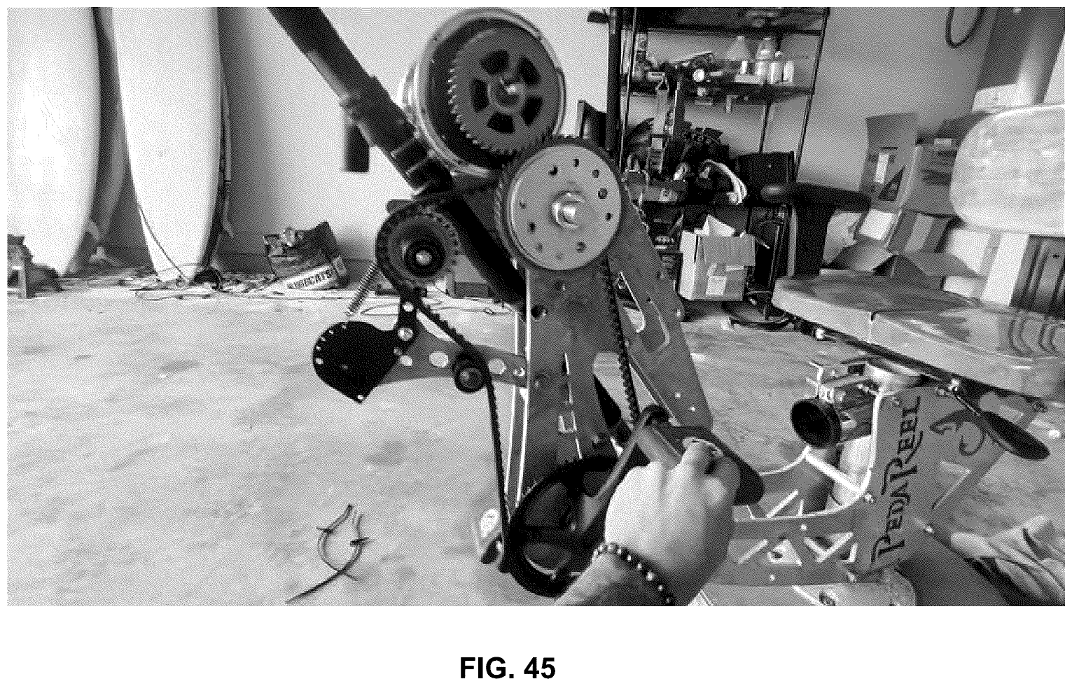

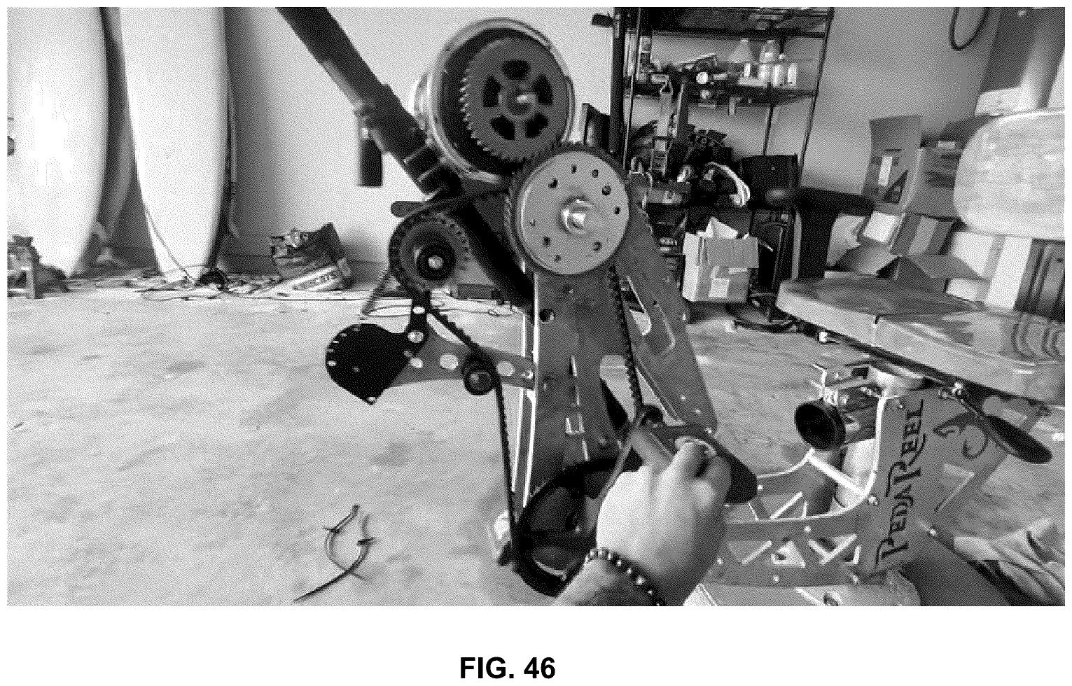

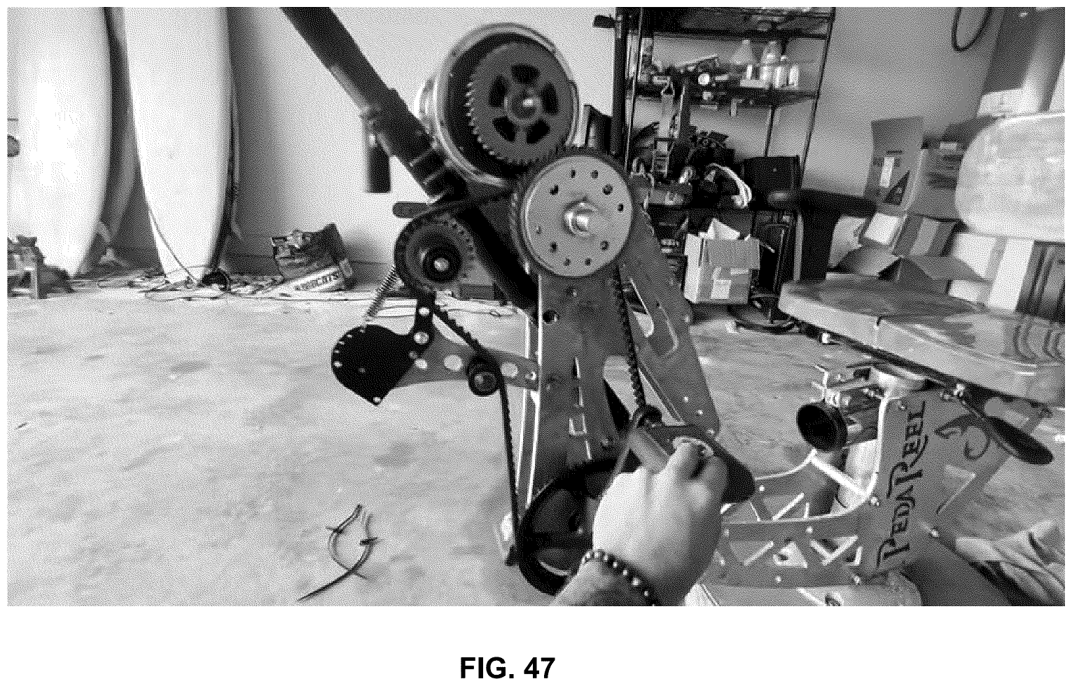

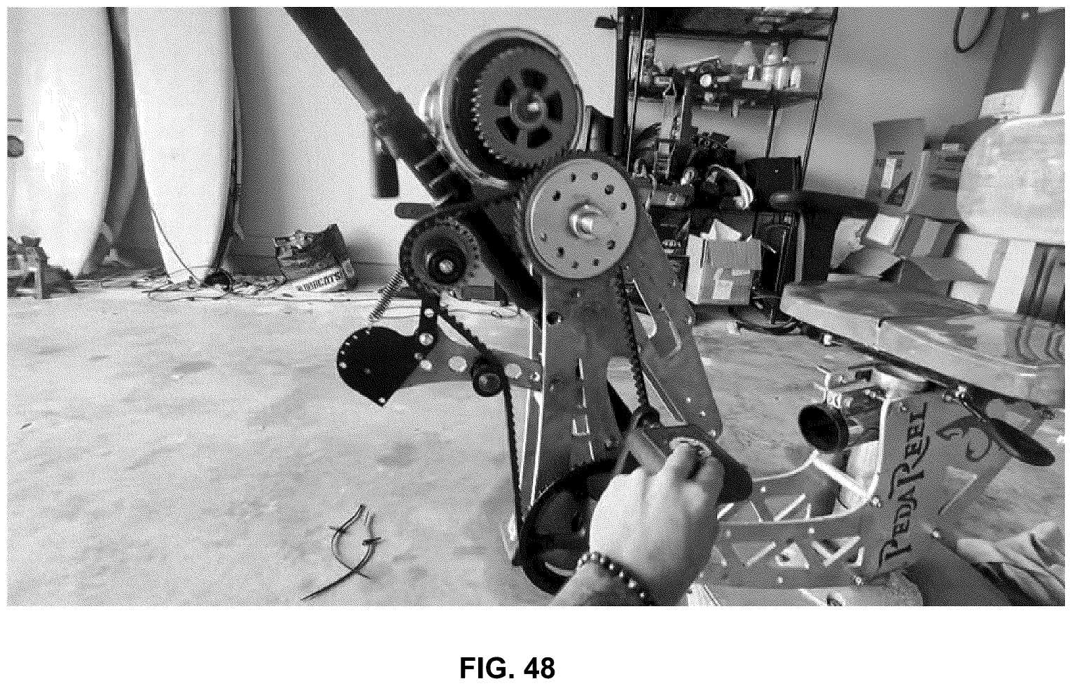

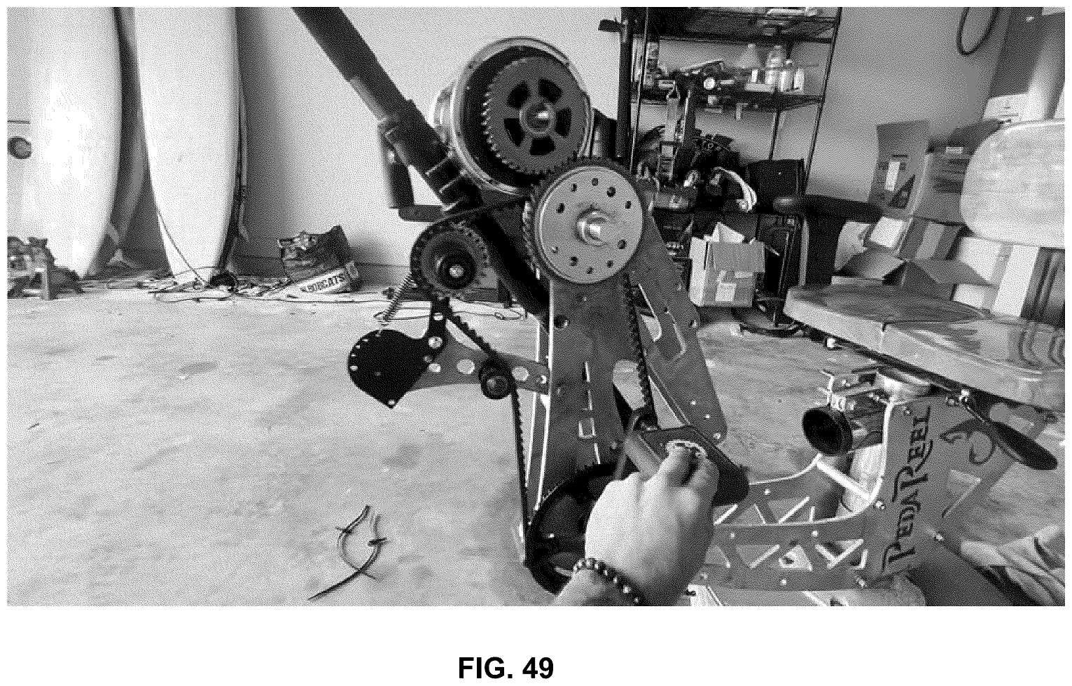

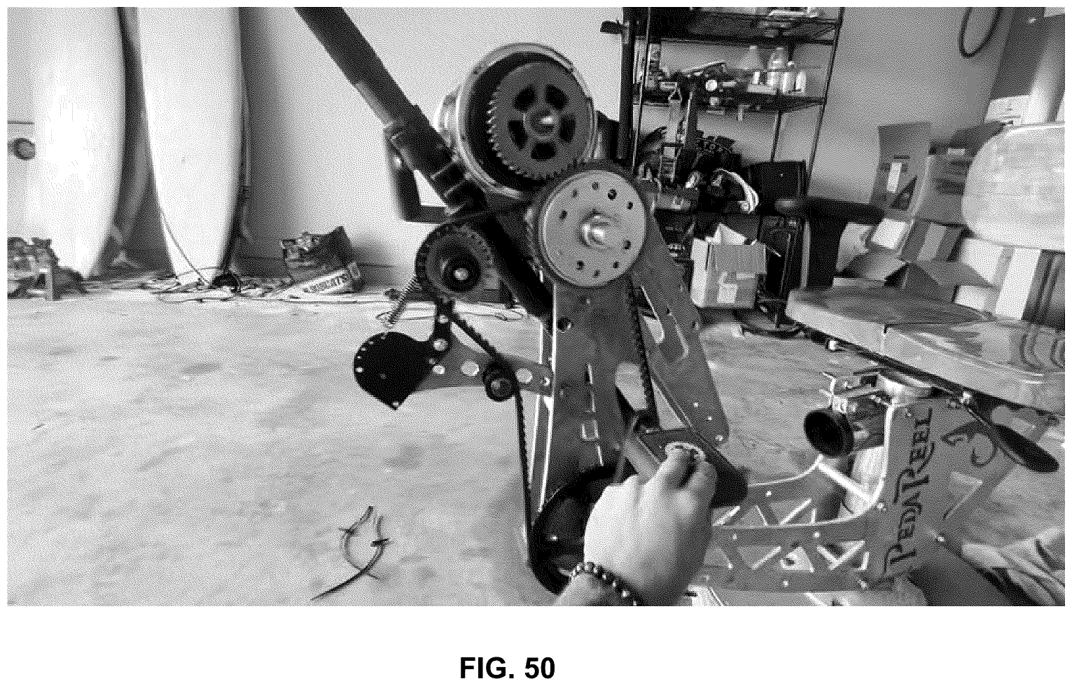

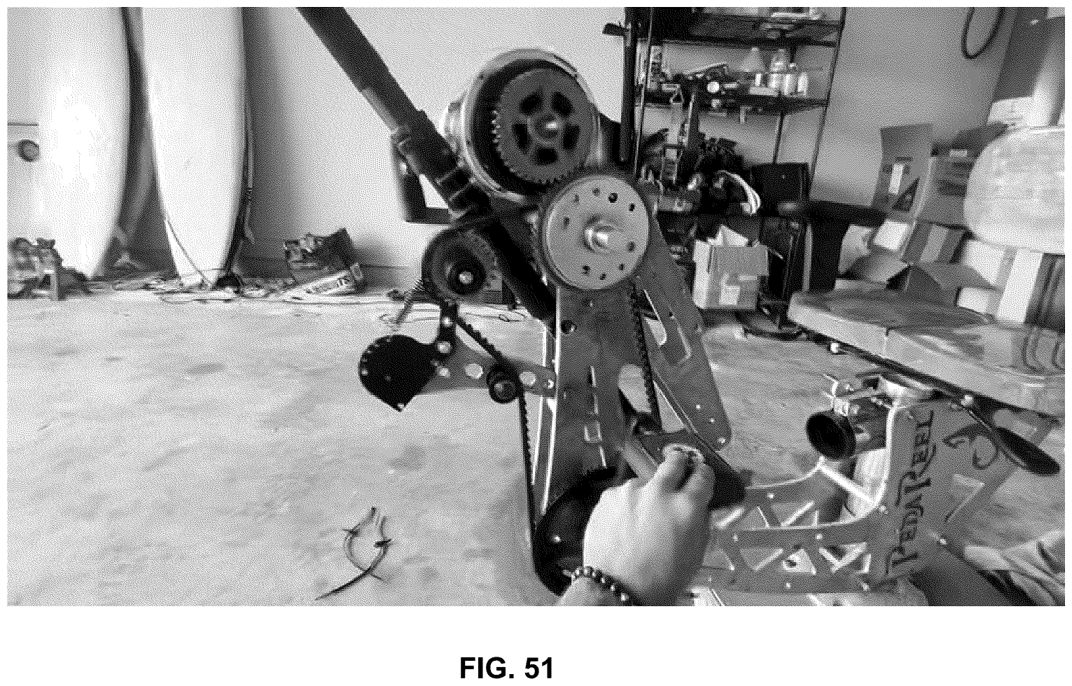

Note: to view the flip chart animation of FIGS. 7-51, please set your browser or other viewer of this patent so the size of the display is equal to the size of a page, and then successively depress the “Page Down” key or other control to see a sequence of images as you progress from FIG. 7 to FIG. 8 and so on to FIG. 51. This flip chart animation for one embodiment is intended to be run beginning with FIG. 7 and proceeding to FIG. 8, 9, etc. but for another embodiment could be run from FIG. 51 and using the “Page Up” key or control to proceed to FIG. 50, 49, etc. to FIG. 7.

### DETAILED DESCRIPTION OF EXAMPLE NON-LIMITING EMBODIMENTS

Before explaining example non-limiting embodiments, it is helpful to explain the structure and operation of a conventional deep sea fishing reel as known in the art.

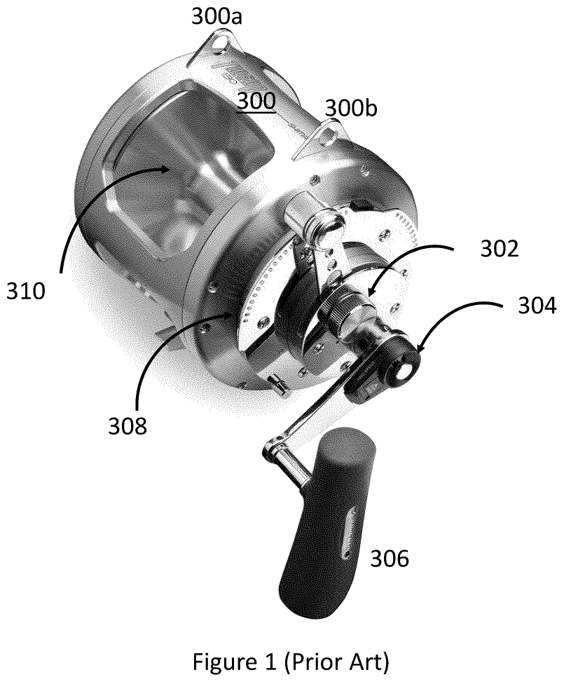

FIG. 1 shows an example of a conventional deep sea fishing reel such as with adjustable drag as described for example in U.S. Pat. Nos. 5,497,953, 2,714,271 and 1,353,113 (each incorporated herein by reference). Such a conventional reel may include a winding lever having a handle 306. An integral gear of connected to the winding lever moves a central shaft by means of an internal overdrive gear. The central shaft rotates the spool 310 on which the fishing line is wound. Rotating the handle 306 clockwise will cause the internal spool 310 to rotate counterclockwise due to the rotation reversing function of the internal overdrive gear within the reel, causing the spool to retrieve the line. See for example White, “Top Saltwater Offshore Heavy-Tackle Reels,” Marlin Magazine (Jun. 22, 2017), www.marlinmag.com/top-heavy-tackle-reels/

In more detail, the FIG. 1 conventional prior art fishing reel compries a housing 300 having one or more harness mounting lugs 300a, 300b to mount to a harness of a fighting chair. A spool tension adjustment 302 adjusts tension on a spool 310 to prevent birdnesting of the fishing line. A spool drag adjustment 308 adjusts drag on the spool (i.e., the amount of friction or braking applied to the spool when the spool is rotated in a line-deployment direction of rotation to deploy line as the line is pulled from the spool). I In one embodiment, a gear speed selector 304 adjusts or switches the ratio of rotational angle of the handle 306 and associated handle arm to rotational angle of the spool 310 when the handle arm is rotated to rotate the spool in a line-retrieval direction (i.e., different gear ratios are applied to give the angler more control over turns of the handle to linear distance of line recovered).

A conventional spinning reel's gear ratio is the number of times the reel's rotor and line roller rotate with one full 360-degree turn of the reel handle. Reels typically have an internal “overdrive” gearing system that multiplies the handle rotation so for example one full rotation of the handle causes the spool to rotate 3, 4, 5, 6, 7 or even 8 revolutions. Lower gear ratios in the 4:1 to 5:1 range are generally best suited to bait fishing since they equate to slower retrieve speeds and more cranking power (torque). Anything above 5:1 is generally considered to be high speed when referring to inshore saltwater spinning reels because it allows high speed retrieval of the line. One of the advantages of using a reel with a higher gear ratio is that you'll be able to pick up line faster because there are more revolutions of the rotor with each turn of the handle. Higher gear ratios are often considered to be more versatile and can be of benefit in a few specific situations. For example, if you hook up with a bonefish and it takes a screaming run across the flats toward the boat, it's important to pick up any slack line quickly and keep tension on the line. A higher gear ratio can also help when fishing for snook around dock pilings or mangrove shorelines because you'll be better equipped to get the fish away from structure quickly. However, very strong fish may require a lower gear ratio and thus more torque. See e.g., “How to Select the Best Gear Ratio for Inshore Saltwater Spinning Reels” (Mercury Marine Jun. 13, 2022), mercurymarine.com/en/us/dockline/how-to-select-the-best-gear-ratio-for-inshore-saltwater-spinning-reels/?j=355116&sfmc_sub=36624452&1=111_HTML&u=9390801&mid=7232290&jb=1082.

Typical deep sea fishing reels of the type shown in FIG. 1 may have a two gear ratios such as the following with a control to switch between them:
3.5:1 or 1.3:1
3.1:1 or 1.5:1
4:1:1 or 1.4:1.

As noted above, a gear ratio less than 4:1 allows for more power (torque) to fight bigger fish. This is best for heavier fish that might be tough to reel in. A gear ratio greater than 6:1 retrieves baits fast. This is best for lighter and faster fish, or ones that yo-yo in their speeds, requiring fast intake and output with your line. See e.g., Emma Mure, “HOW TO CHOOSE A SALTWATER FISHING REEL” publiclands.com/blog/a/how-to-choose-a-saltwater-fishing-reel

Meanwhile, the speed at which the spool 310 rotates is not the sole factor that determines rate of linear line retrieval; the effective diameter of the spool also plays a part in line retrieval rate. For this reason, the spool 310 of such a reel typically holds a long length of backing wound onto the spool to provide a suitable effective spool diameter to deploy and retrieve the actual fishing line being used. A conventional fishing line such a monofilament fishing line, a braided fishing line and/or a fluorocarbon fishing line is attached to the backing. The fishing line is typically threaded through the eyelets of a conventional rod made of fiberglass, graphite or some other resilient composite.

Attached to the distal end of the fishing line is tackle such as one or more hooks, one or more weights, one or more floats, one or more swivels, one or more artificial lures and one or more baits. Skilled anglers rig such a fishing line in a number of different ways depending on conditions, preferences and experience to make the fishing line attractive to target fish the angler wishes to catch. Example rigs include but are not limited to knocker rig, fish finder rig, carolina rig, dropper loop rig, paternoster rig and double drop bottom rig. A stiff hook rig is a type of rigging used for trolling lures when targeting large game fish such as blue marlin, allowing the hook to remain in a more upright position when trolled through the water to make it easier for the hook to penetrate the fish's mouth when it strikes the lure.

Anglers all over the world use such a fishing reel as described above every day to catch fish. Unfortunately, a veteran or other person who is missing one or both hands or arms cannot manipulate or use such a fishing reel. In particular, for someone without hands, it seems impossible to hold the rod and manipulate the handle of the reel to retrieve the line. Example embodiments herein allow such a disabled person to retain the rod and operate the reel using their feet instead of their hands.

### Example Reel Modification

In one example as described below, such a conventional off-the-shelf reel is modified or its design is modified to permit the reel to be operated by a person's feet instead of or in addition to their hands.

In one example, a fishing reel is modified so the spool can be turned by a manually-foot-operated machine instead of by hand. The manually-foot-operated machine can in one embodiment comprise one or two rotatable foot pedals operated by a person's foot or feet.

For example, a conventional fishing reel may be modified to provide a direct or indirect coupling of the spool or spool driving mechanism to a pedal-driven machine comprising a chain-driven or belt-drive gear, sprocket or other direct drive coupling. In one example, as foot pedals are rotated clockwise, a sprocket also rotates clockwise—which in turn acts through another gear to turn the spool counterclockwise. Turning the spool on the fishing reel counterclockwise causes the spool to retrieve the fishing line. The angler is thus able to use their legs in place of hand-operating the fishing reel handle and lever arm to manually reel in a fish.

In this embodiment, an upper sprocket coupled to the spool is mounted on stainless steel ball bearings and is able to freely float or turn without pedaling under the force of the fishing line, so that force of a fish pulling on the fishing line will not rotate the pedals. The pull on the fishing line applied by the fish instead applies force against the drag provided by the conventional reel. A selective coupling or one-way clutching mechanism is used in some embodiments to protect the angler from force a fish exerts on the fishing line, and allows instead the drag control of the reel to control the rate at which a fish can take fishing line off the spool of the reel without interference by either resistance or rotation of the pedals.

In another embodiment, the fishing reel is not modified, and the machine instead drives the fishing reel handle in an appropriate (e.g., clockwise) rotational direction to cause the spool to rotate (e.g., counterclockwise) in a line retrieval direction. Thus, in either embodiment, the handle of the fishing reel may rotate in the same direction (e.g., clockwise) as the pedals are rotated as the spool rotates in the opposite (e.g., counterclockwise) direction to retrieve the fishing line.

### Example “Fighting Chair”

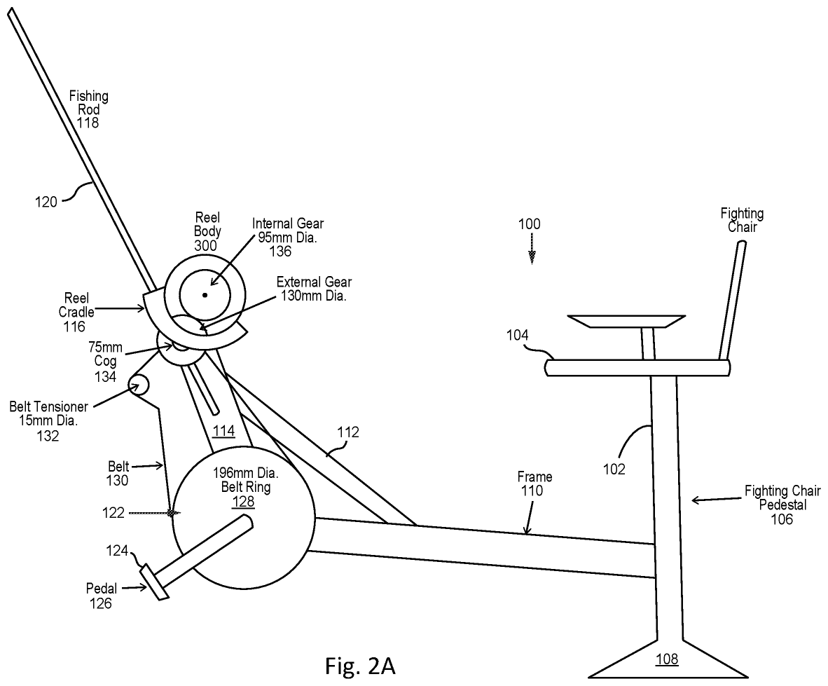

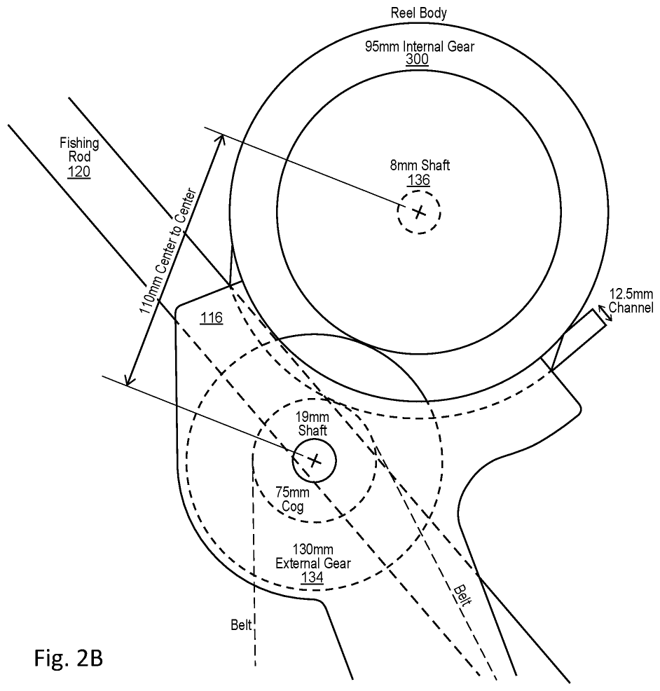

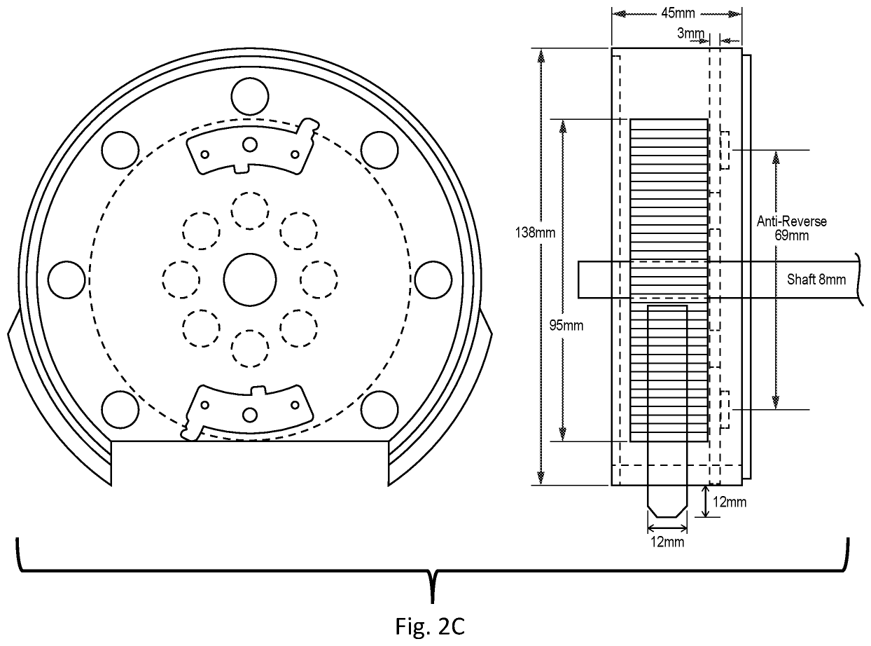

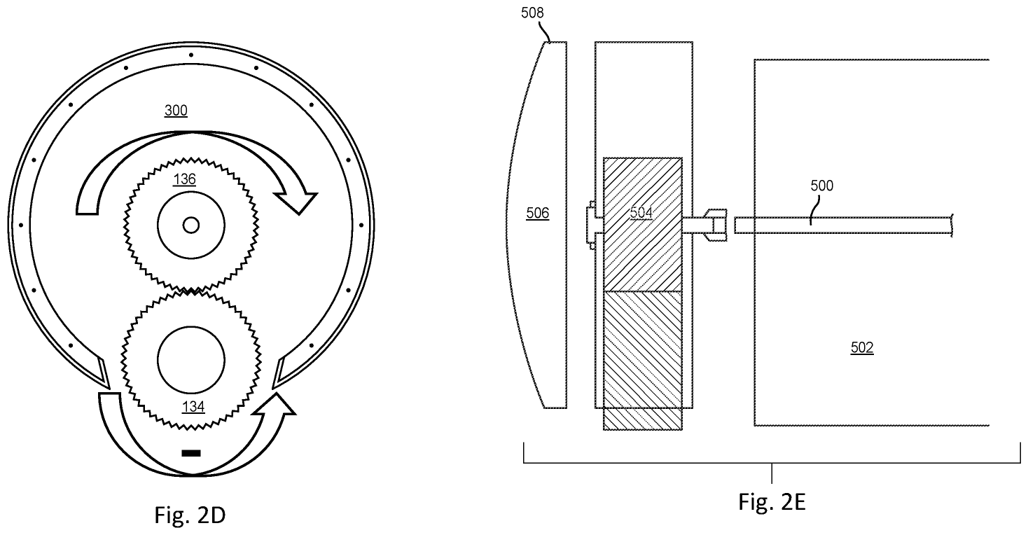

FIG. 2A show an example manually operated fishing system 100 comprises a “fighting chair” 102 having a seat 104 mounted onto a vertical pedestal 106. The seat is designed to support the posterior of an angler. Pedestal 106 has at its bottom end a mounting plate 108 configured to be mounted to a conventional pedestal mounting plate on the deck of a boat or ship. The mounting plate may be a Class A type that includes e.g., 6 mounting screws around a hole that accepts a central post. The pedestal and mounting plate is designed to support someone in the seat 104 when the boat is underway at any speed. For example, pedestal 106 can comprise a Class AP pedestal designed to be used while the boat is underway. This seat hardware for passenger boat seats meets the following American Boat & Yacht Council (ABYC) specifications:
Swivel locking mechanism sustains torque of at least 30 ft. lbs.
·A seat designed for occupancy while the vessel is underway at any speed
Employs a locking mechanism for each plane or axis of movement
Seat with a fore/aft adjustment sustains static loads of at least 300 lbs. for 3 minutes, in mid position
Seat with a vertical adjustment feature has a positive locking mechanism
Sustains at least 10 impacts of at least 225 lbs.

In one embodiment, the pedestal 106 can rotate 360 degrees in its deck mounting. Such a pedestal 106 can be fastened to the desk of a ship or boat, or could be mounted to some other object such as a tow mounting bracket of a vehicle for dock or shoreline use, as shown in FIG. 7.

FIG. 2A further shows a frame connected to and supported by pedestal 106. In this example, the frame supports the feet of a person seated in seat 104, and in particular provides rotary pedals that the person's feet can rest on and manipulate.

In one example, a roughly horizontal frame member 110 extends from the pedestal 106. Frame member 110 in turn supports a projecting frame member 114 that extends at an angle away from the seat 104. A cross frame member 112 maintains the projecting frame member 114 in position. Adjustments may be provided to adjust the projecting angle/distance of the projecting frame member 112 relative to the seat.

Projecting frame member 114 has a rod receiving structure 116 configured to receive and retain a conventional fishing rod 118. Fishing rod 118 is conventional and includes a butt end 120 that can be inserted into the rod receiving structure 116. The rod receiving structure 116 may comprise for example a hollow tubular member into which the rod butt end 120 may be inserted. The rod receiving structure 116 retains the rod so it does not pull out in an unexpected way, but so that rods can be removed and replaced as needed (i.e., the rods are interchangeable and different rods can be swapped in and out as desired).

Conventionally, the rod 118 would normally be attached to the reel such as shown in FIG. 1, and the harness loops 300a, 300b on the reel would be attached to clips connected to the chair to prevent the rod from being pulled out of the rod receiving structure 116. However, in some embodiments herein, the reel is not mounted to the rod but is instead mounted to the chair frame independently of the rod. Thus, in such embodiments the rod 118 cannot rely on reel harness loops on the reel to retain the rod in the rod receiving structure 116. As shown in FIG. 7, a strapping or clamping system independent of the reel can be used to strap rod 118 to the frame and retain the rod in the rod receiving structure 116. This allows the rod to be removed, interchanged and reinserted independently while the reel remains attached to the chair frame. The reel may be attached to the chair frame using any mechanical structure such as one that connects to the foot of the reel in the same way the reel can be attached to and retained by the rod.

As shown in FIG. 2A, a crankset 122 is rotatably mounted to a second end of frame member 110 opposite the first end of frame member connected to the pedestal 106. Crankset 122 is typically supported by the frame member 110 above a horizontal surface below such as a deck or the like. The crankset 122 can be similar or identical to a crankset or chainset of a conventional bicycle, comprising two crank arms 124a, 124b (one on either side of the frame) to which the pedals 126a, 126b are respectively attached (another embodiment could comprise a single crank arm and associated foot pedal). The crank arms 124 are attached in this example to a chainring 128 that engages a toothed chain or belt 130. The chainring 128 is rotatably journaled to the frame member 110 and in one embodiment is attached to an axle that is disposed in a hole through the frame member as on a bicycle. Rotating the pedals 126a, 126b causes the chainring 128 to rotate.

When the chainring 128 rotates based on rotation of the pedals 126a, 126b, the chain or belt 130 engaged with the toothed outer periphery of the chainring 128 circulates through an idler wheel/tensioner 132 and around a rotatable driving wheel 134. Driving wheel 134 is mechanically coupled to a driven wheel 136. Driven wheel 136 is in turn is connected to the spool 310 of reel 300. In one embodiment, the driving wheel 134 and driven wheel 136 mesh as shown in FIGS. 2B, 2D so they rotate in opposite directions (see FIG. 2B, 2D). Thus, when one of these wheels turns, the other wheel also turns but in the opposite direction.

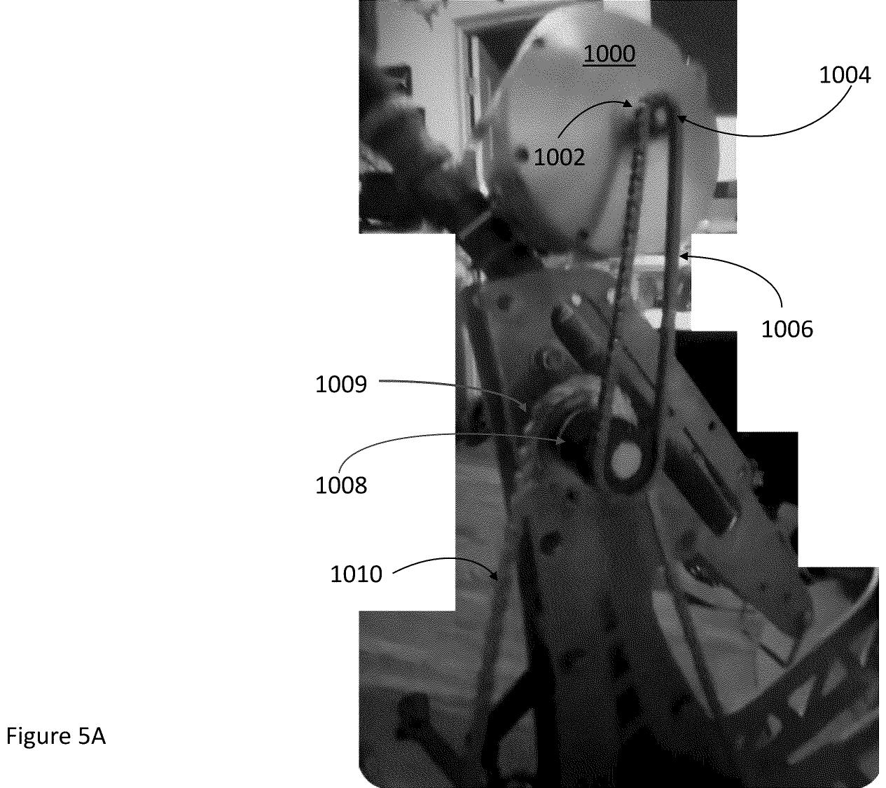

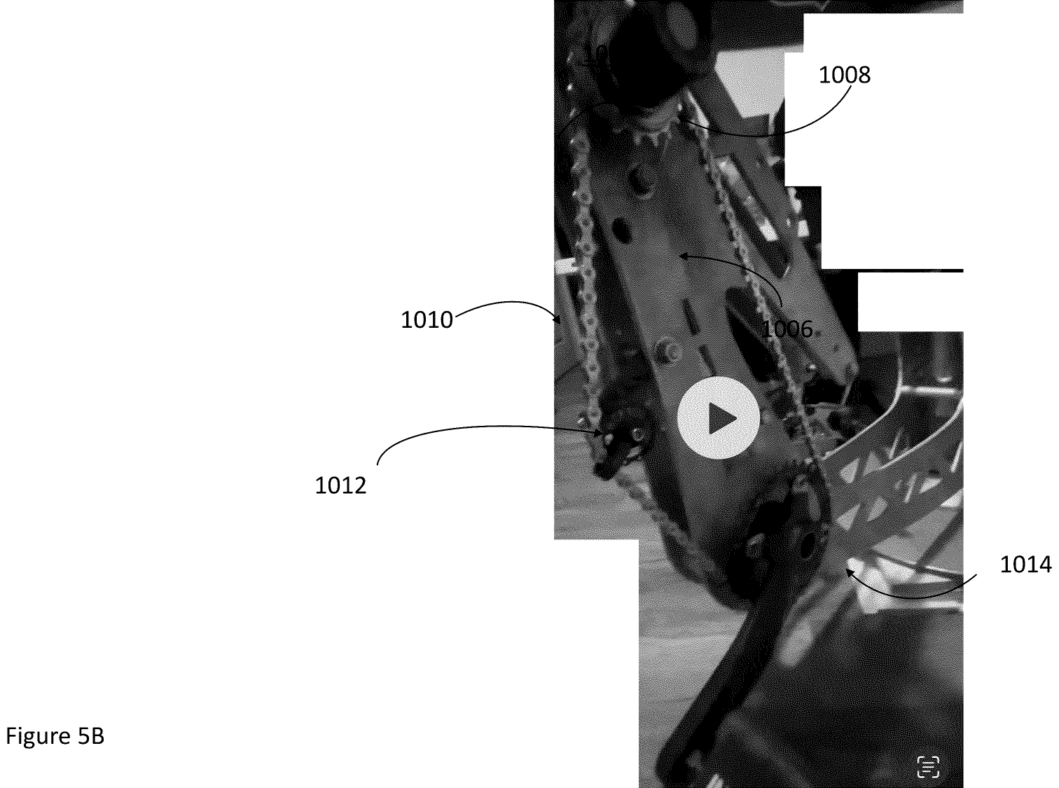

In example embodiments, a one-way clutch is incorporated into the design. This one-way clutch ensures that rotational energy is only coupled to/from the spool 310 in a spool rotational direction that retrieves the line onto the spool, and decouples rotational energy to/from the spool in a spool rotational direction that deploys line from the spool. In one embodiment as shown in FIG. 5A discussed below, the chain or belt 130 is coupled to the driving wheel 134 through a further toothed wheel and one-way clutch that transmits rotational energy to the driving wheel in only one direction and not in the other direction. In this embodiment, the spool 310 can freely turn in a delivery direction to deliver line without turning the driven wheel 134, but turning the driven wheel in a predetermined direction causes the spool to turn in a retrieval direction to retrieve line.

Thus, in example embodiments herein, rotating the pedals 126 in a first direction such as clockwise will cause chain or belt-coupled wheels 128, 136 to turn in respective directions to turn the reel spool 310 in a line retrieval direction (which may be counterclockwise). And in such embodiments, rotation of the spool in a second, line deployment direction opposite the line retrieval direction is decoupled from the drive mechanism external to the reel so some or all of the machine parts external to the reel 300 are not affected and do not turn when the spool is turning in the line deployment or delivery rotational direction. This means a fish hooked on the end of the line can run and pull line against the conventional drag mechanism the reel provides just as if the pedal-driven machine (i.e., 128, 136) were not present (since the machine is decoupled in that rotation direction)—but as soon as a person sitting in the seat 104 turns the pedals 124 with their feet in a particular direction such as clockwise, the machine couples the rotational energy of the pedals to the reel spool 310 to rotate the reel in the retrieval direction and the reel begins retrieving the line under manual force of and controlled by the pedal rotation caused by force applied by the angler's foot or feet.

FIGS. 7-51 together comprise a flip chart animation of an example embodiment showing rotation of pedals 126 in a conventional clockwise rotation direction. These diagrams show how chainring 128 rotates in the same direction as the pedals, which causes the chain or belt to circulate to cause wheel 134 to rotate in that same direction. Since wheel 134 is meshed with upper wheel 136, upper wheel 136 rotates in the opposite direction as wheel 134—in this case counterclockwise. Because upper wheel 136 is connected to drive the spool 310, the spool will rotate in the line retrieval direction which in one embodiment is counterclockwise. However, as can be seen, counterclockwise rotation of the spool under power of the external pedal-driven machine causes the reel's normally hand-operated handle to rotate in the clockwise direction due to the reversing overdrive gear within the fishing reel. Thus, pedaling in a clockwise rotation will cause the reel to operate as if the reel handle were being turned in a clockwise (retrieval) direction. In this case, the gearing within the reel between the spool and the handle operates as a reduction gear with a gear ratio determined by the design of the particular reel. In this embodiment, the reel can be operated by either the foot pedals or the hand or both. A one-way clutch within the reel can be used to decouple the spool from the external driving mechanism when the spool turns in the line deployment direction.

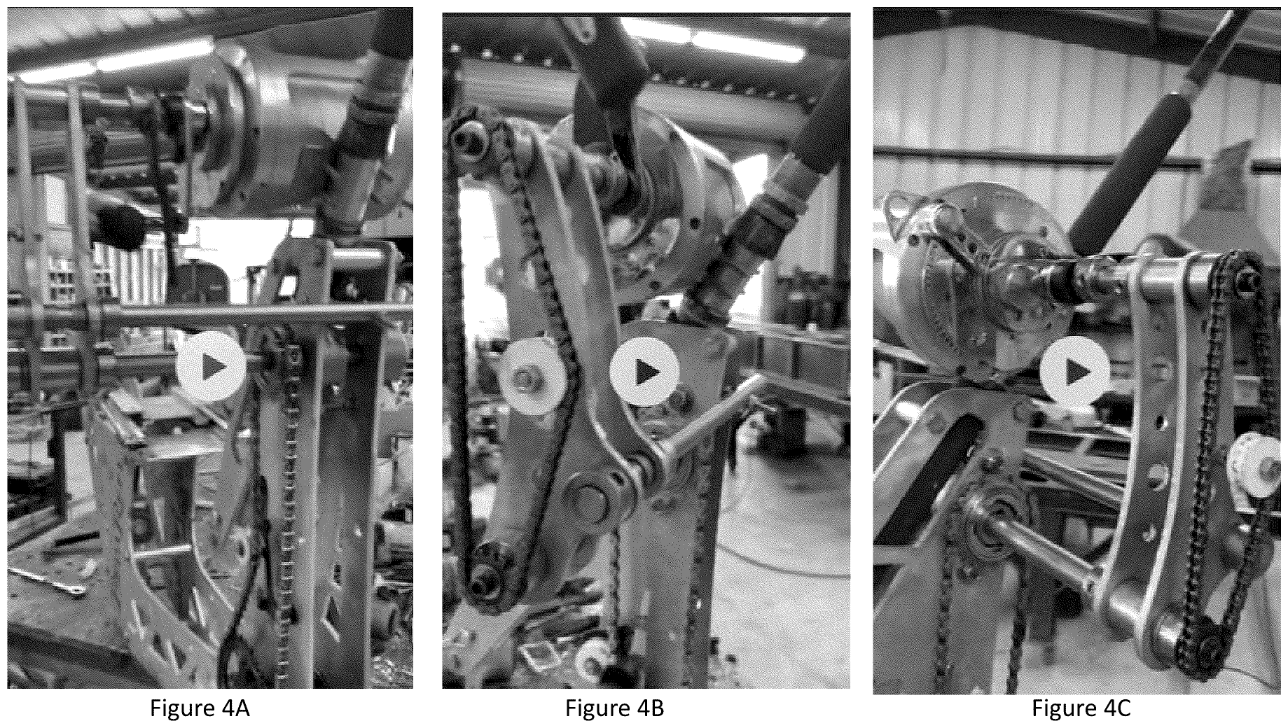

In other embodiments, the reel handle can be disconnected or removed and the reel can be controlled only with the external pedal-driven machine. In still another embodiment, the external pedal-driven machine with no rotation reversal mechanism can be directly coupled to the reel handle of an unmodified reel so clockwise pedal rotation causes clockwise rotation of the reel handle and thus counterclockwise (line retrieval) rotation of the reel spool. In this case the reel operates normally but the reel's handle is turned under the angler's foot power rather than hand power. See e.g., FIGS. 4a, 4b, 4c.

In some embodiments, instead of using a conventional reel, the reel could be redesigned to omit the handle and internal reversing overdrive gearing altogether. In such embodiments, the external pedal-driven machine is directly coupled to the spool within the reel through a one-way clutch so rotation of the pedals in a predetermined direction such as clockwise will cause the spool to rotate in a line retrieval rotational direction such as counterclockwise. The line retrieval rotational direction of the fishing reel may depend on how the line is spooled onto the spool of the reel and so could be changed from one rotational direction to the other rotational direction if desired.

First Embodiment where External Machine Turns Reel Handle

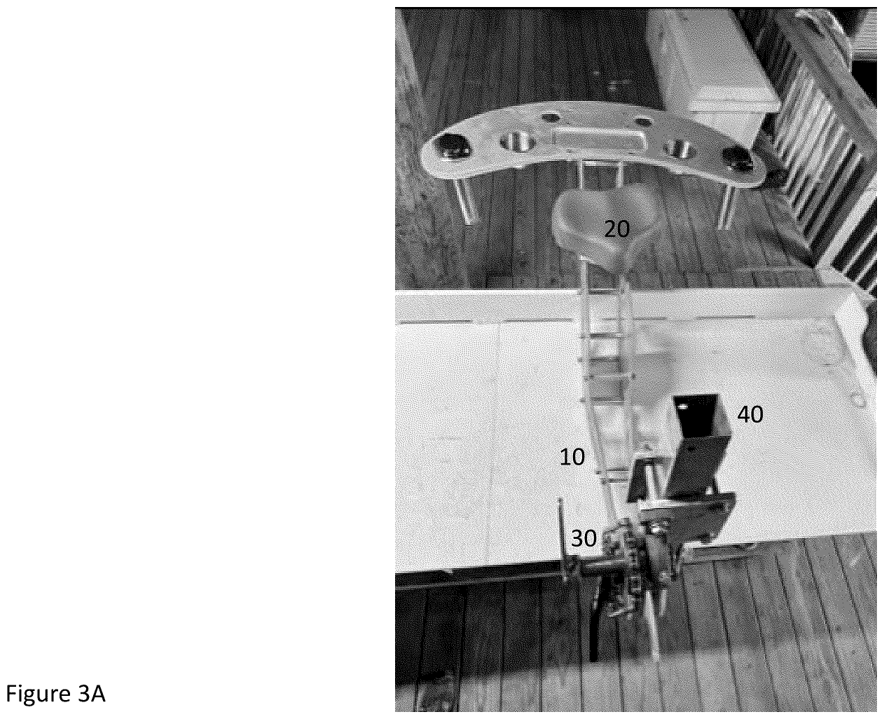

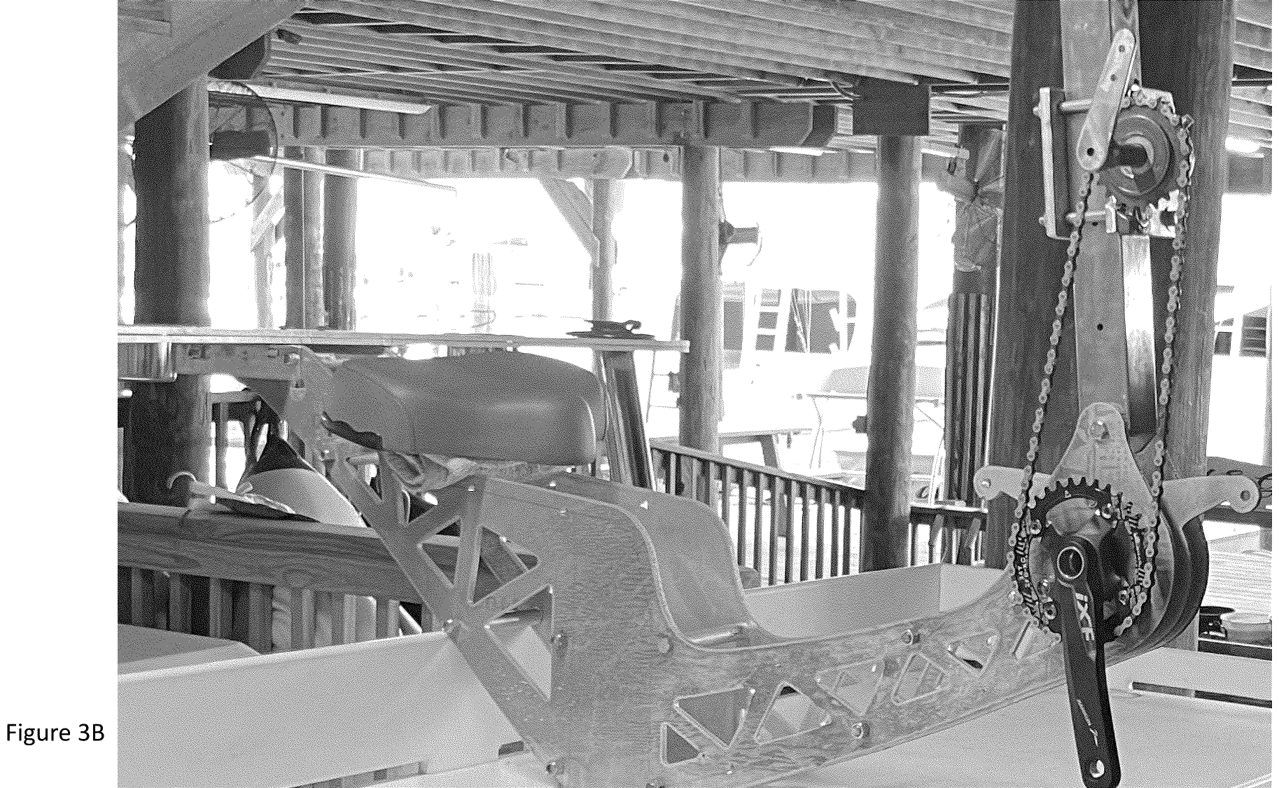

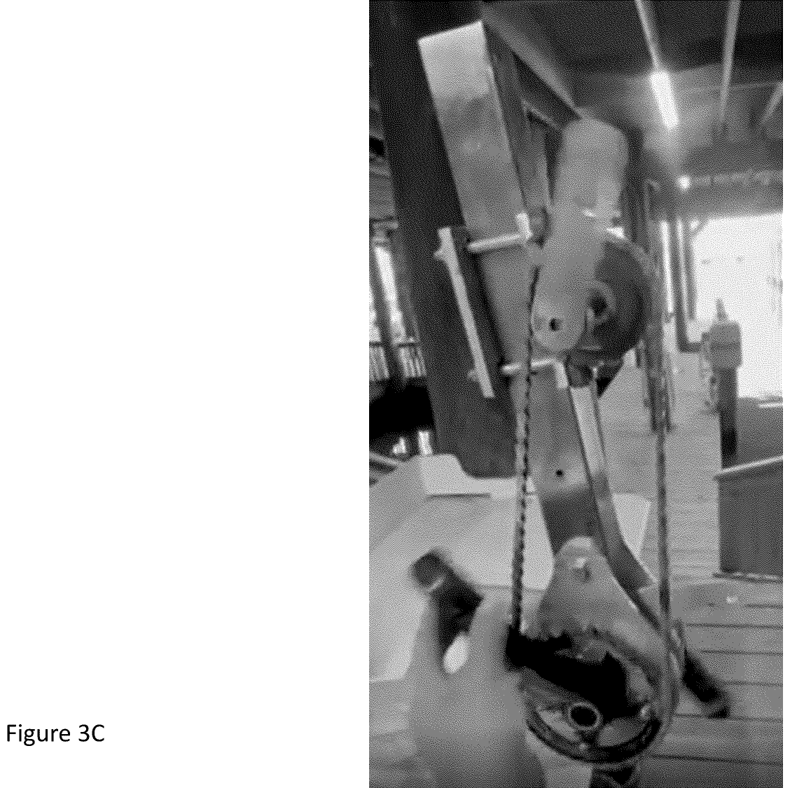

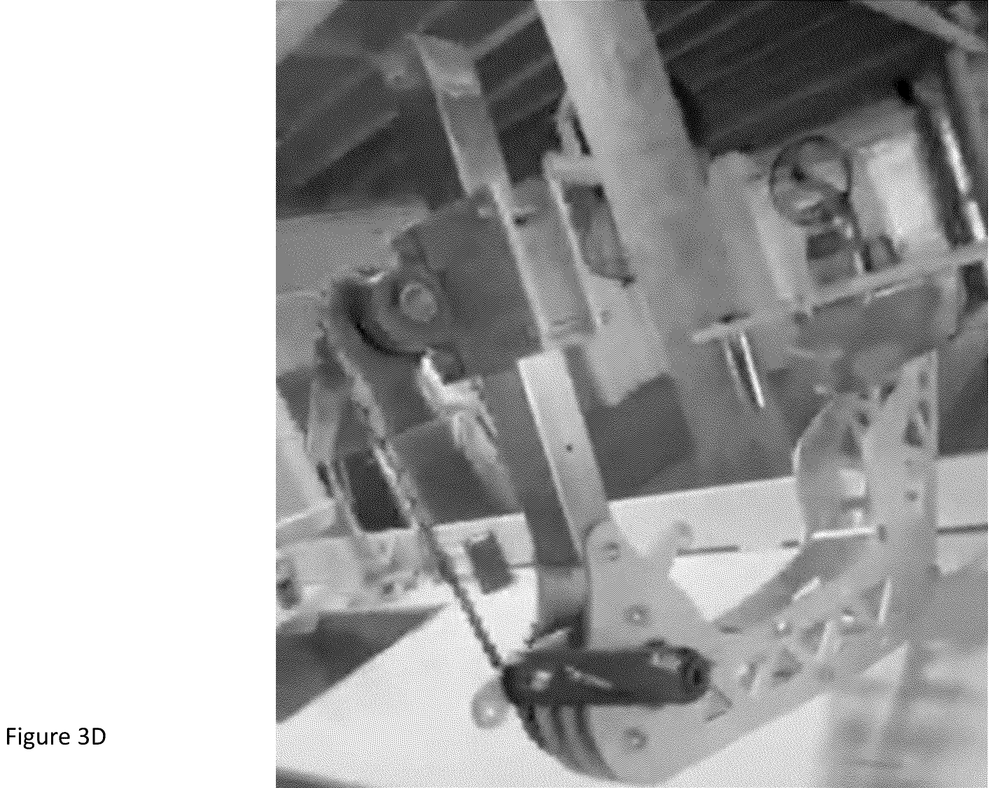

FIGS. 3A-3D and 4A-4C shows a specific example fighting chair with a lower body (e.g., leg and foot) operated mechanism for operating a fishing reel. The fighting chair shown includes a structure 10 supporting a seat 20, a rotary pedal mechanism 30, a rod mount and a reel mount 40. The structure 10 may be mounted to a conventional upright pedestal of the standard type and dimensions for mounting onto the deck of a boat.

In the example shown, the structure is mounted to the pedestal on gimbals so the entire fighting chair is able to rotate (e.g., about multiple axes in multiple degrees of freedom) about the pedestal pivot point. The seat 20 may have a back and arm-rests, and can be adjustable for the length of the angler's legs. The Figure also shows a rear table platform that can support an umbrella, drinks, etc.

When an angler sits on the seat 20, they can adjust the seat to place their feet onto rotary pedal mechanism 30. Pedal mechanism 30 in one embodiment includes a conventional bicycle hub and sprocket assembly with foot pedals mounted on each side. The angler may place their left and right feet onto the respective pedals and pedal as they would pedal a bicycle. Positioning the feet in this way provides stability to keep the angler in the fighting chair as the fighting chair rotates and/or pivots. Rotating the foot pedals also generates a rotational torque that is mechanically coupled to the fishing reel in order to retrieve the fishing line onto the spool of the reel.

In one embodiment, this rotational torque or force is mechanically coupled to a conventional fishing reel such as shown in FIG. 1, to enable the angler to retrieve fishing line onto the spool of the fishing reel by pedaling the rotary pedals in a predetermined direction. In one embodiment, a conventional fishing reel retrieves fishing line by rotating a handled shaft on the righthand side of reel in a clockwise direction. In such embodiment, an extension to said shaft on the lefthand side of the reel is rotated in a counterclockwise direction (which is the same as rotating the right-hand handled shaft in a clockwise direction) by foot-operated rotary pedal power.

In one embodiment, the coupling between the pedal sprocket and the fishing reel is unidirectional—that is, pedaling in one direction such as clockwise or “forward” rotation as if riding a bicycle causes the reel to retrieve fishing line onto the spool of the reel to pull a hooked fish closer to the boat or otherwise retrieve the line, whereas pedaling in an opposite direction such as counterclockwise or “reverse” rotation does not rotate or affect the spool. In another embodiment, pedaling in one direction such as clockwise or “forward” as if riding a bicycle is decoupled from the reel and thus does not rotate or affect the reel operation, whereas pedaling in an opposite direction such as counterclockwise or “backward” causes the reel to retrieve fishing line onto the reel spool to pull a hooked fish closer to the boat. In some embodiments both directions of pedal rotation are mechanically coupled to the spool, whereas in other embodiments only one direction of pedal rotation is mechanically coupled to the spool.

As is well known, conventional reels have adjustable drag mechanisms that can be set to automatically provide a desired amount of resistance to fishing line being fed out of or deployed from the reel such as when the fish is running after being hooked by a hook tied to the end of the fishing line. During such times, an angler does not need to turn the rotary handle of a conventional reel or otherwise control the reel in any way to deploy more fishing line—rather, the game fish pulls fishing line from the reel against the force of the spool's drag. When the fish tires and the fishing line goes slack, the angler begins pedaling with their feet in an appropriate direction to turn the spool of the reel in an appropriate direction to retrieve the fishing line onto the spool. The faster the angler pedals, the faster the reel spools in (retrieves) the fishing line. The more force the angler's foot or feet exerts onto the pedals, the more force the reel exerts against a fish trying to pull the fishing line out of the reel. The manual force the angler's feet apply is thus pitted against the force of the running fish trying to swim away from the boat. In one embodiment, an assistant can rotate the chair so it faces the direction of the fish—following the fish. In this way, the angler can reel in a fish hooked on the fishing line by using their calf and thigh muscles to pull the fish closer to the boat with no hands or hand manipulation at all (the only angler-operated control of spool rotation comes from foot pedal operation, and the spool rotates only in response to (a) a fish pulling line from the reel or (b) the angler rotating the pedals to retrieve line onto the reel). When the fish tires and has been pulled close to the boat, an assistant can use a device such as a gaffer (hook) or a net to bring the exhausted fish onto the boat.

### One Example Mechanical Drive Embodiment

FIGS. 4A-4C shows a side perspective view detailing one embodiment of the pedal mechanism. This Figure shows a lower sprocket that is rotatable about a hub by applying force to one or a plurality of a pedal crank arms. While not shown in this Figure, there are generally two pedal crank arms (one on either side of a hub axle as on a conventional bicycle) each supporting a respective foot pedal, the crank arms being angularly offset from one another (e.g., by 90 degrees as on a conventional bicycle).

In the example shown, a conventional bicycle chain or a toothed belt is meshed to teeth of the sprocket so the chain or belt circulates as the sprocket rotates under the rotational torque the angler's feet apply to the rotary pedals. The chain or belt is meshed to the teeth of an upper sprocket that also rotates as the chain or belt circulates. The upper rotatable sprocket may have a smaller diameter than, the same diameter as, or a larger diameter than the lower sprocket to provide a suitable overdrive or other gear ratio as desired. In one example embodiment, the ratio is 2:86 to 1 but other ratios can be used so that for example one full rotation of the rotary pedals could correspond to four or five or 6 or 7 rotations of the reel spool to retrieve the fishing line. As noted below, if the external machine operates the reel handle, the reel itself may typically internally provide a ratio of reel handle shaft turns to spool turns that multiplies the gear ratio provided by the pedal-driven mechanical drive assembly provided external to the reel.

As shown in FIG. 4A-4C, in one embodiment the upper rotatable sprocket is coupled to a lever arm. The lever arm rotates with the upper sprocket. In one embodiment, the lever arm is coupled to the winding lever of the reel handle or reel handle coupling of a conventional fishing reel

FIGS. 4A, 4B and 4C show one example mechanism for coupling the upper sprocket to a fishing reel handle arm. In this example, a shaft mounted to the upper sprocket couples the upper sprocket to a further sprocket and associated chain which rotates yet another sprocket and associated shaft that in turn rotates the spool of the fishing reel. Other coupling mechanisms are possible as described below. The function to be achieved is to allow the angler to retrieve fishing line onto the reel spool by rotating the pedals with their feet. FIGS. 4A, 4B and 4C further show a mounting structure for mounting the end of a fishing rod in proximity to the reel.

### Another Example Mechanical Drive Embodiment Directly Coupled to the Spool

FIGS. 5A and 5B show example drawings of a further embodiment wherein a conventional fishing reel is modified or redesigned to couple the external manual drive mechanism described above to the spool directly rather than through the handle. It should be understood that “directly coupled” in this context does not include a one-way clutch or other coupling mechanism so the pedals are coupled to the spool for only one rotation direction and not for the other rotation direction.

FIG. 5B shows a side cross-sectional view where a shaft 500 fixedly attached to a reel spool 502 is attached via a drag mechanism 506 to an external coupler 508 and has an end that extends outside of the reel housing. Shaft 500 has a toothed gear mounted on the end thereof. A removably housing 510 can be attached with a spring-loaded arrangement to give access to the gear while preventing hair, fishing line etc. from getting caught in the gear mechanism.

In this embodiment, the reel 1000 is modified as discussed above to replace the typical internal shaft driving the spool to retrieve fishing line onto the spool with a longer, bearing-mounted shaft having a first distal end 1002 that protrudes out of a side surface of the reel housing as shown in FIG. 2E. A toothed gear 1004 is fixedly mounted to the protruding first distal end 1002 of the bearing-mounted spool shaft. The second (opposite) distal end of the bearing-mounted spool shaft may in some embodiments continue to be coupled to the conventional lever and handle so the same setup can be used either with either hand control or foot control. In other embodiments, the hand control can be disabled or not present by removing the spool lever and handle, e.g., for tournament use.

When the toothed gear 1004 is rotated counterclockwise, the shaft it is connected to rotates counterclockwise to spool in (retrieve) fishing line onto the spool. When the spool rotates clockwise to allow fishing line to spool out (deploy fishing line), the toothed gear 1004 does not rotate due to a one-way clutch assembly in one embodiment that may be internal to the reel. The spool instead rotates free of the shaft, with the rate of spool rotation typically being controlled by the drag mechanism and associated drag control of the reel. Thus, no counter-rotation force of the spool is transmitted to the toothed gear 1004 or to pedals coupled to the toothed gear, and the angler's feet and legs can remain stationary (or in any position) as the reel feeds fishing line out without interfering with or otherwise affecting spool movement and fishing line deployment.

As FIG. 5A, 5B further shows, the gear 1004 may be coupled to a chain or belt 1006 that is also coupled to an intermediate rotatable gear 1009 such as a bushed roller chain sprocket. The gear 1009 is in turn coupled via a uni-direction coupling (e.g., a one-way clutch bearing) to a further toothed gear 1008. Thus, gear or wheel 1008 will turn when gear 1009 is rotated in one direction, but will not turn when gear 1009 rotates in the opposite direction, due to the effect of the one-way clutch that directionally couples rotational energy from gear 1009 to gear or wheel 1008.

A further chain or belt 1010 connects gear 1009 to a further gear 1014 coupled to a hub that rotates with the pedals. This further gear 1014 may be a conventional bicycle pedal crank arm and sprocket assembly connected to one end of a conventional pedal axle, the other end of the pedal axle being connected to an additional pedal, the pedal axle passing through the hub that is mounted to the frame of a fighting chair.

The relative diameters of gears 1004, 1008/1009, 1014 can be designed to provide a suitable overall gear ratio so a desired angle of rotation of the pedals corresponds to a desired angle of retrieval rotation of the reel spool. In this embodiment, any internal gearing within the reel does not affect the ratio of pedal rotation to spool rotation because the external machine is directly coupled to the spool rather than being coupled through the handle and its overdrive gearing. One can see from the FIG. 7 et seq flip chart animation that the embodiment shown has an overdrive ratio of around 4:1—that is, one complete turn of the pedals will cause the reel spool to rotate four times in the retrieval direction. However, suitable ratios could be 3:1 or 3.1:1 or 3:2 to 1 or 3.3:1 or 3.4:1 or 3.5:1 or 3.6:1 or 3.7:1 or 3.8:1 or 3.9:1 or 4:0 to 1 or 4.1:1 or 4.2:1 or 4.3:1 or 4.4:1 or 4.5:1 or 4.6:1 or 4.7:1 or 4.8:1 or 4.9:1 or 5.0:1 or 5.5:1 or 6.0:1 or 6.5:1 or 7.0:1 or 7.5:1 or 8.0:1, as determined by the relative diameters of wheels 128, 134, 136. In one embodiment, the ratio could be changed in a conventional fashion by swapping wheels or using a conventional series of chainrings of different diameters with a bicycle derailleur.

In one embodiment, a conventional chain tensioning roller wheel and associated assembly mounted on a spring or other biasing means such as found on many bicycles ensures the chain or belt 1010 maintains proper tension so gears 1008, 1014 turn as the pedals rotate. Other embodiments use a different tensioning assembly or omit the tensioning assembly (e.g., by using a prestretched chain or belt of the precisely correct size, or by providing a tension adjustment on the reel mount).

In one embodiment, the unidirectional coupling (e.g., one-way clutch bearing) between gears 1008, 1009 couple only one direction of rotation of chain or belt 1010 to rotate chain or belt 1006, while in one embodiment permitting the pedals to rotate freely in the other direction (or at least not forcing the pedals to rotate in the opposite direction) without turning the reel spool and instead allowing the reel spool to turn freely (i.e., the reel in one embodiment has conventional internal mechanisms that allows the reel spool to turn freely in the fishing line feed-out rotational direction subject to adjustable drag tension settings while causing the reel spool to turn in the fishing line retrieval direction with rotation of shaft 1002).

In this example, clockwise rotation of the pedals causes the chains or belts 1010 and 1008 to rotate clockwise, thus rotating the reel spool shaft counterclockwise to retrieve or reel in fishing line. In another example embodiment, counterclockwise rotation of the pedals could cause the chains or belt 1010, 1008 to rotate counterclockwise, rotating the reel spool clockwise to retrieve or reel in fishing line. In either embodiment, one direction of pedal rotation does not rotate the reel spool, whereas the other direction of pedal rotation rotates the reel spool to retrieve or reel in fishing line. Other embodiments may rely on the reel itself to mechanically decouple the spool from the spool drive shaft for fishing line deployment. The example fighting chair provides no mechanical advantage such as from a motor, spring or other drive. Rather, all rotational power comes from the angler's legs. This potentially means the angler could qualify for a record or prize when reeling in and catching a world or local record fish.

As shown, a rod holder may be mounted in front of the reel to accept the butt of a rod, which may be securely clamped into the rod holder. The fishing line from the spool may be threaded through eyelets on a rod that extends from the butt of the rod. The angler can change the attitude of the rod from horizontal by tipping or pitching the entire chair forwarded and backward, thereby using the rod as a lever against the force applied to the fishing line by a running fish.

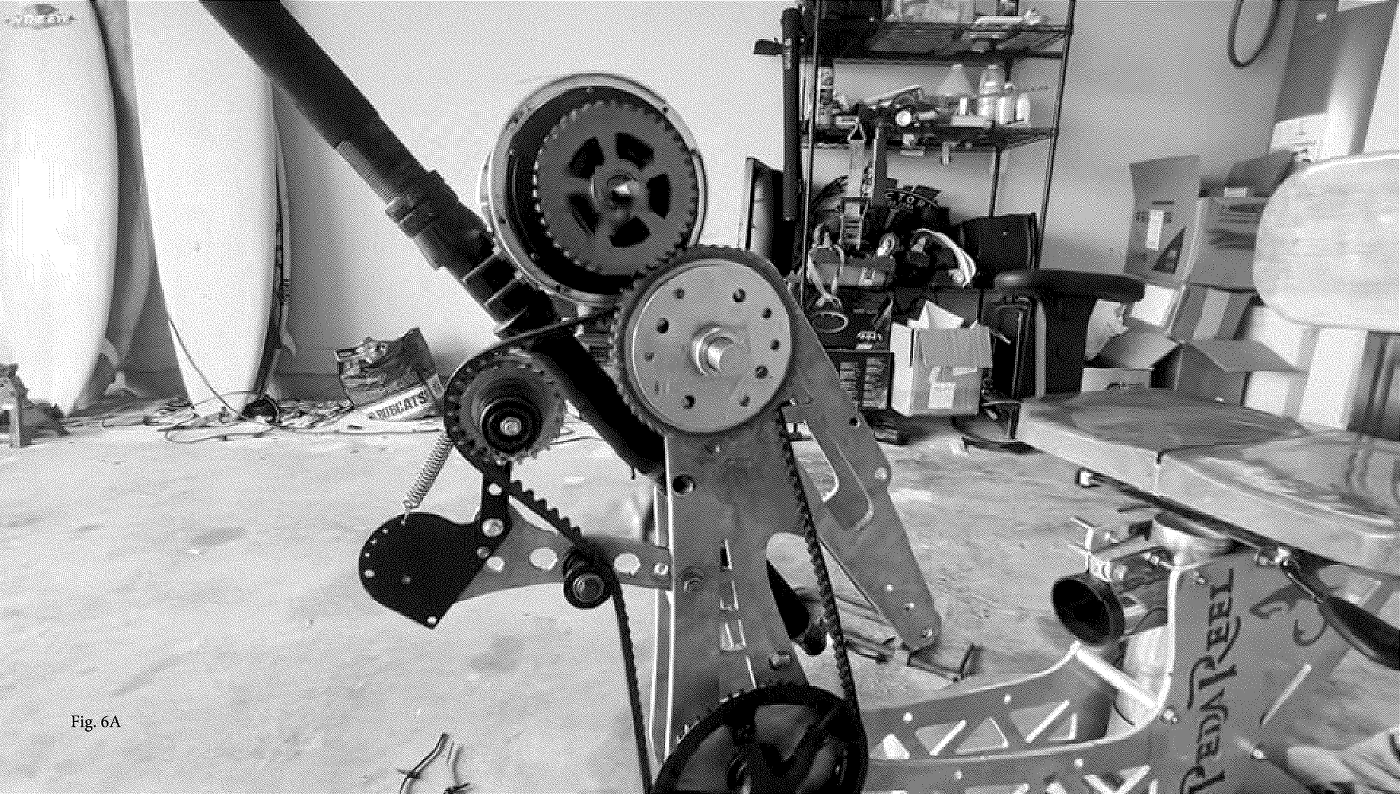

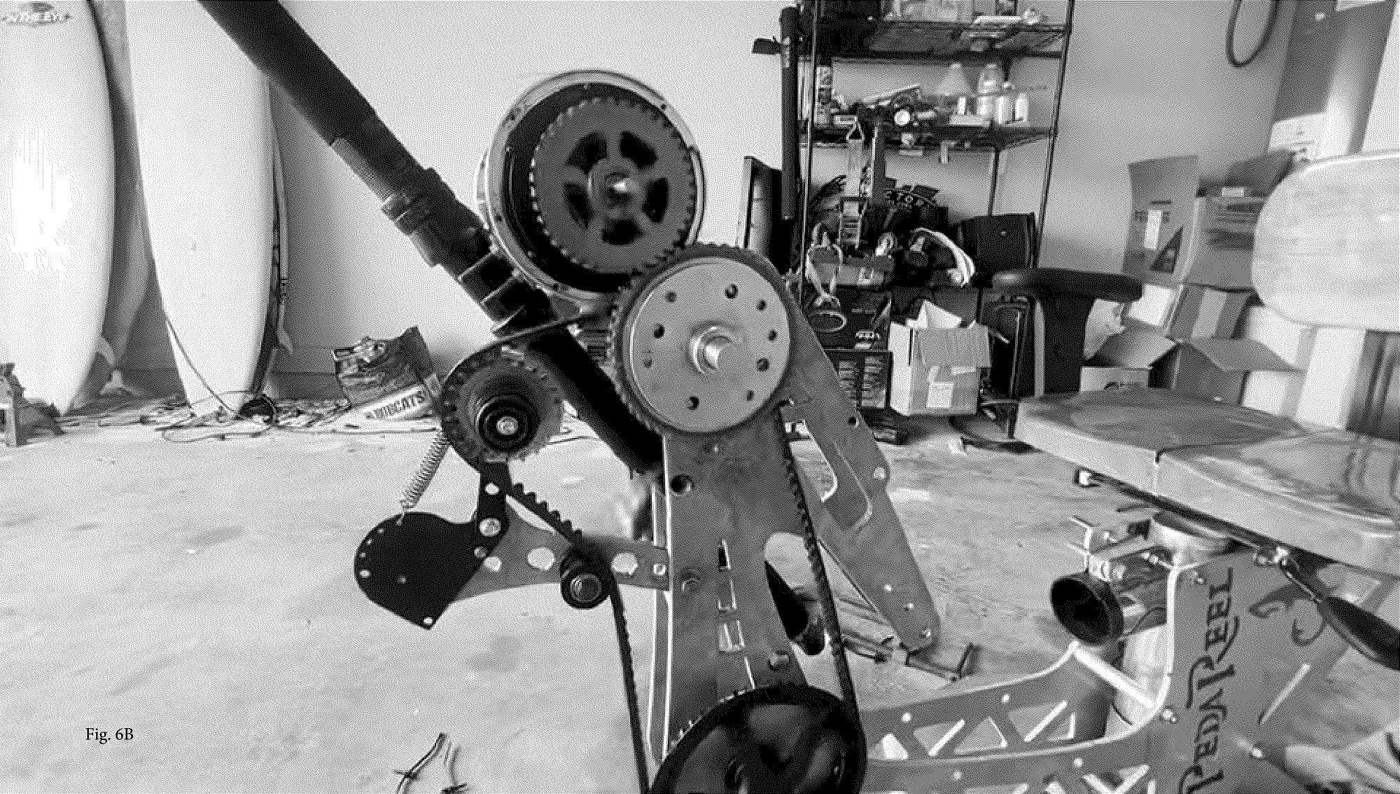

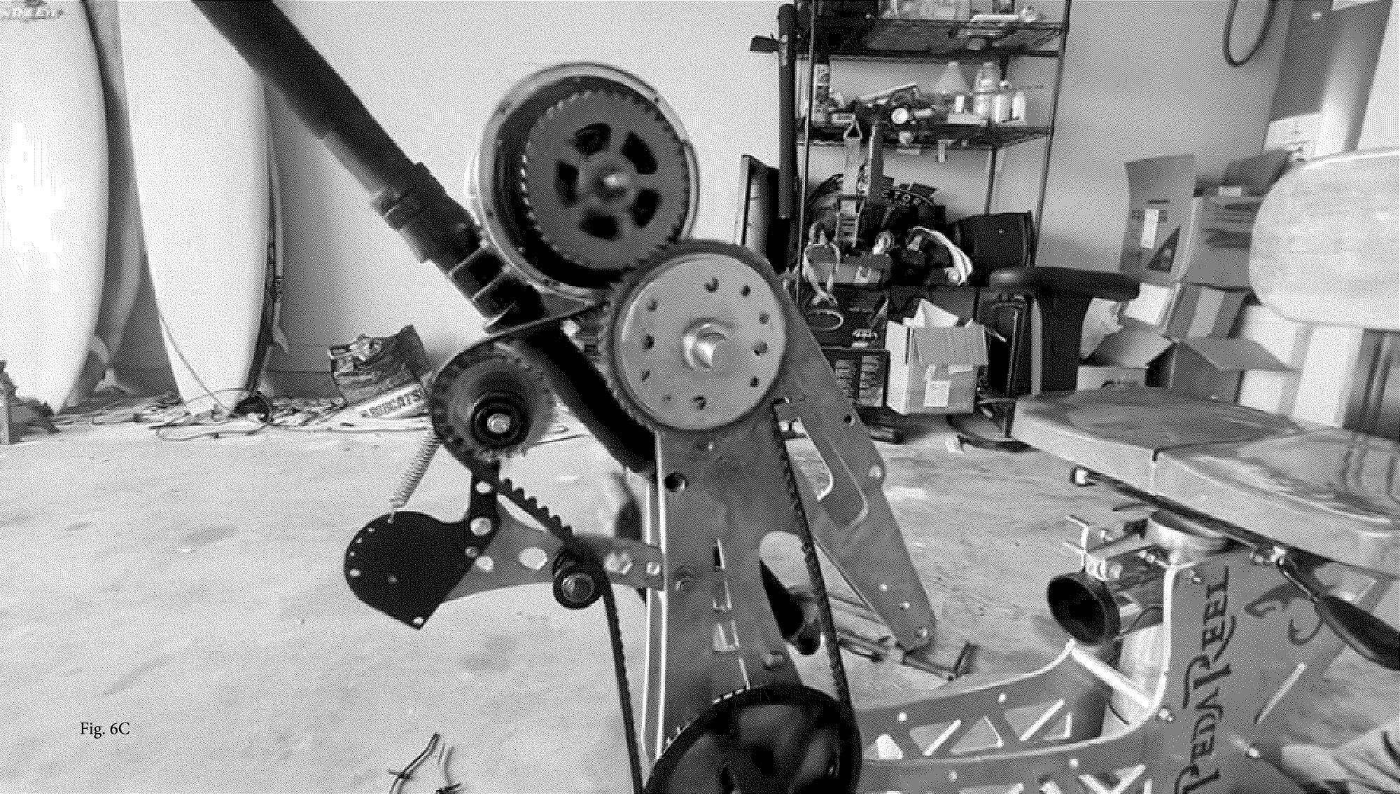

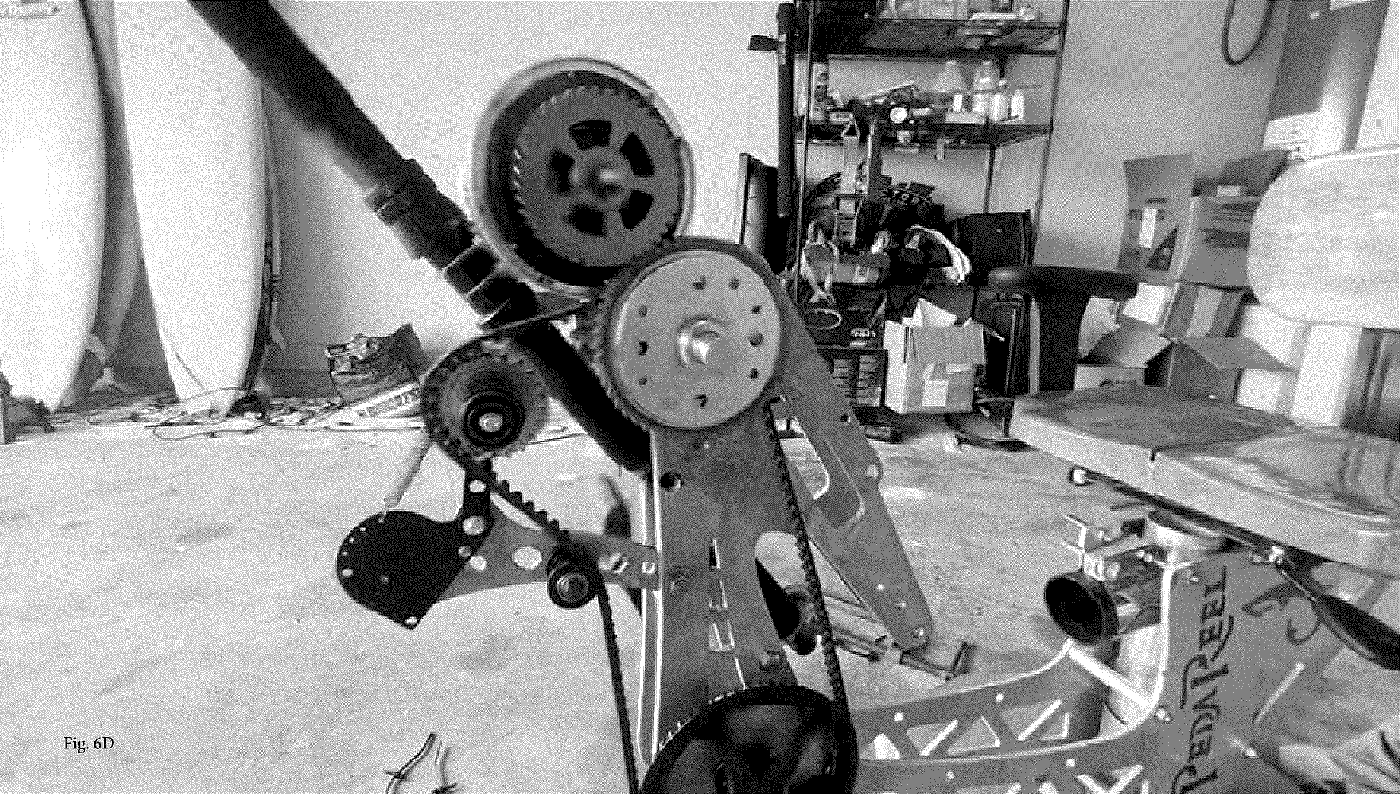

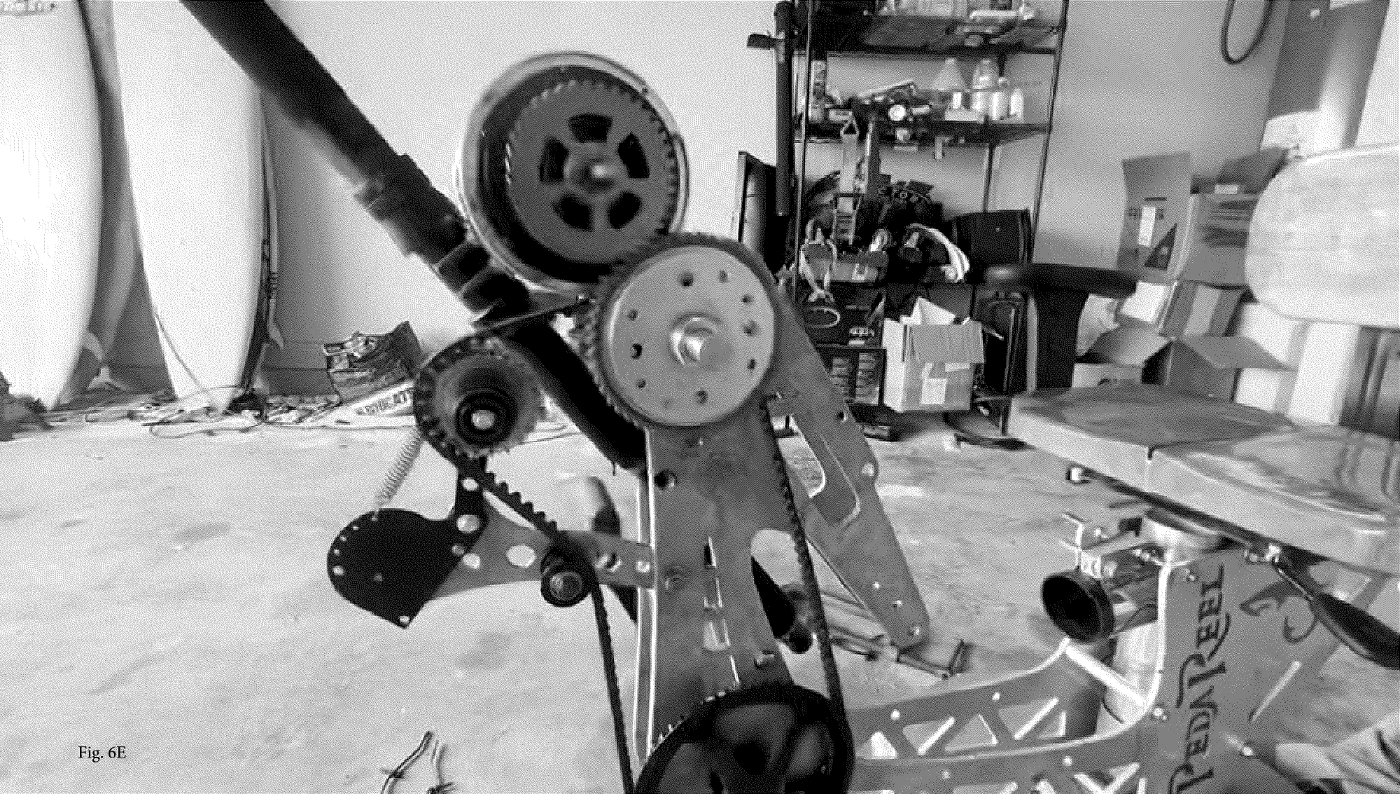

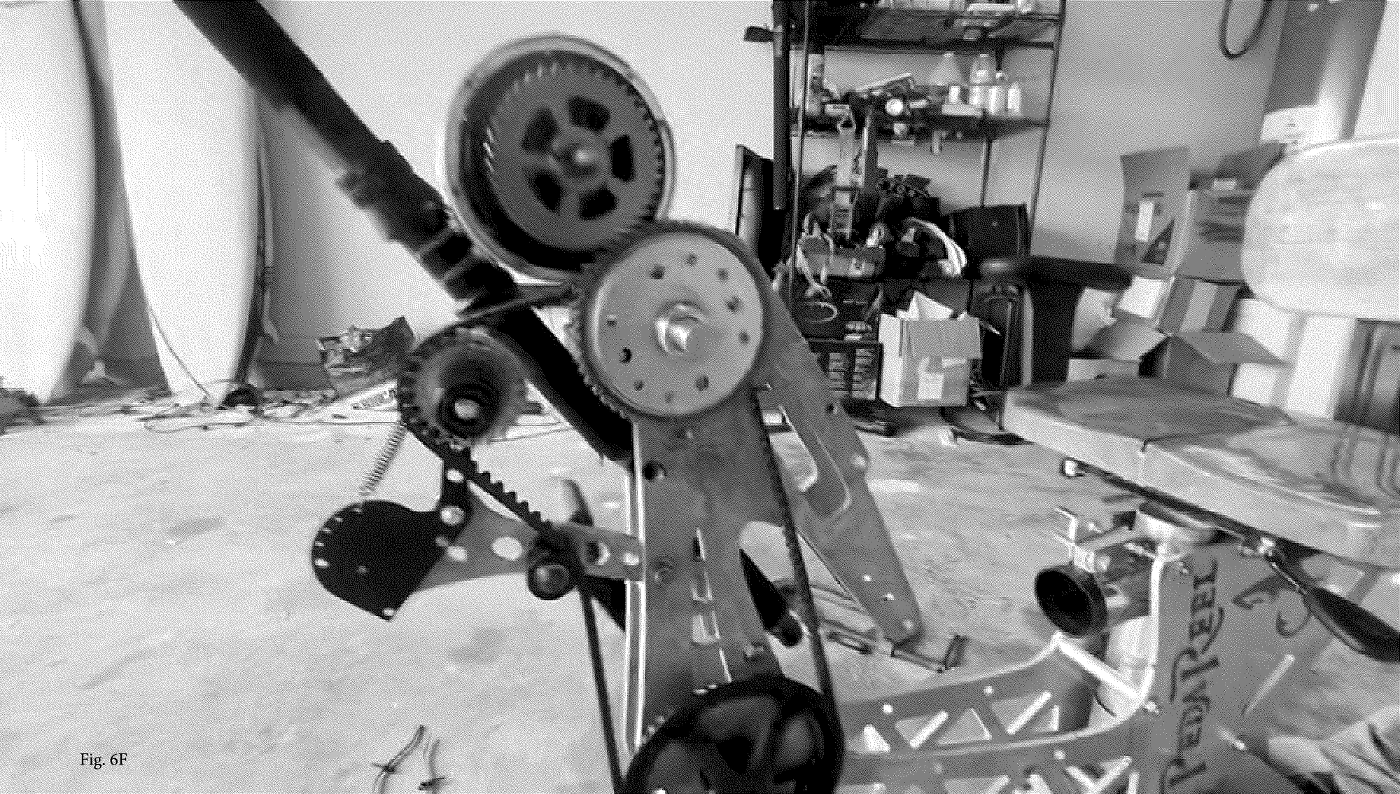

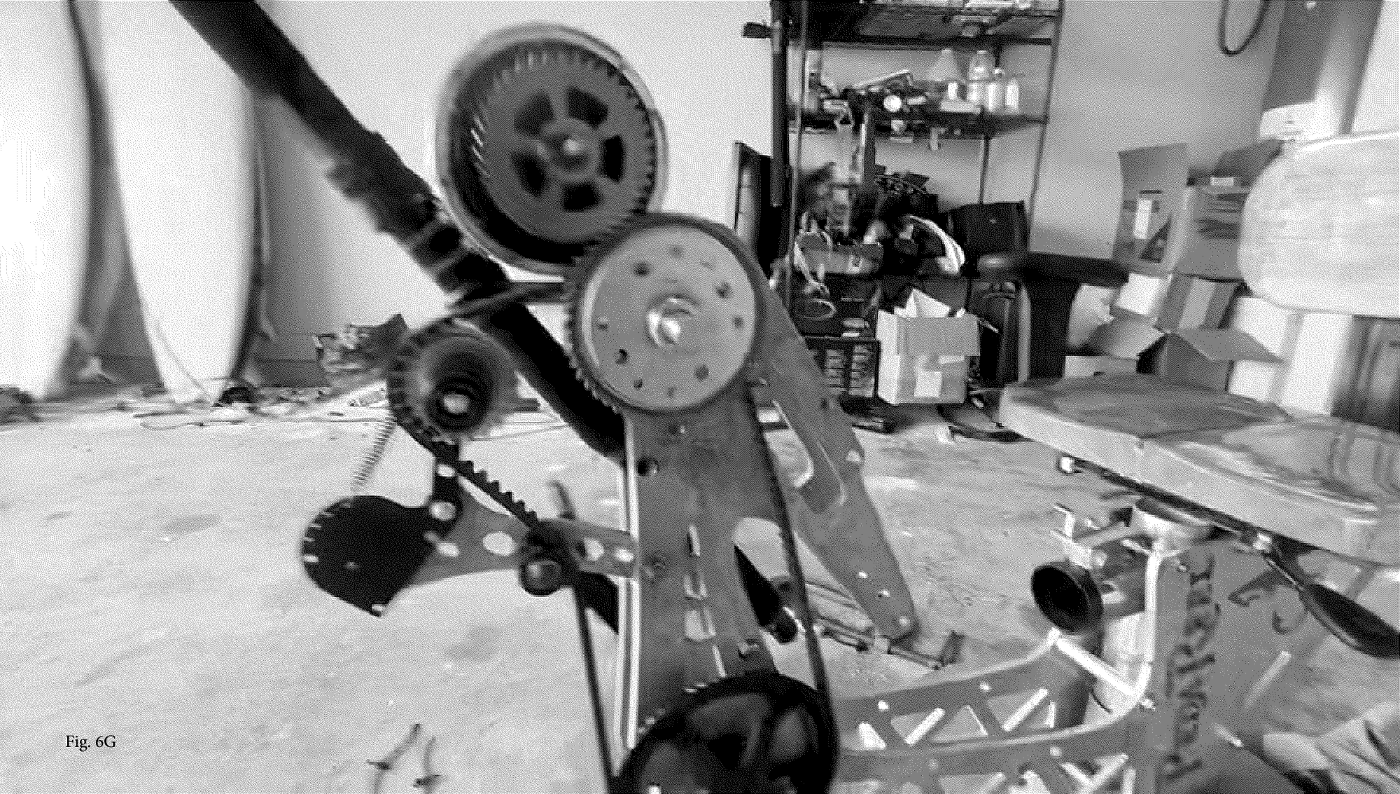

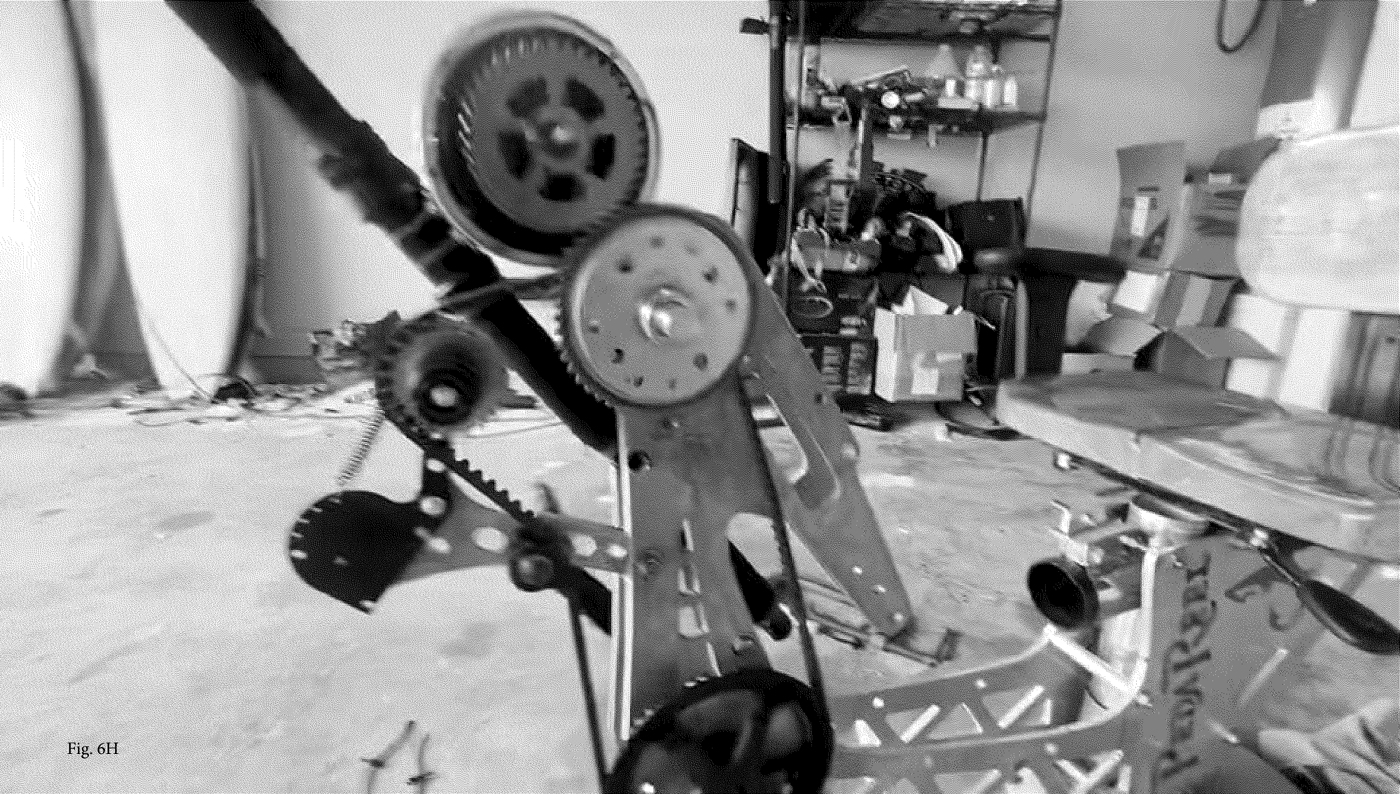

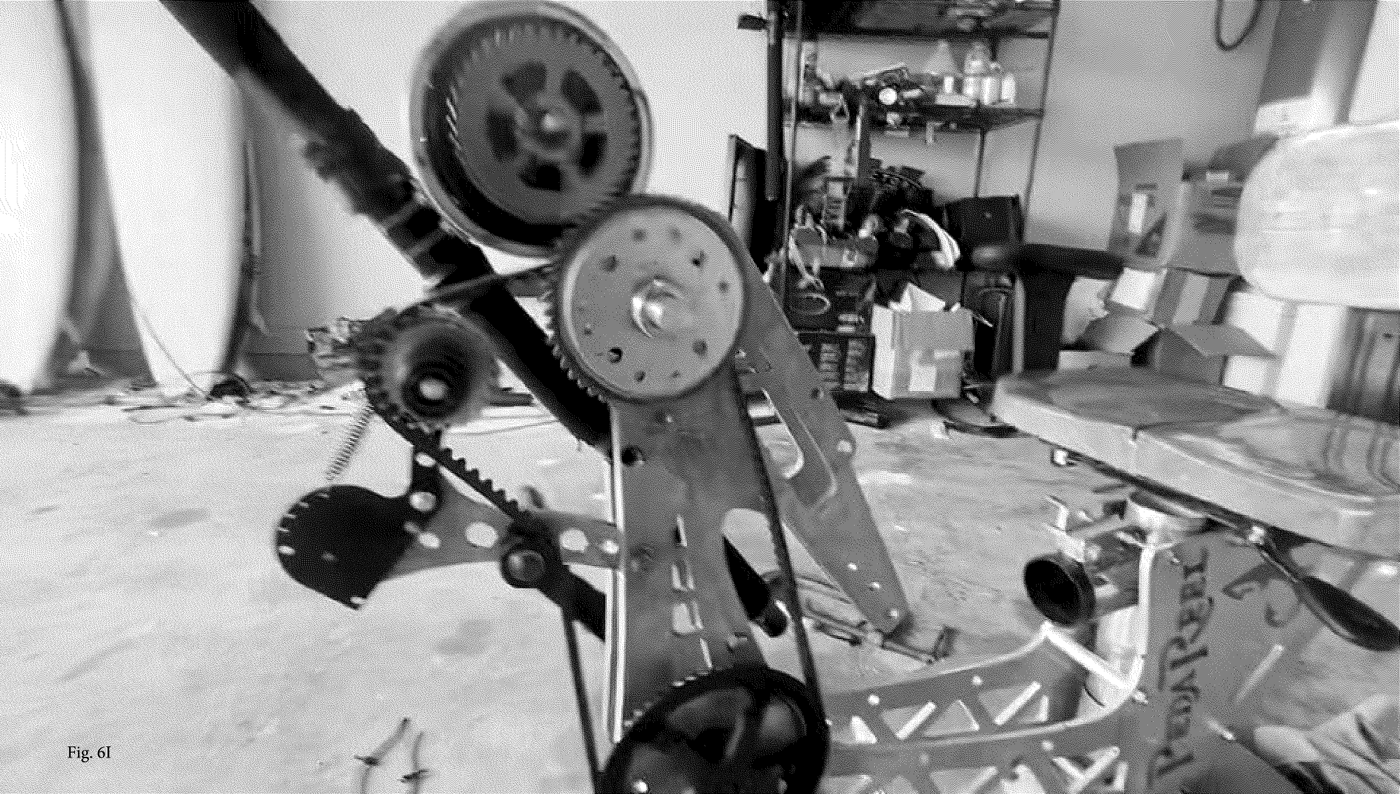

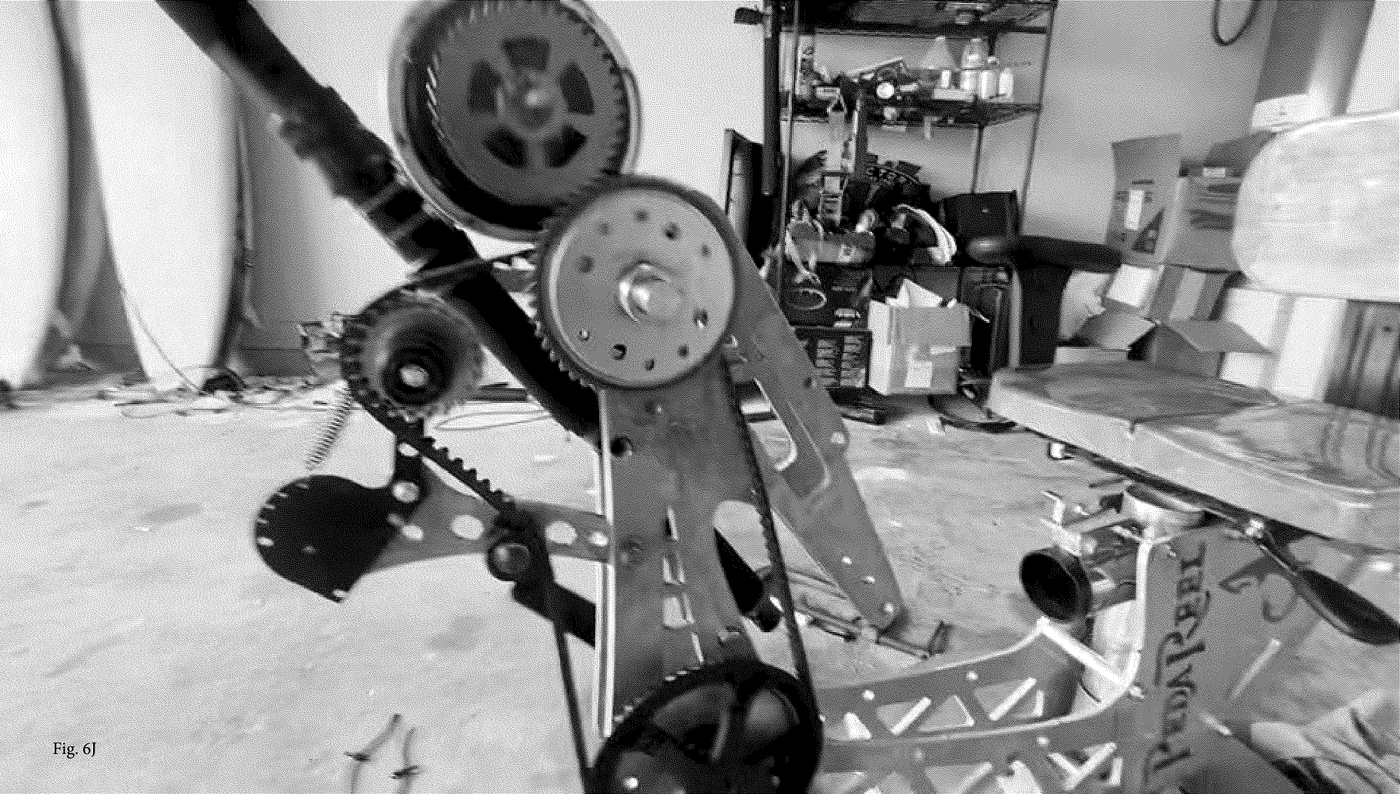

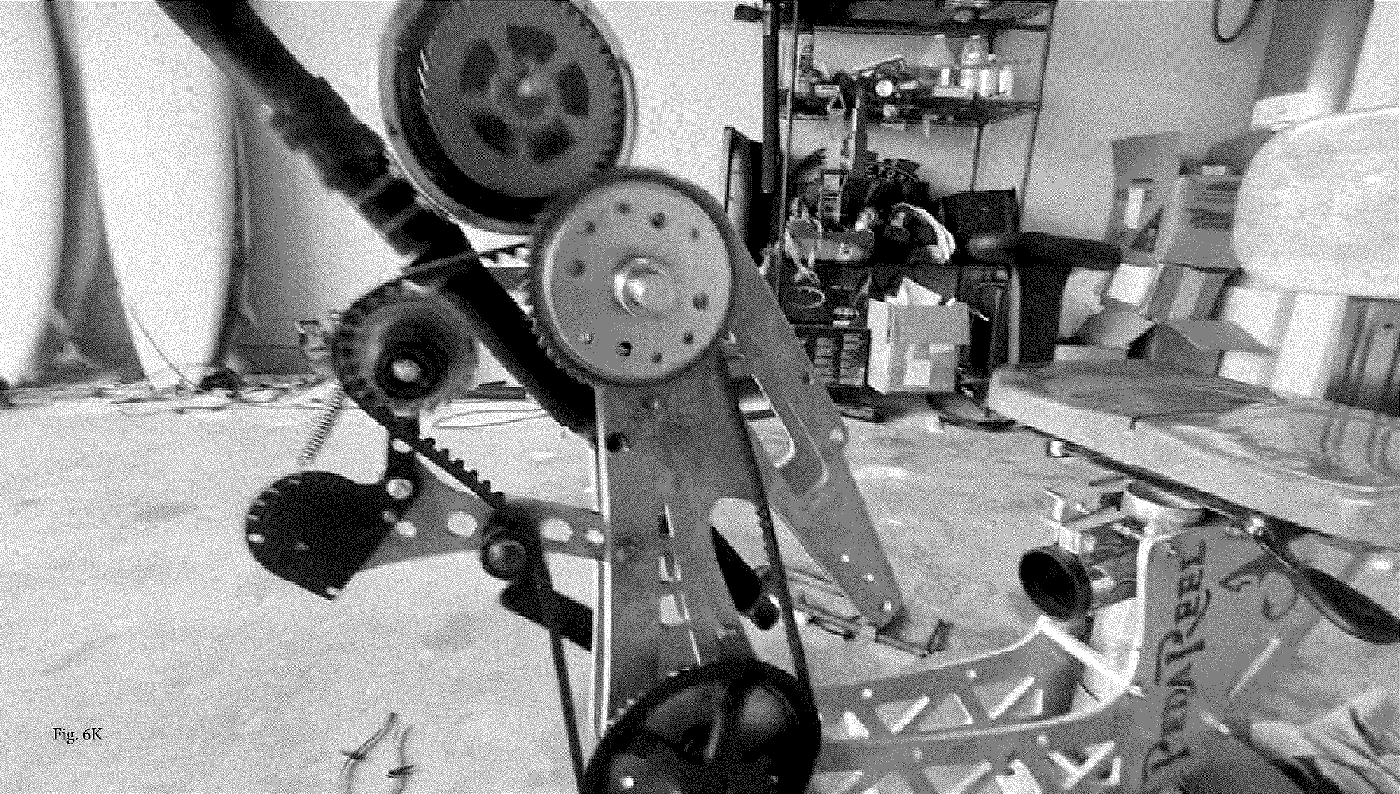

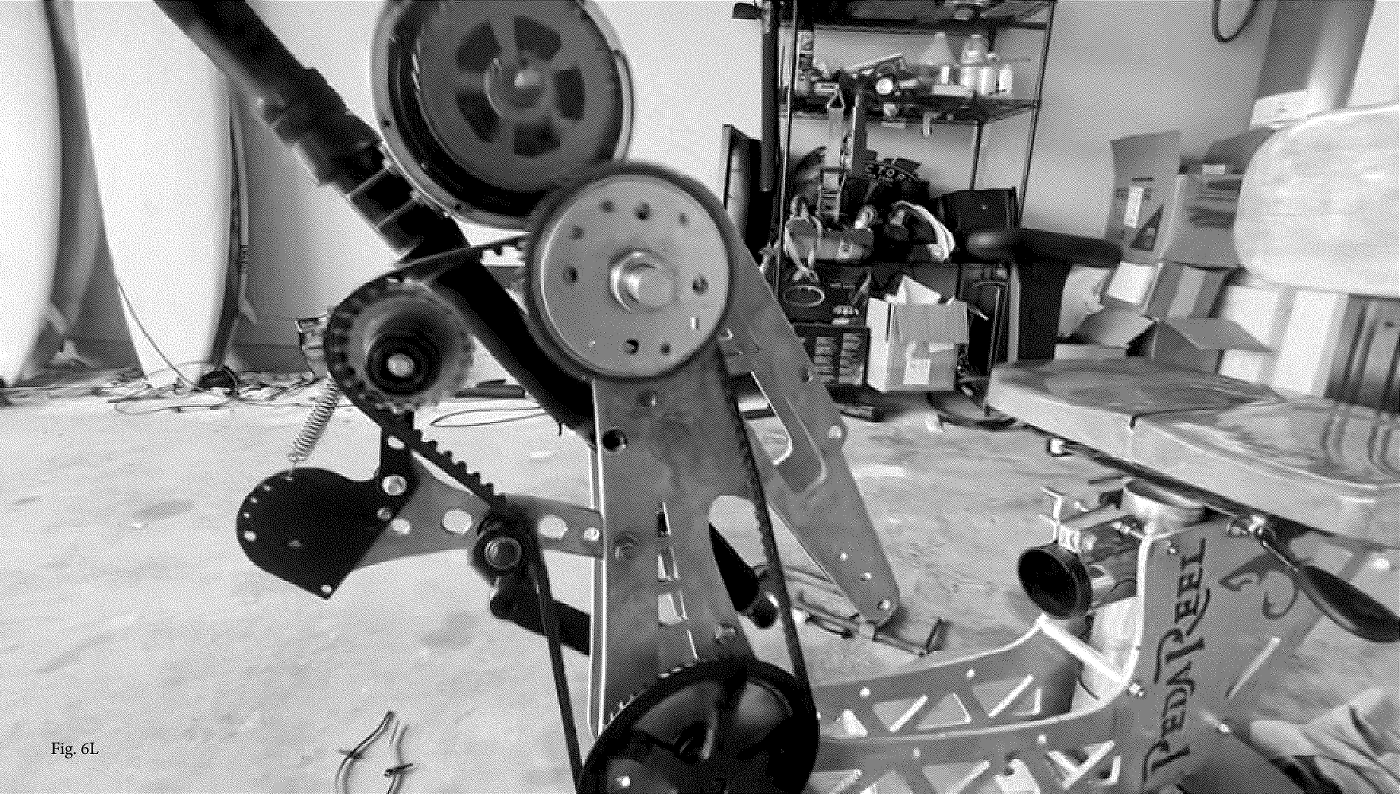

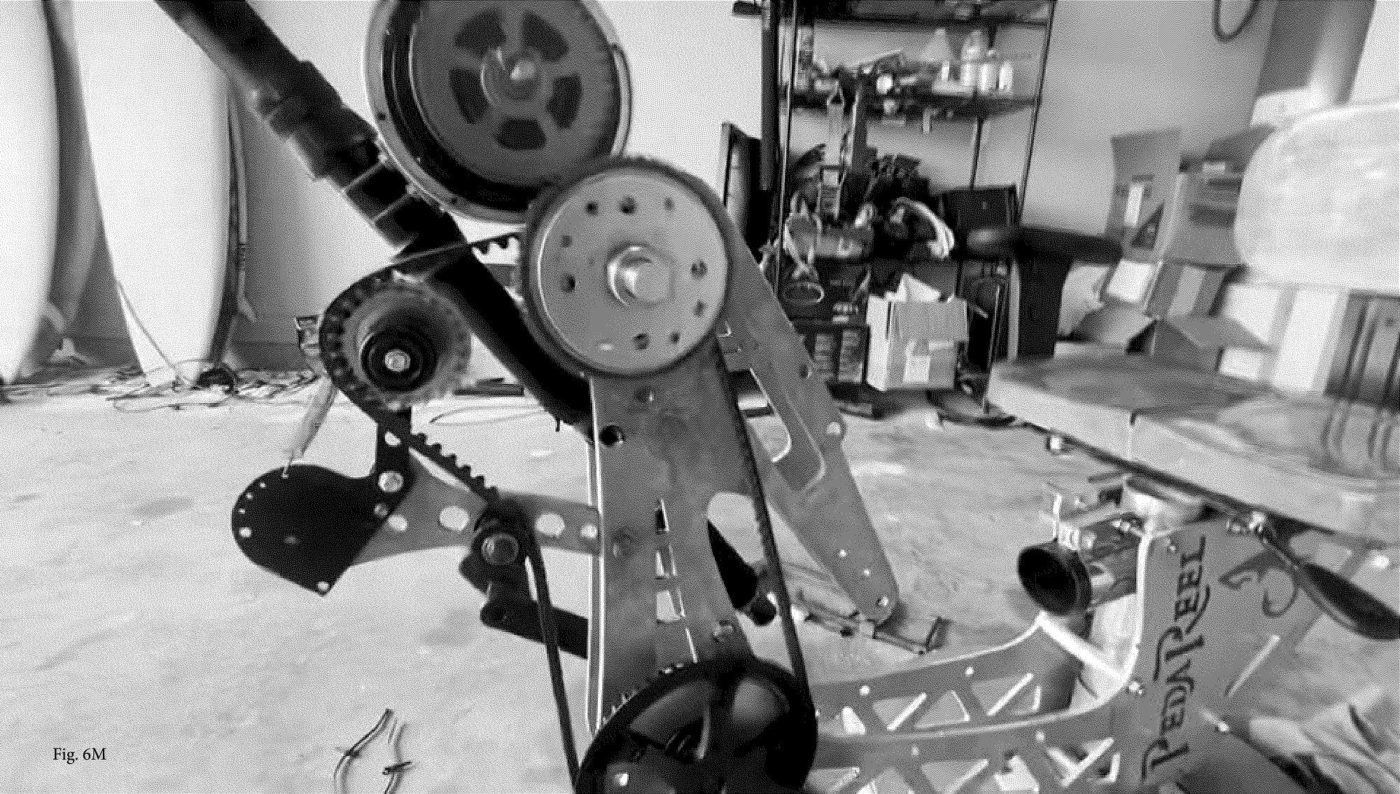

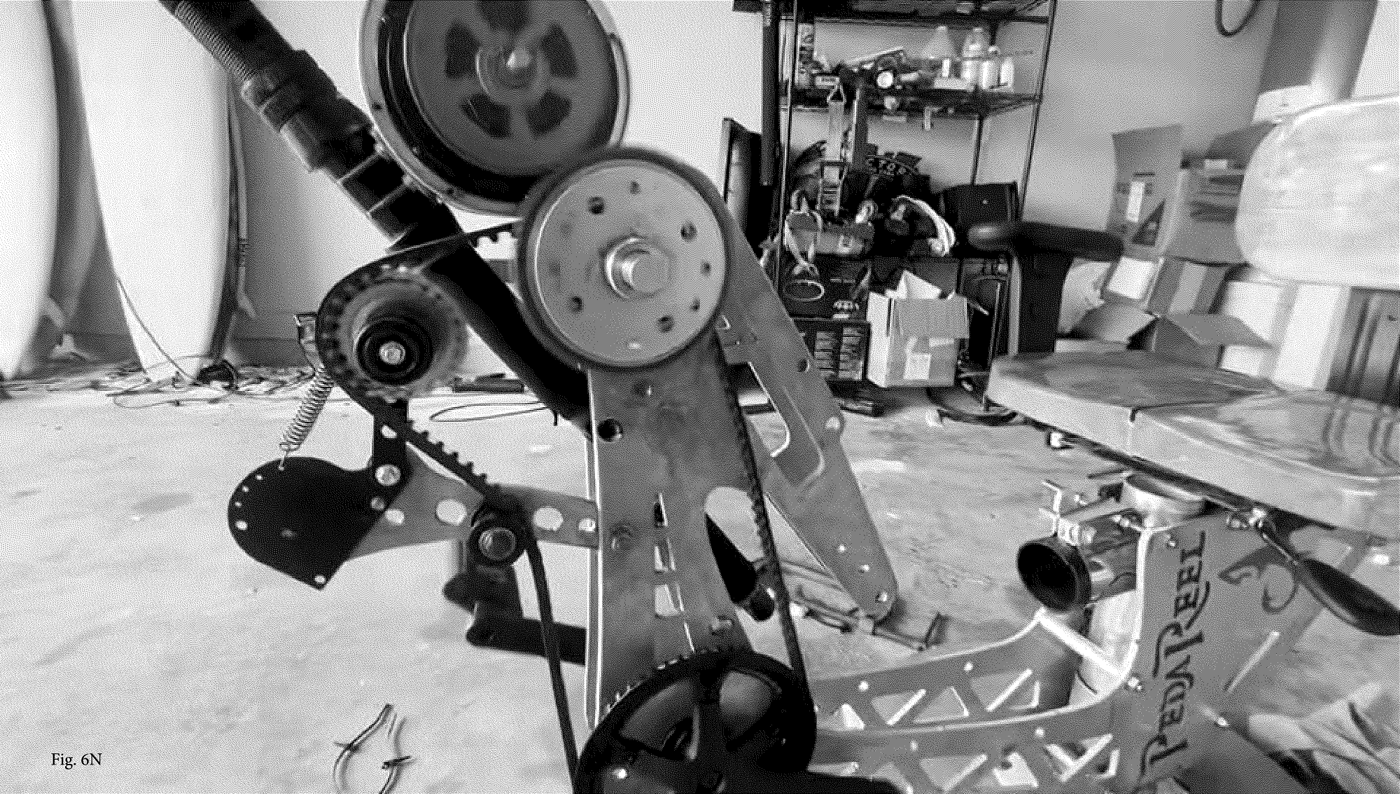

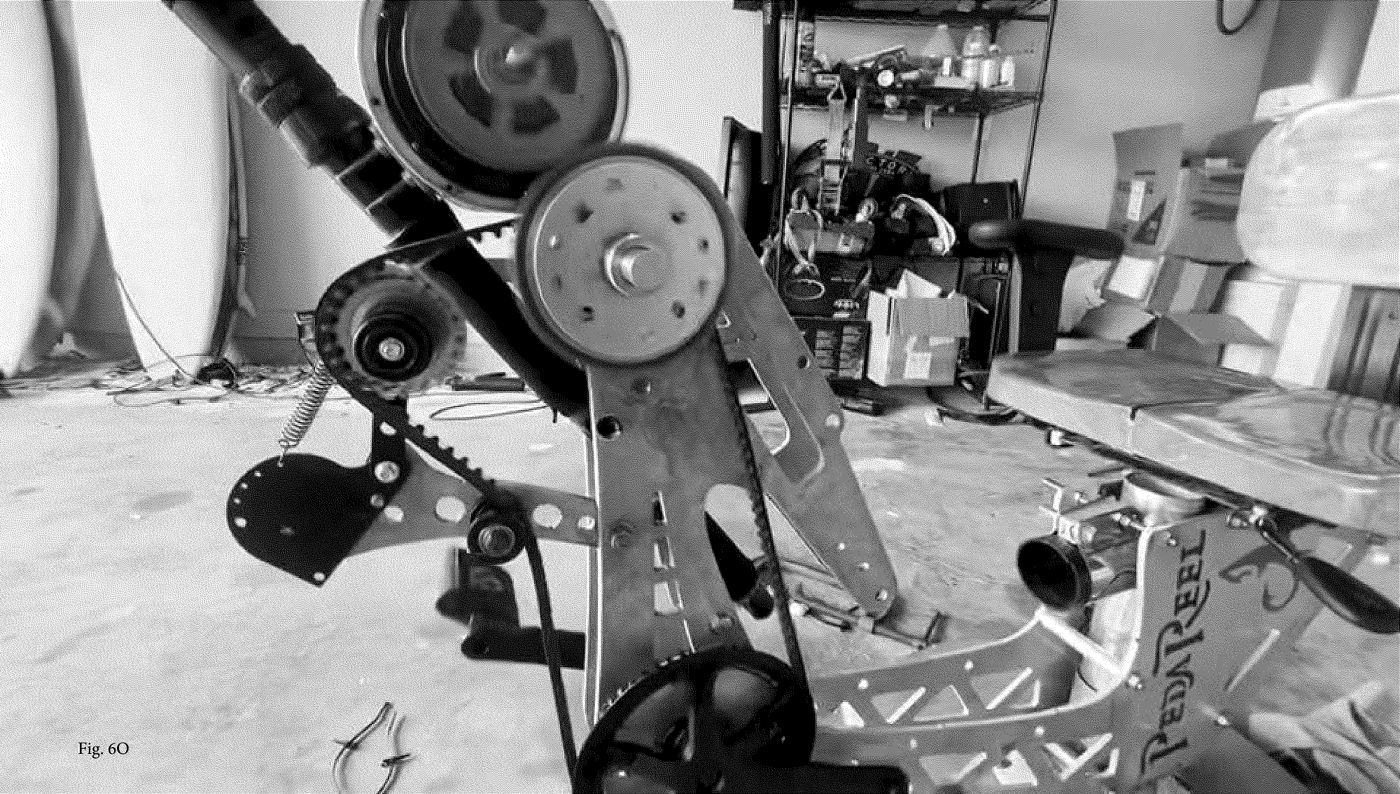

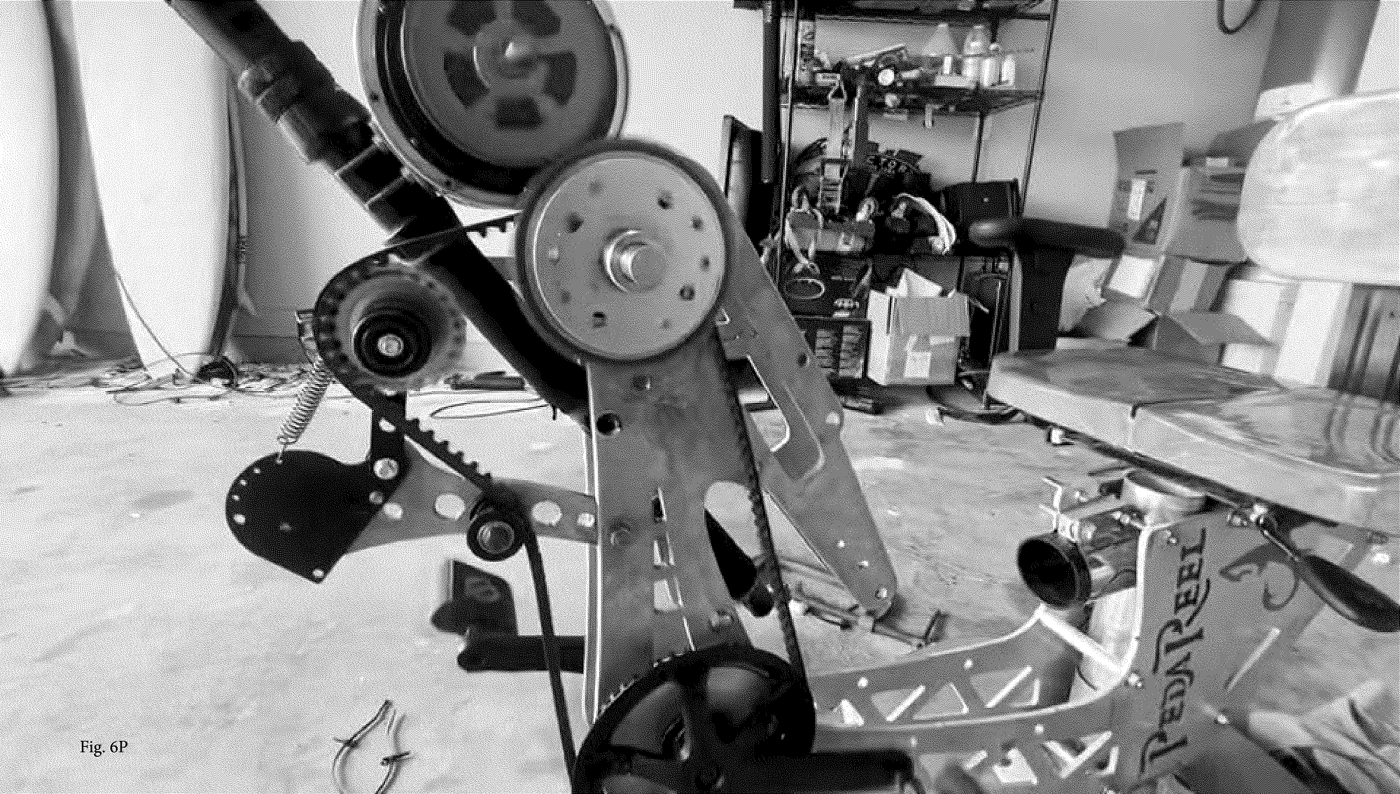

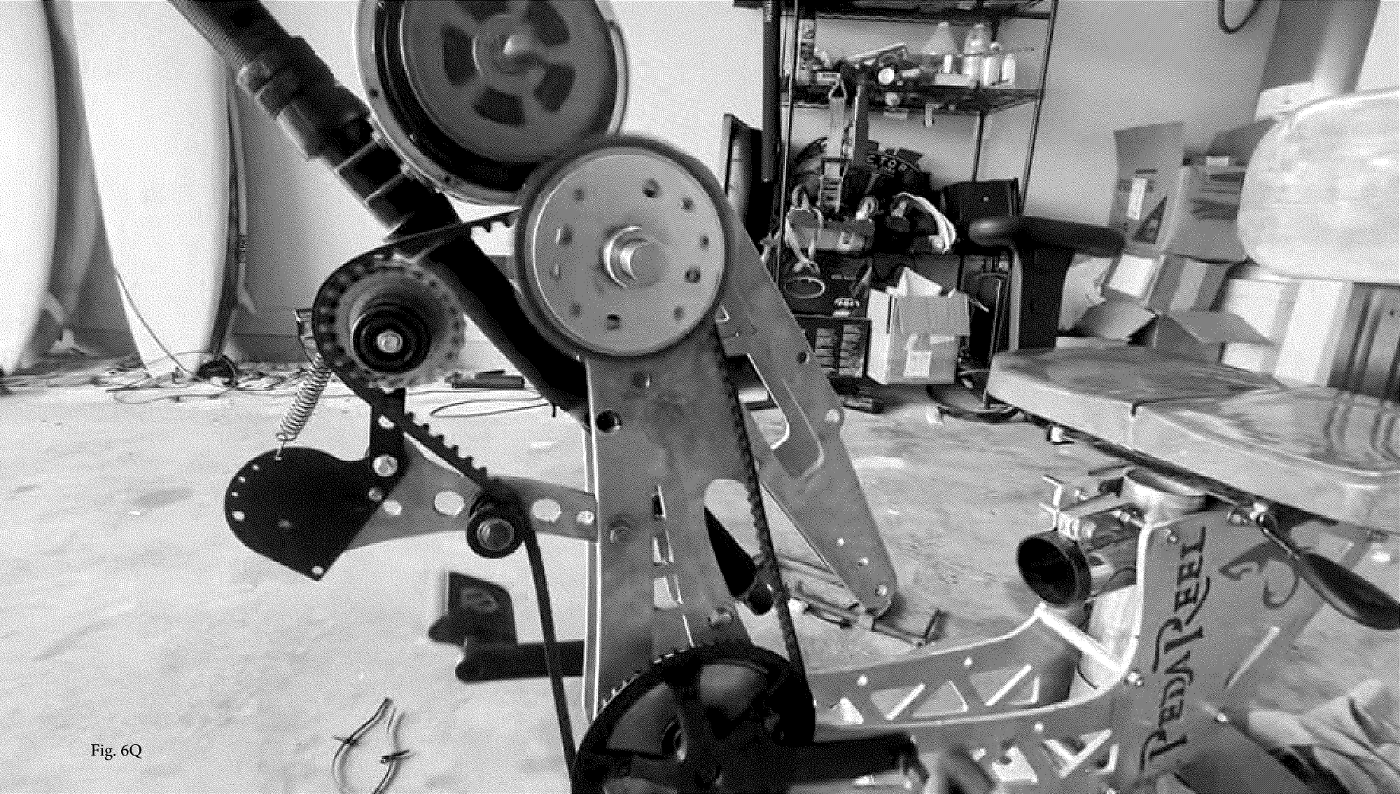

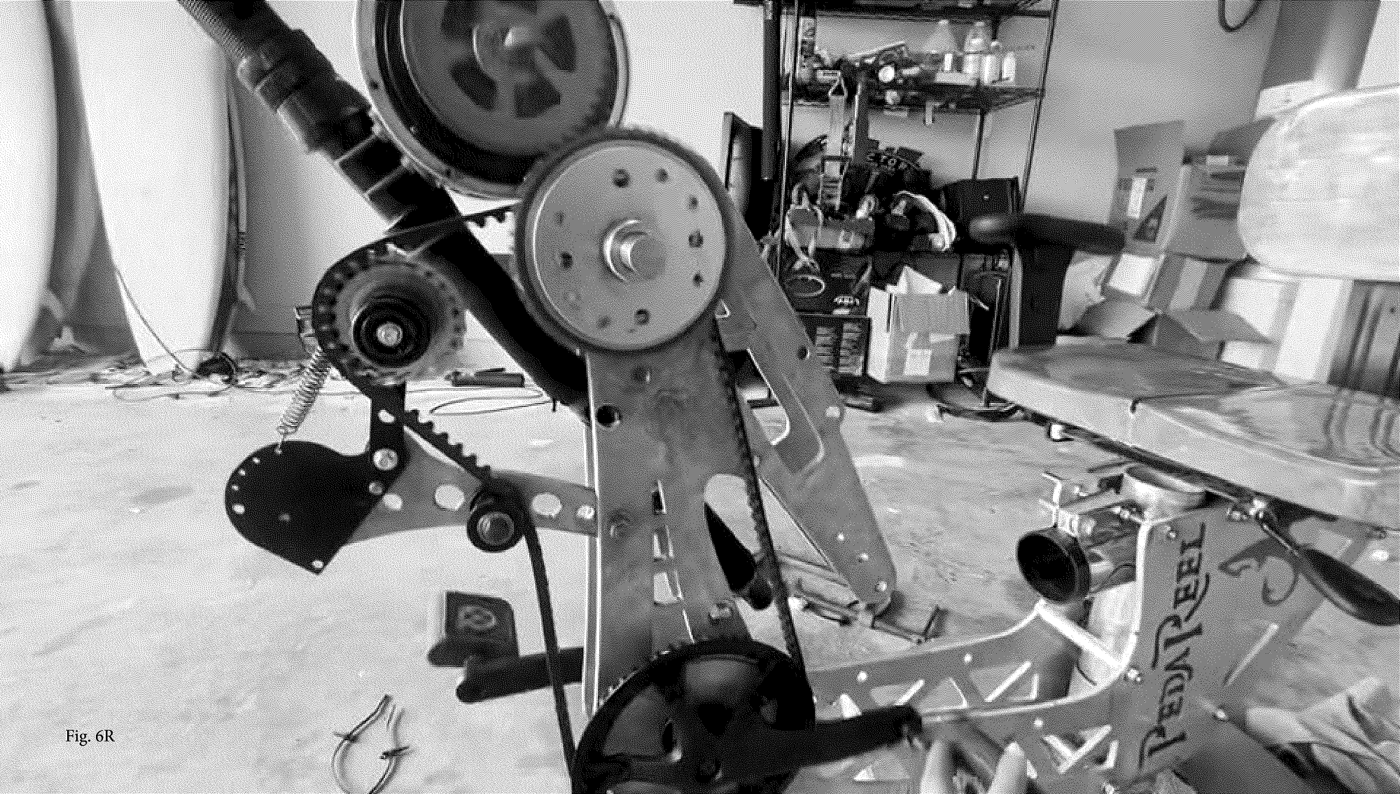

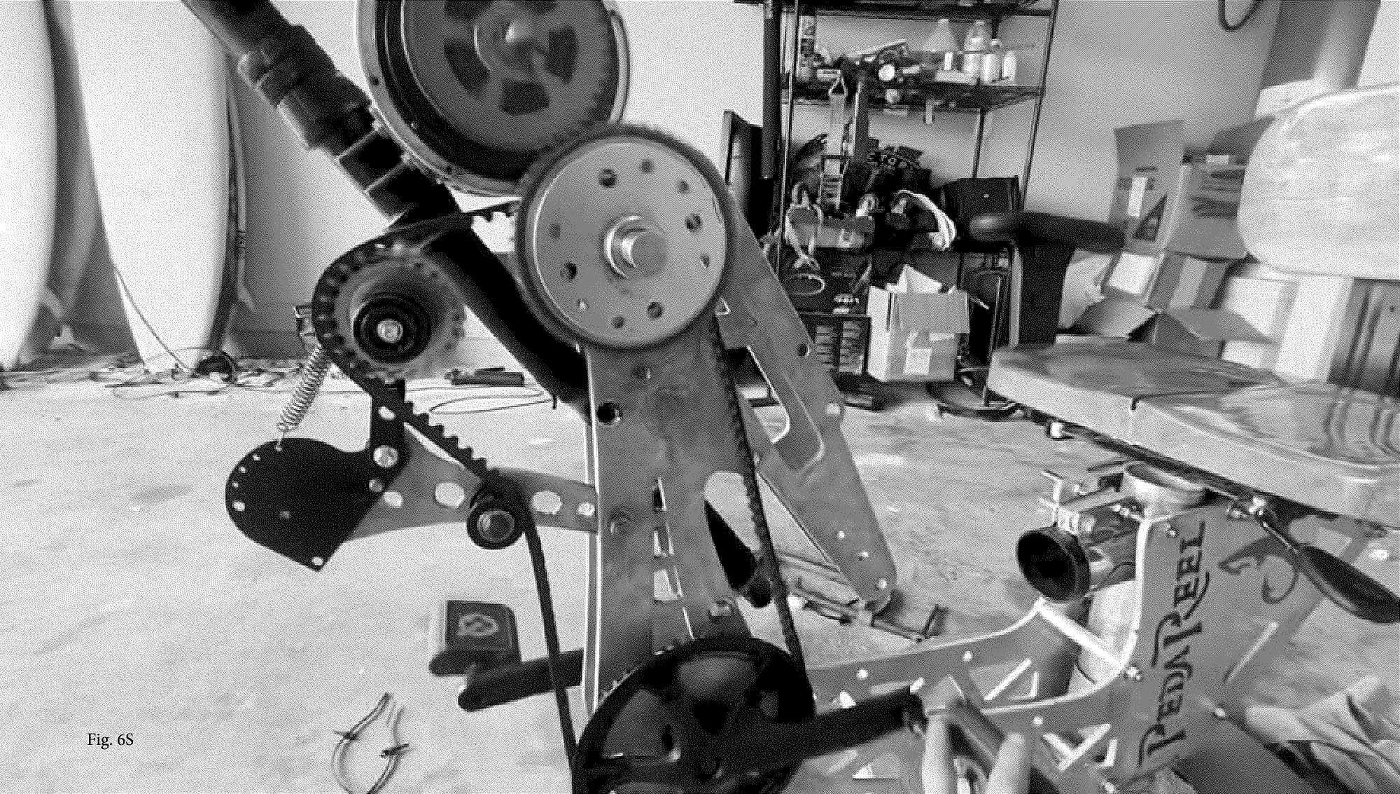

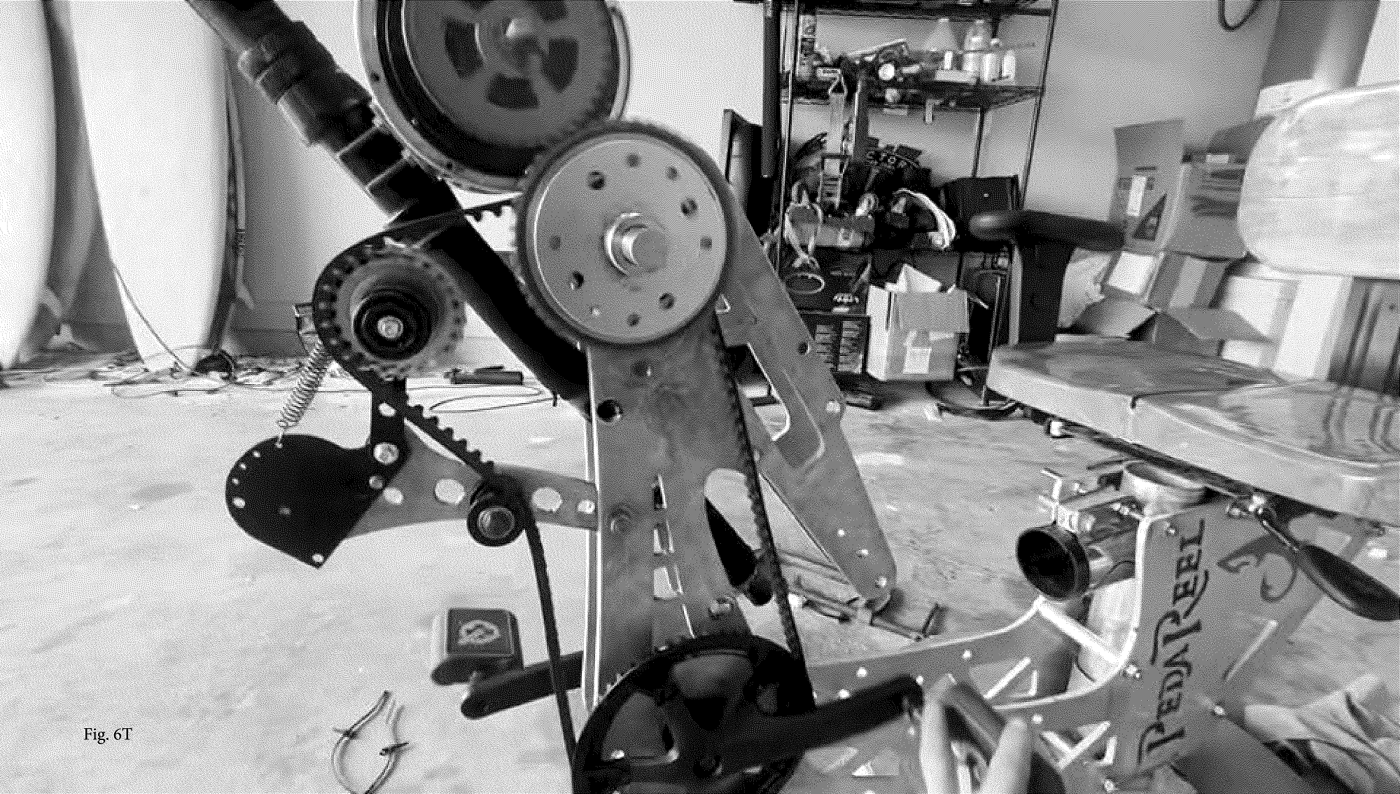

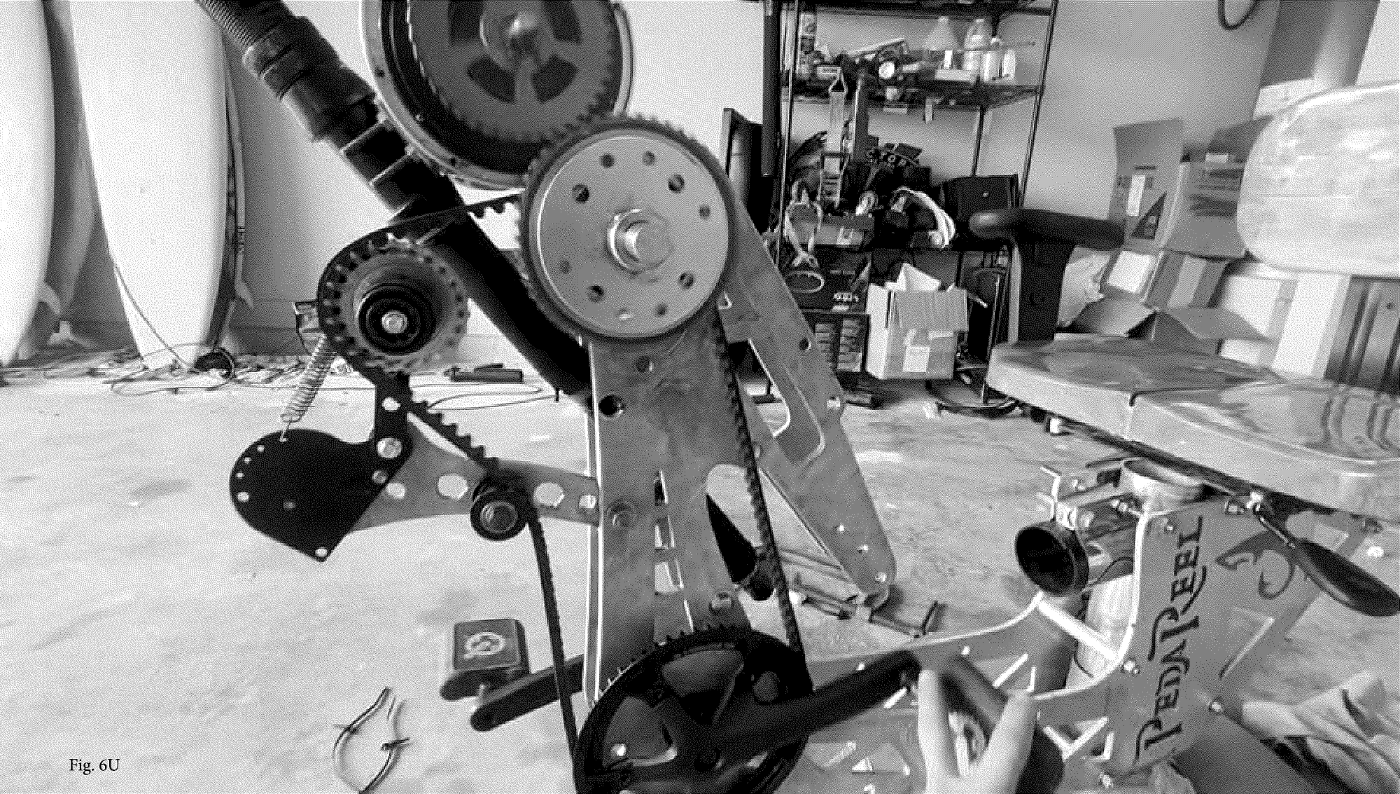

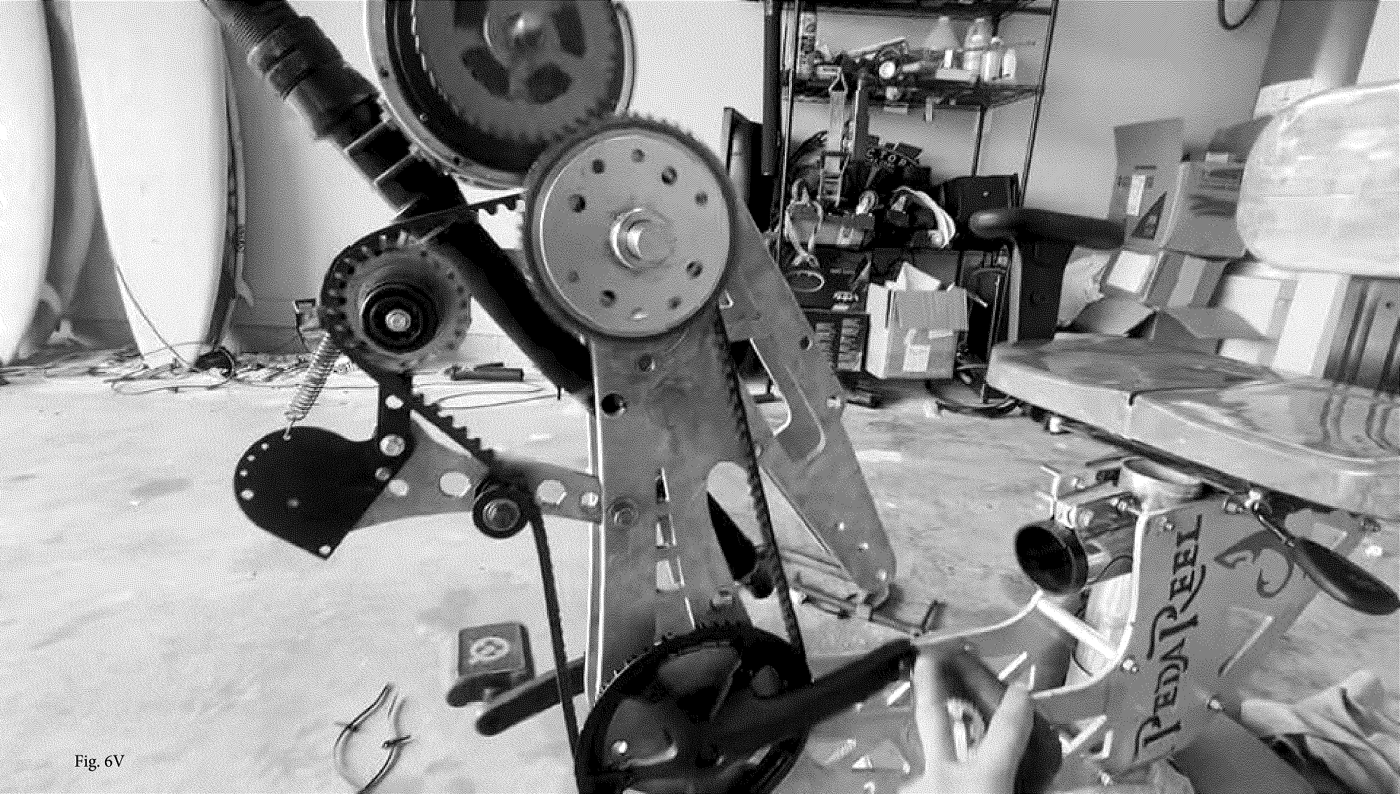

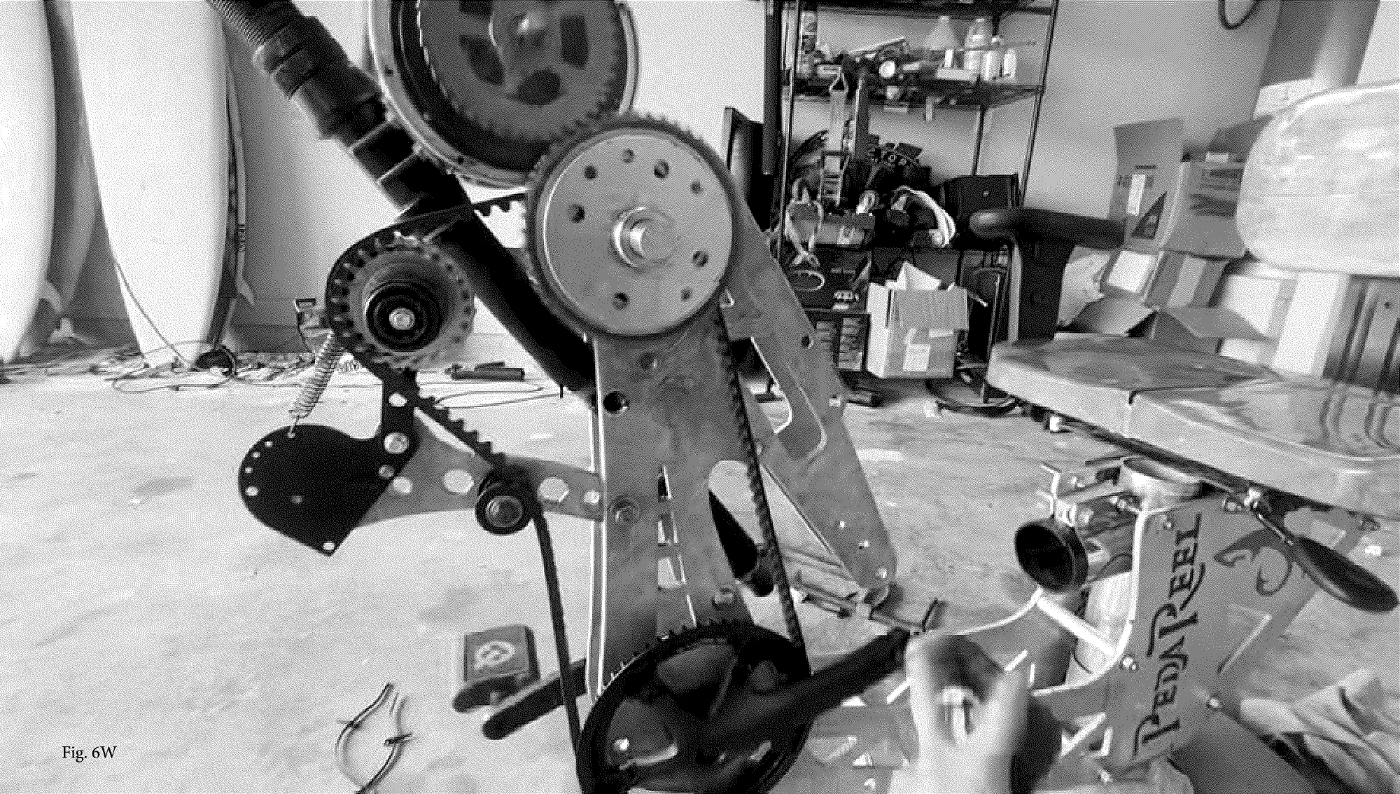

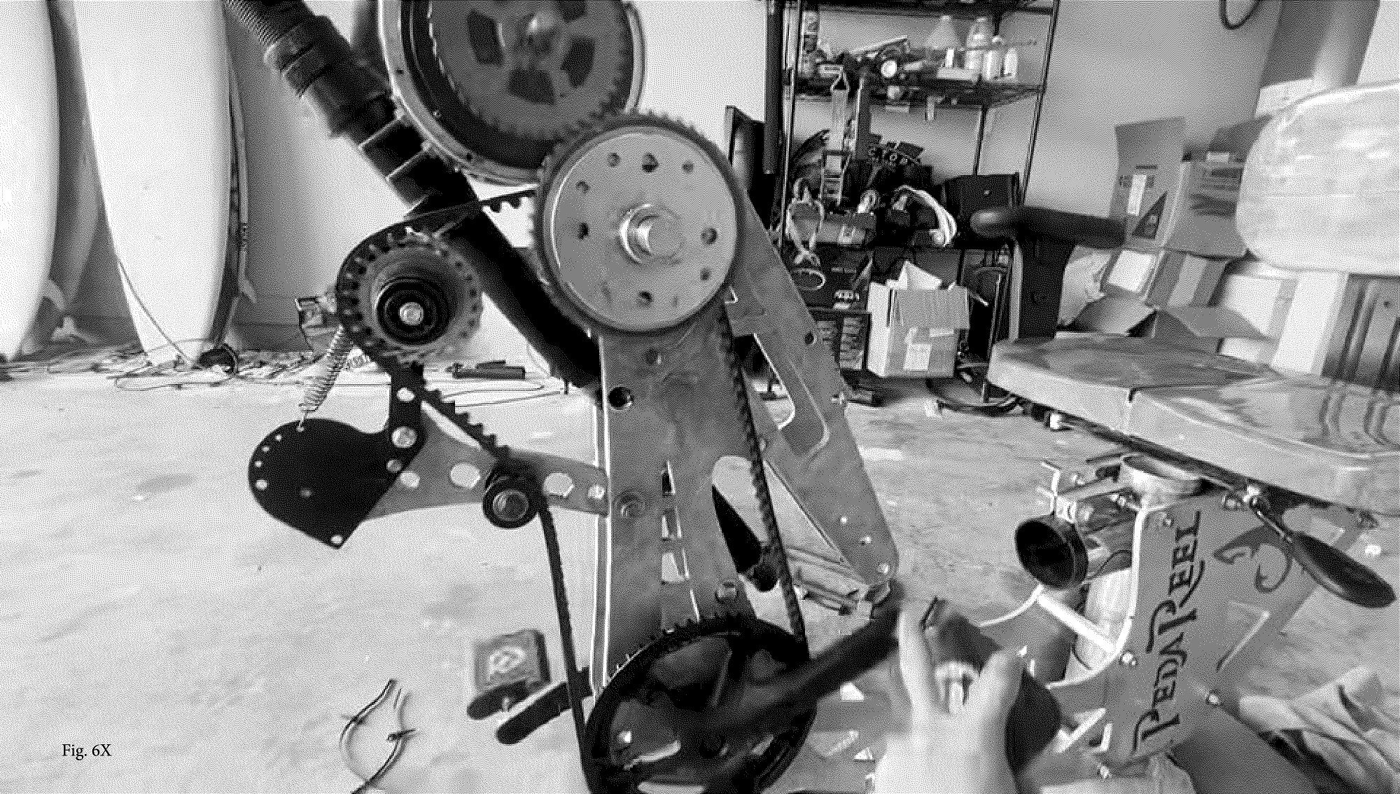

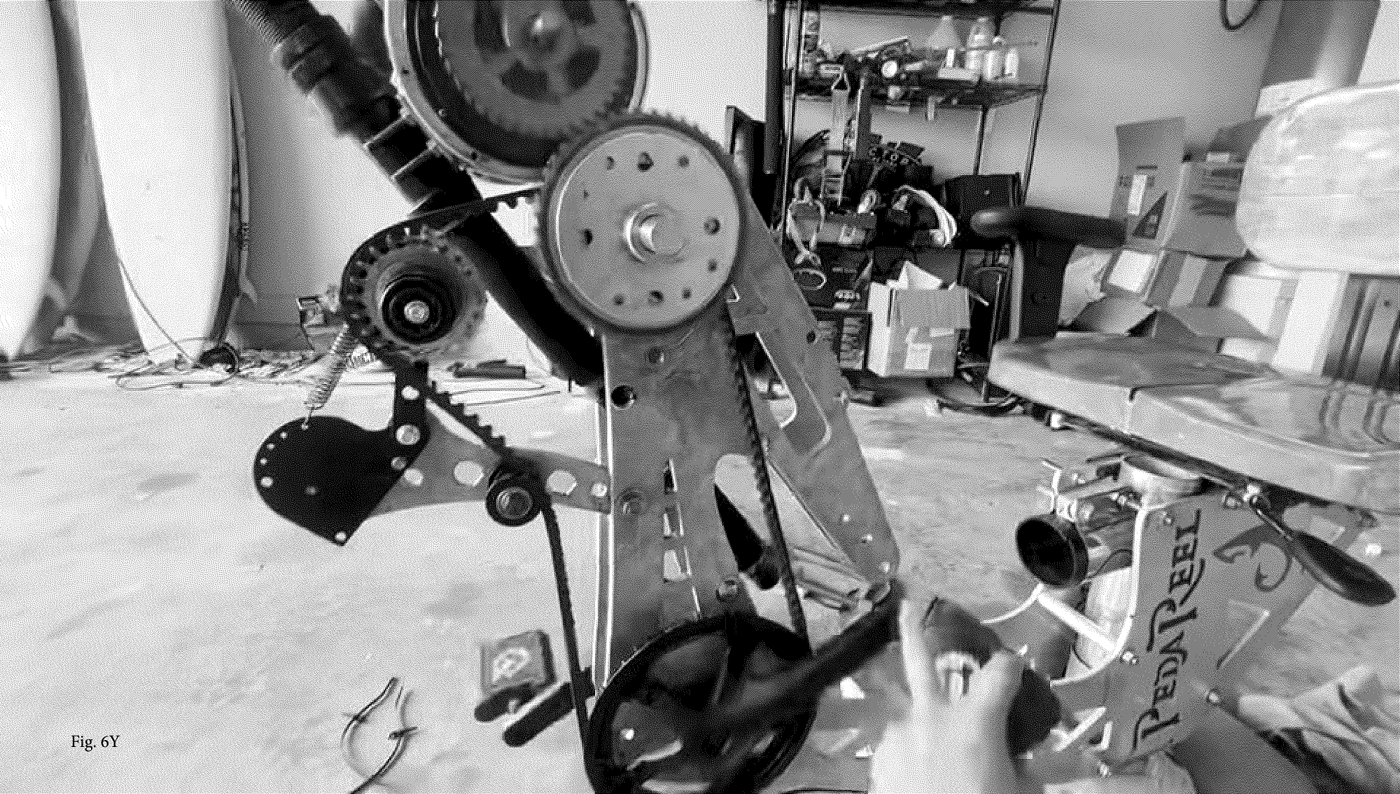

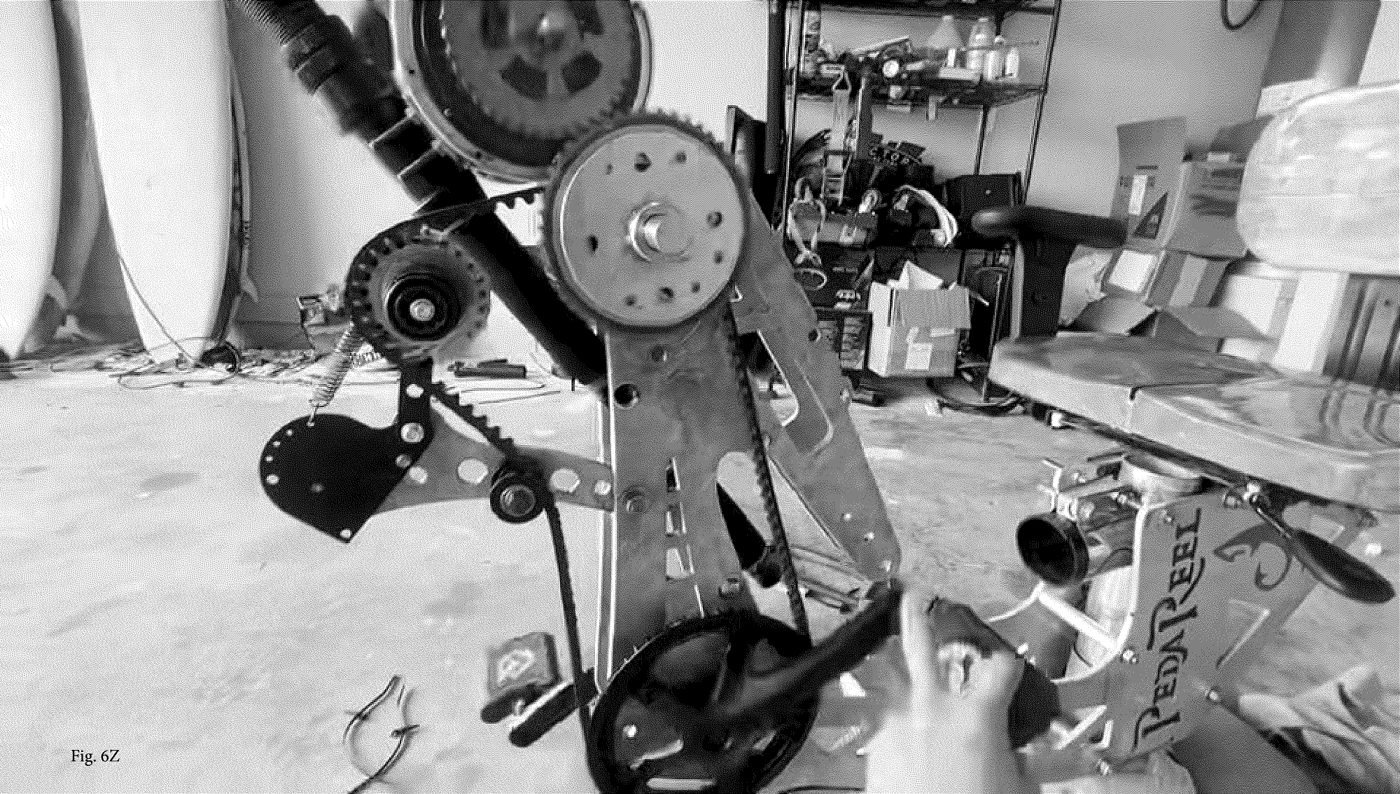

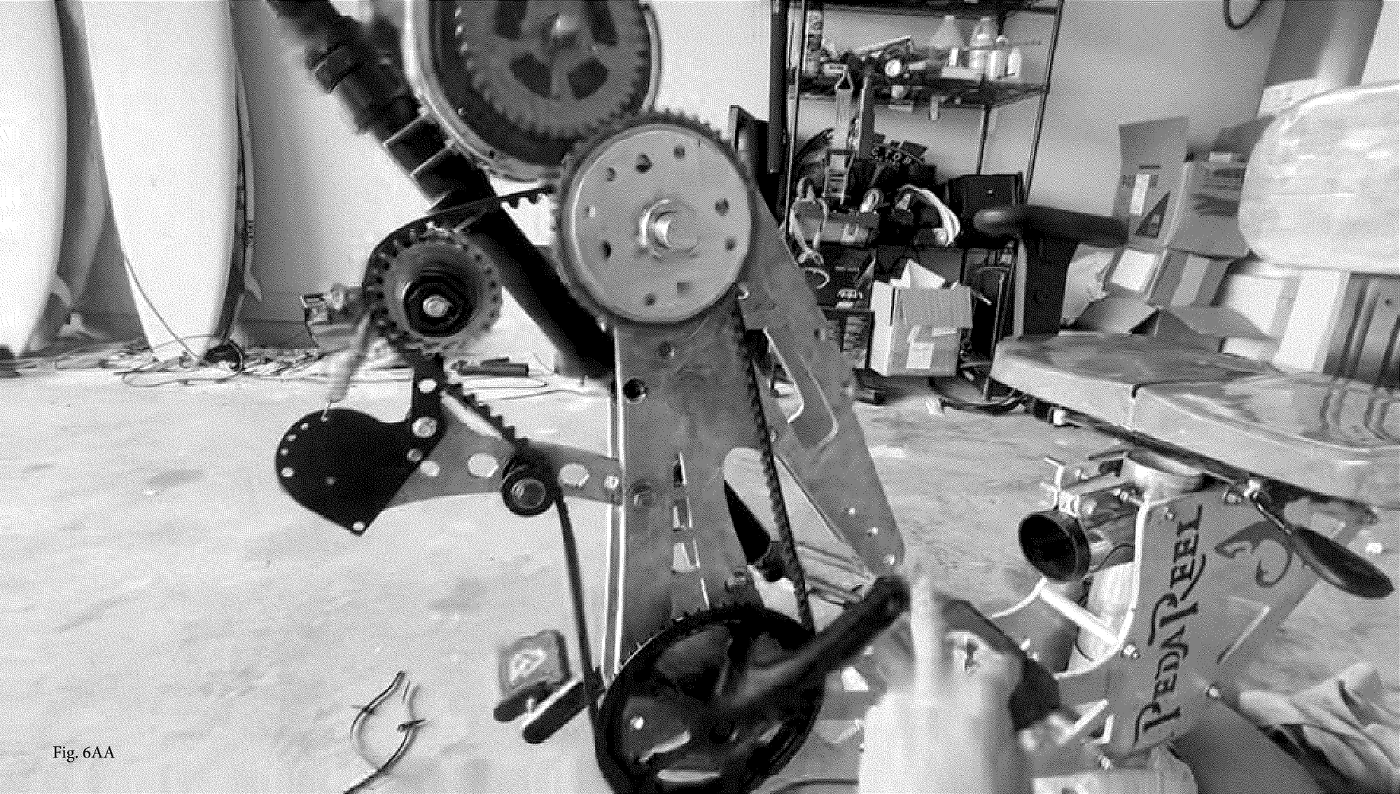

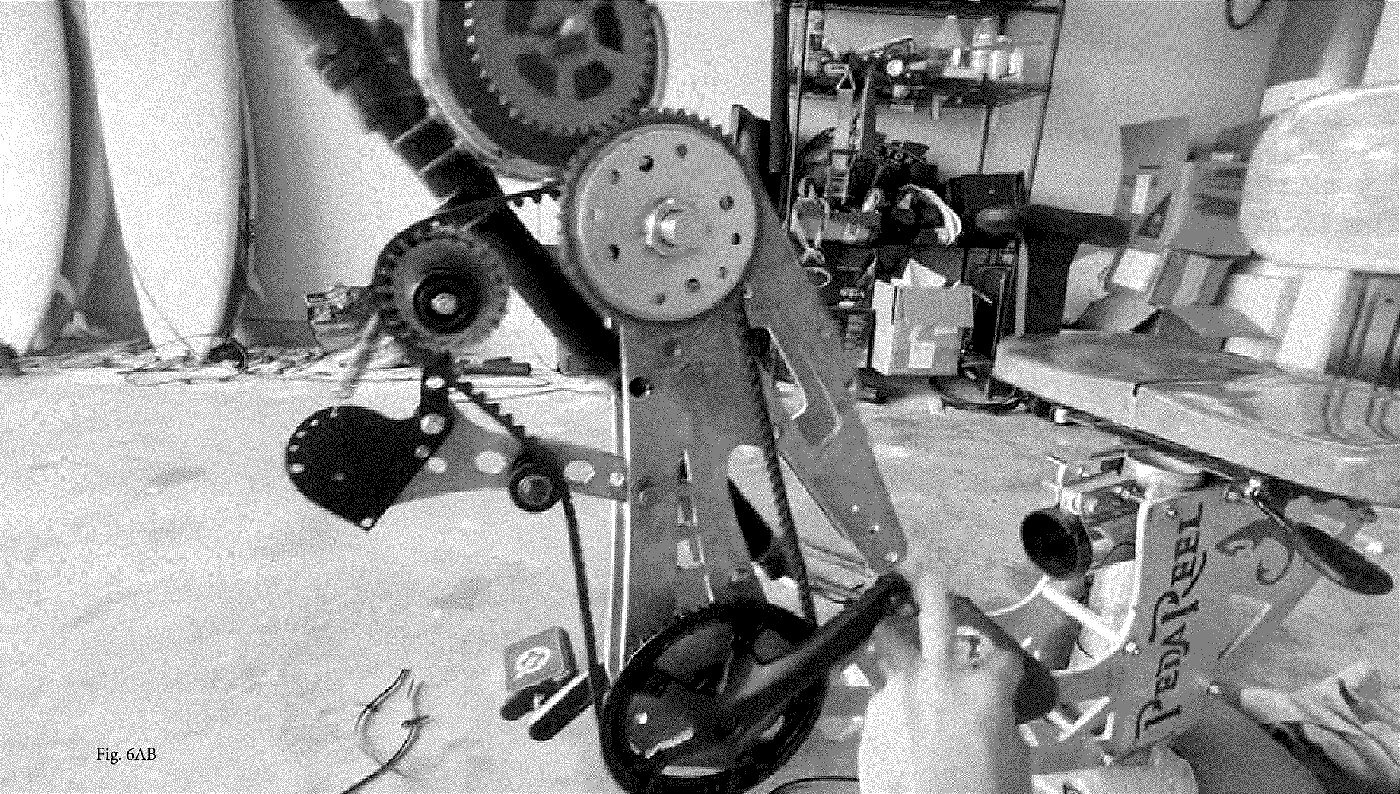

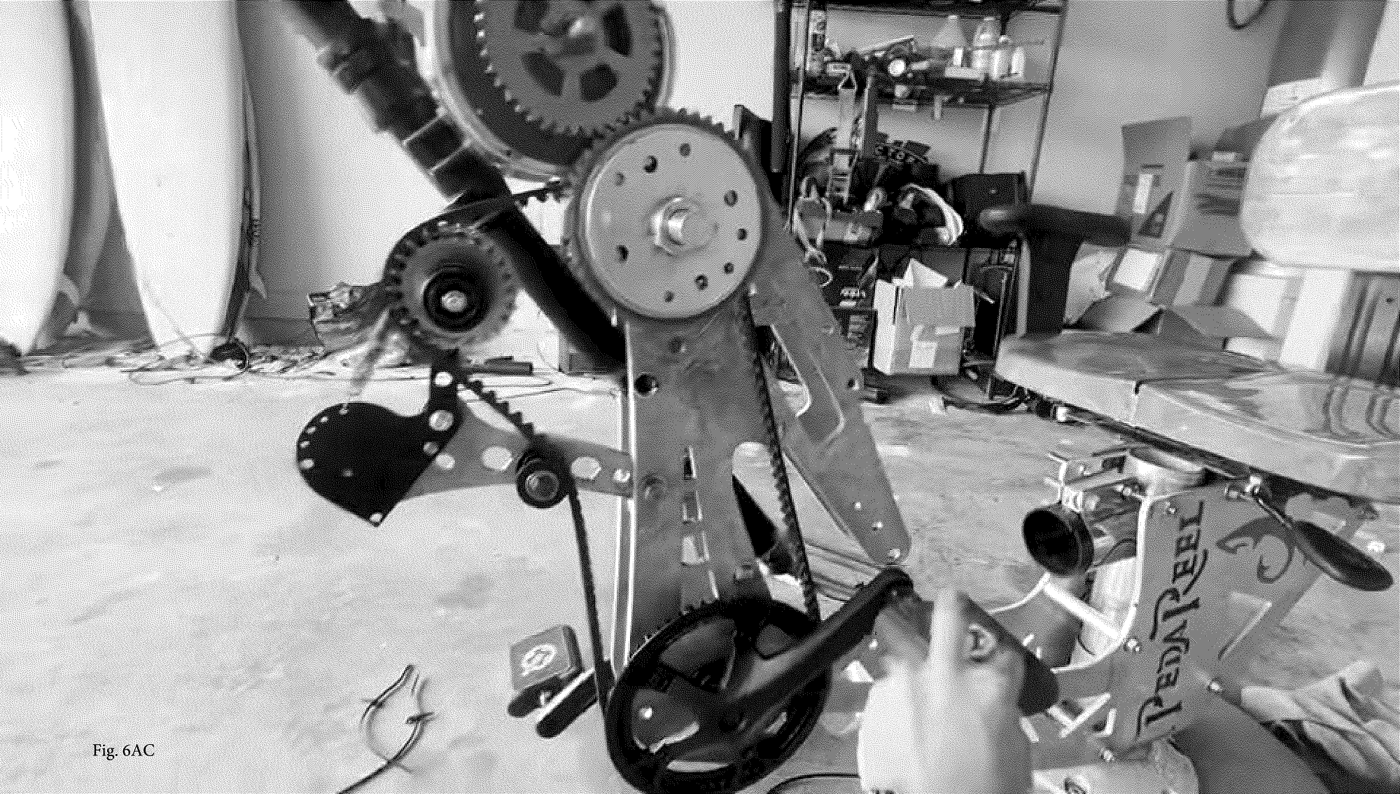

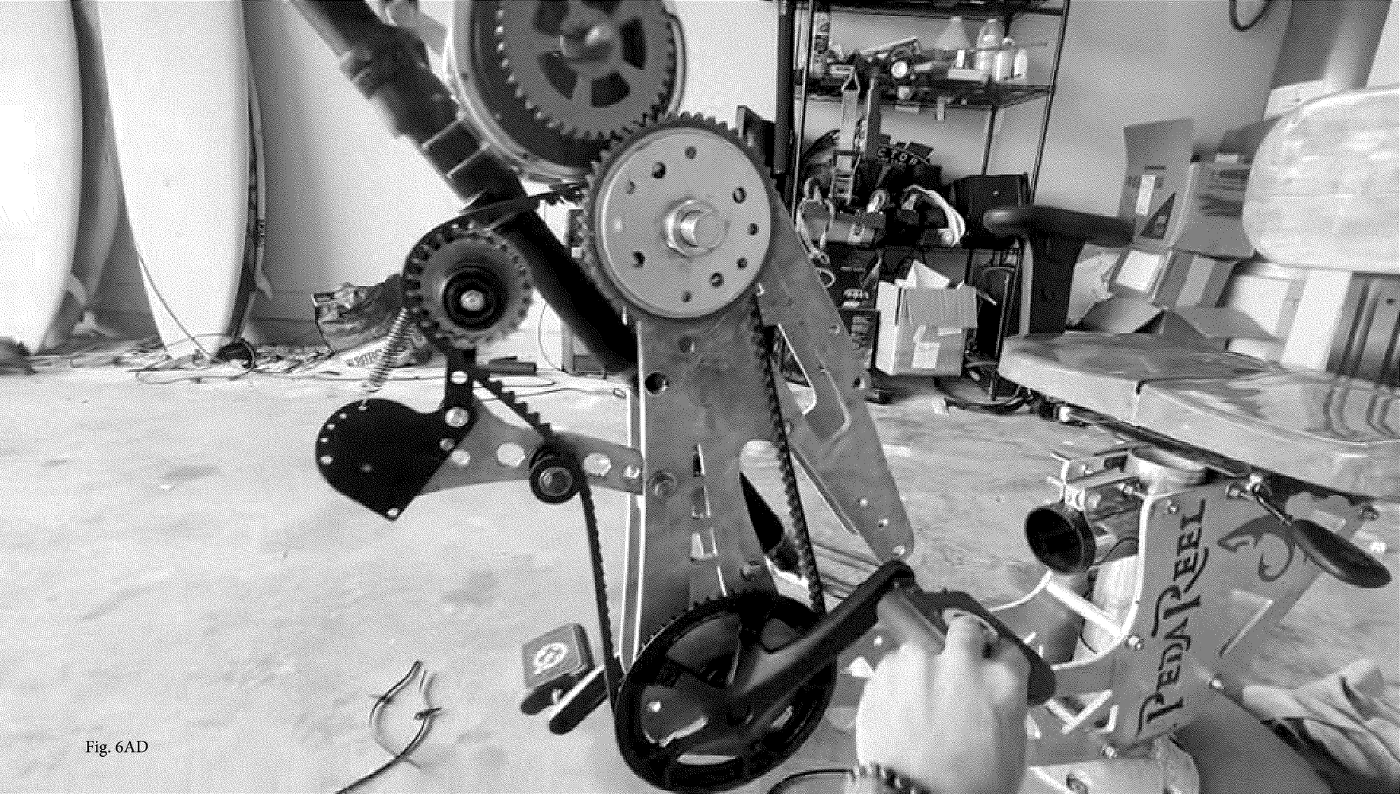

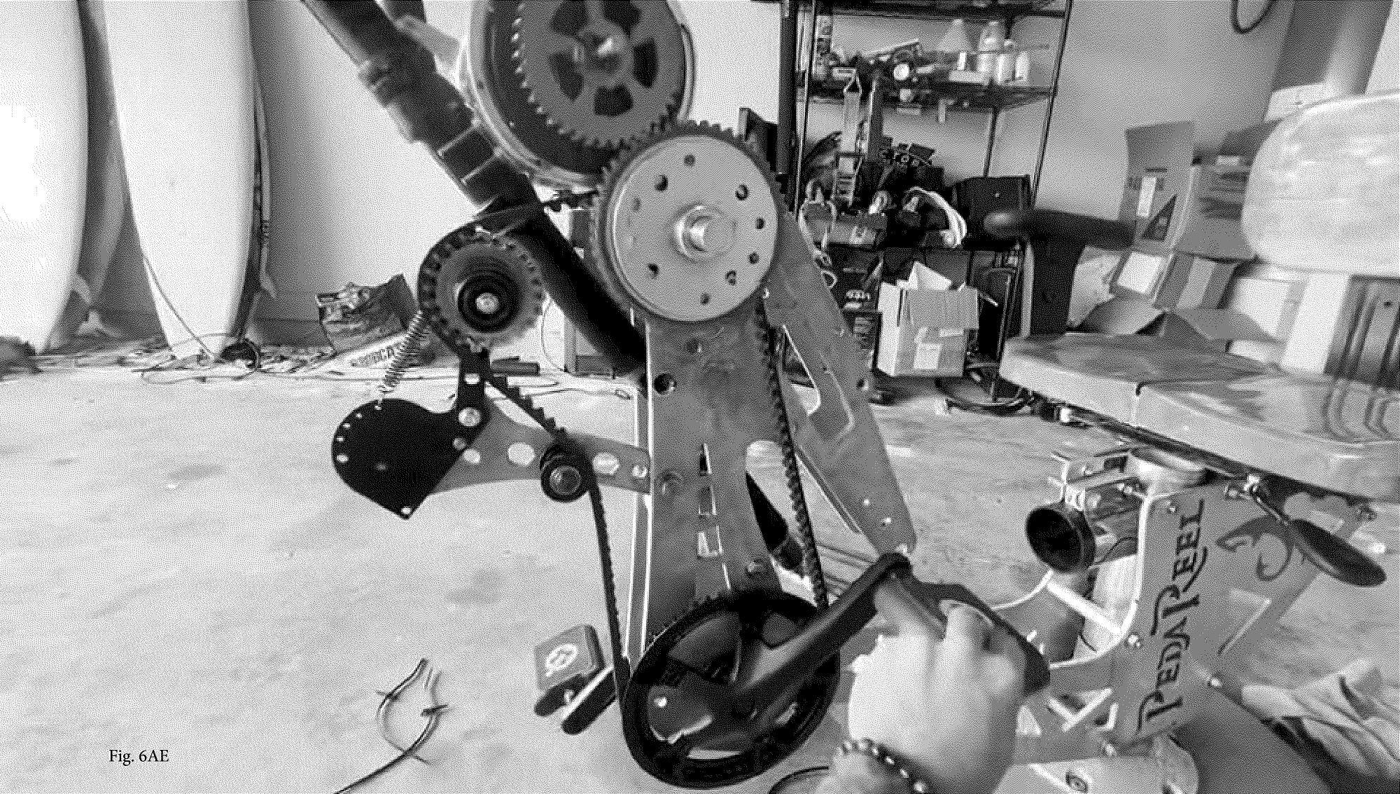

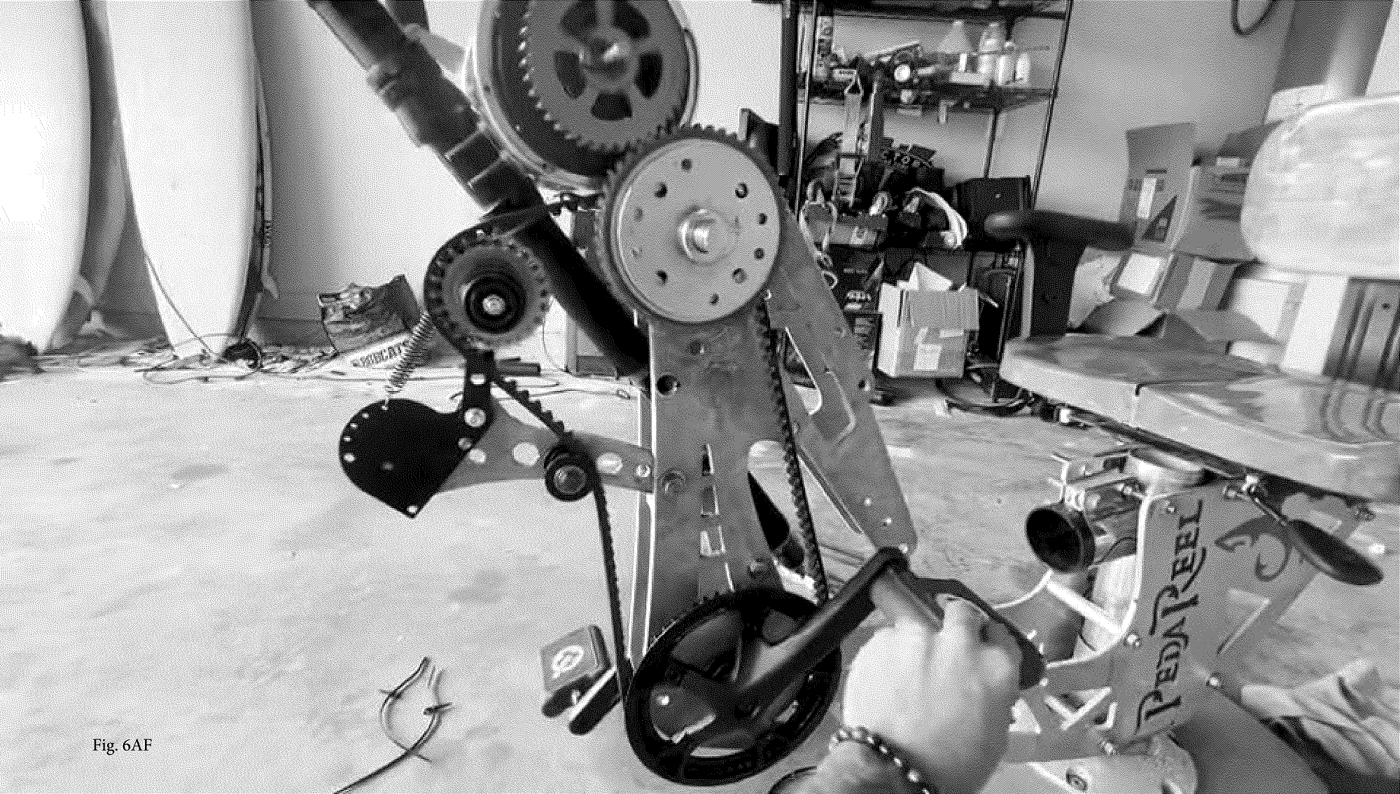

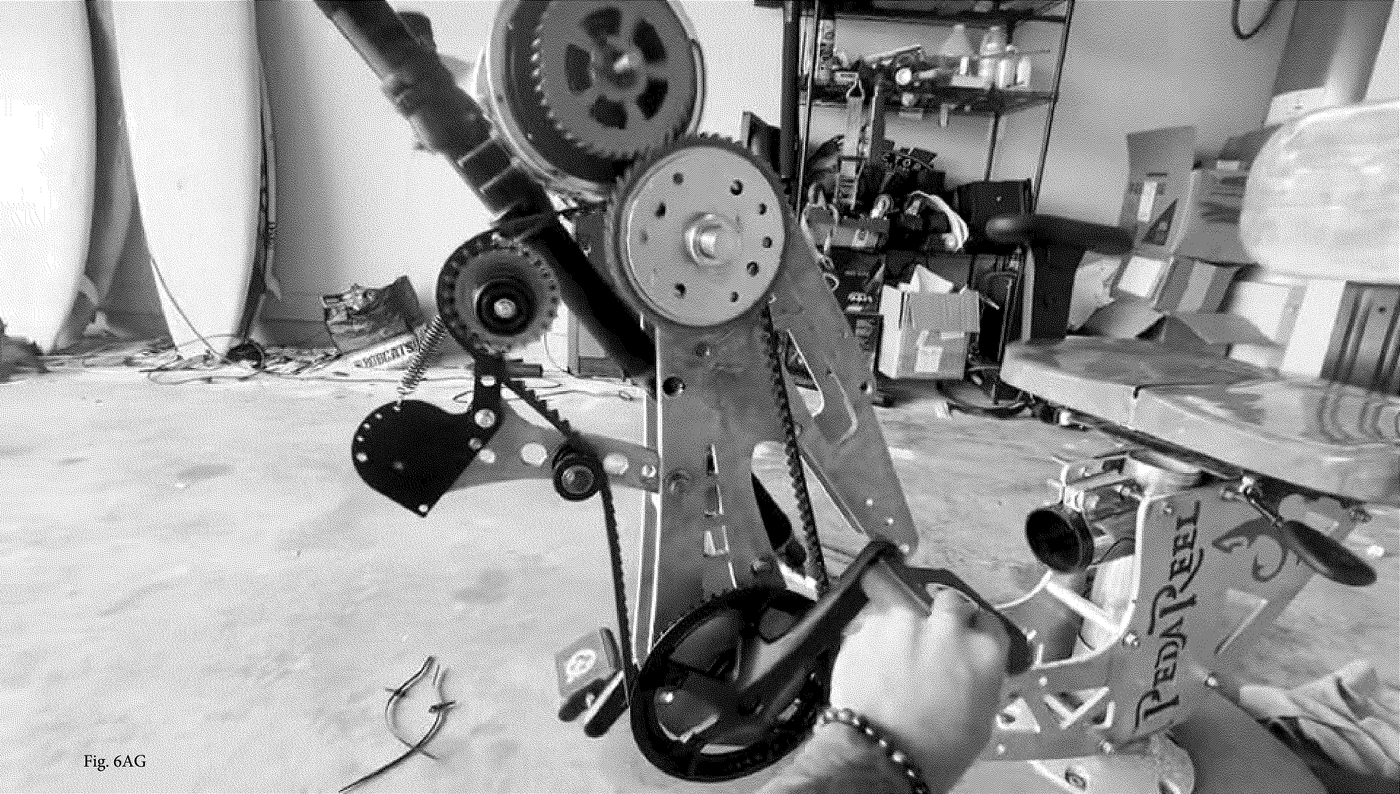

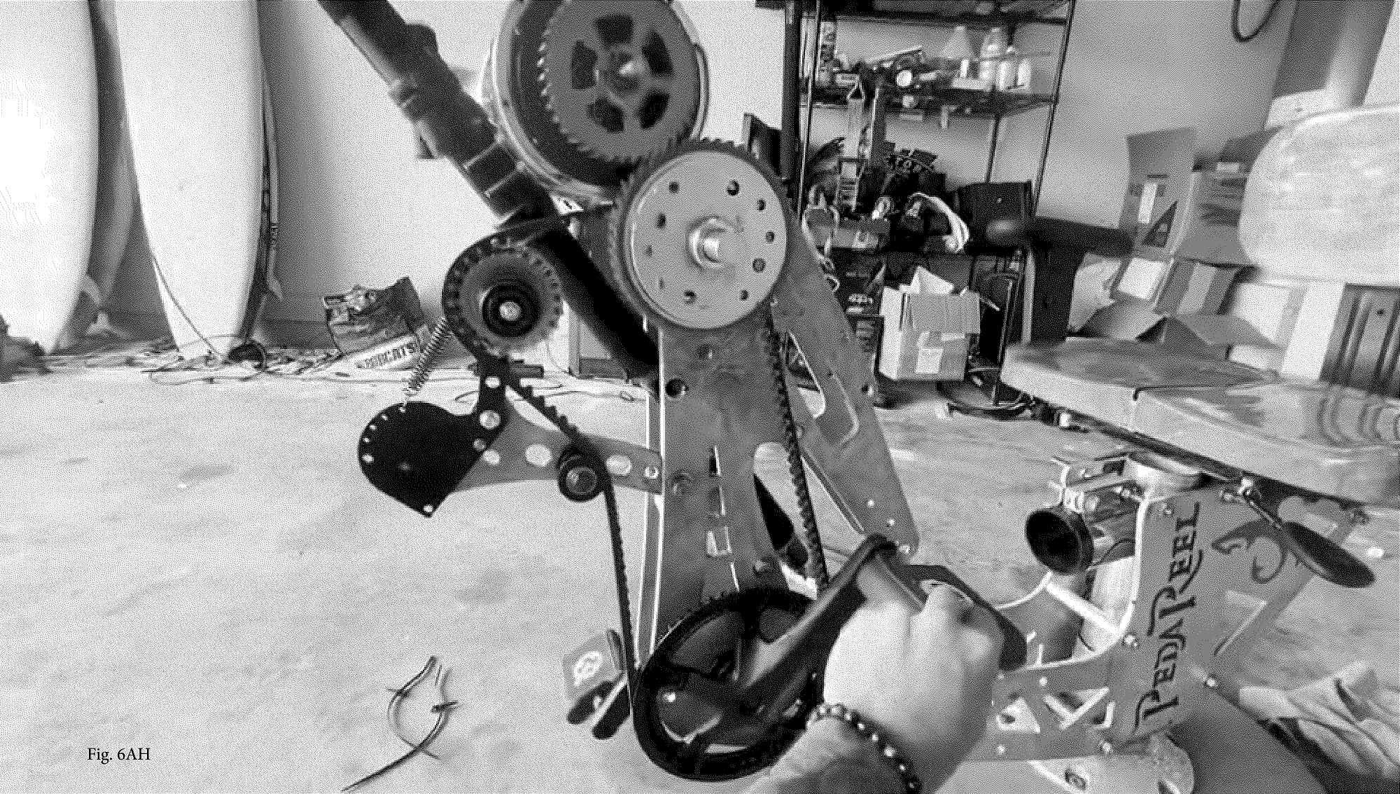

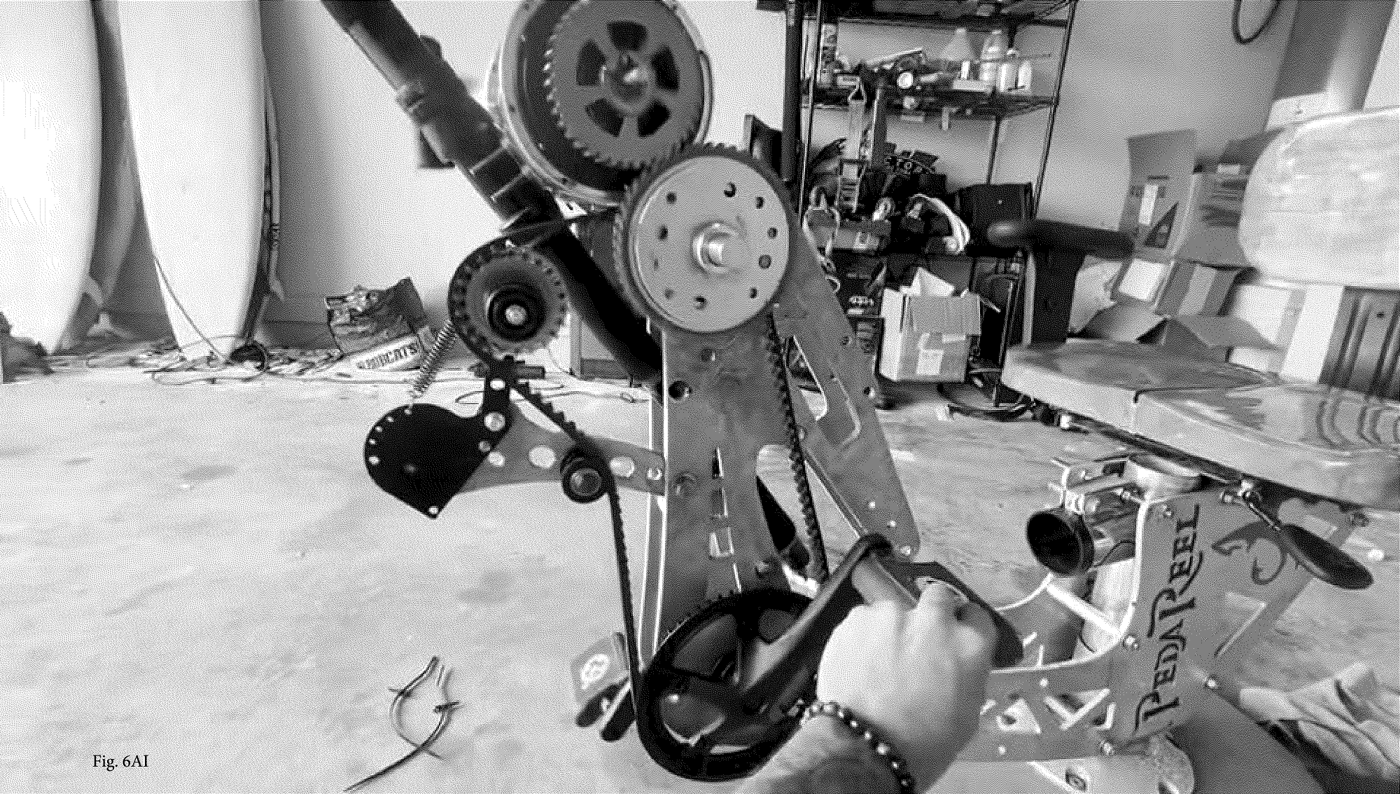

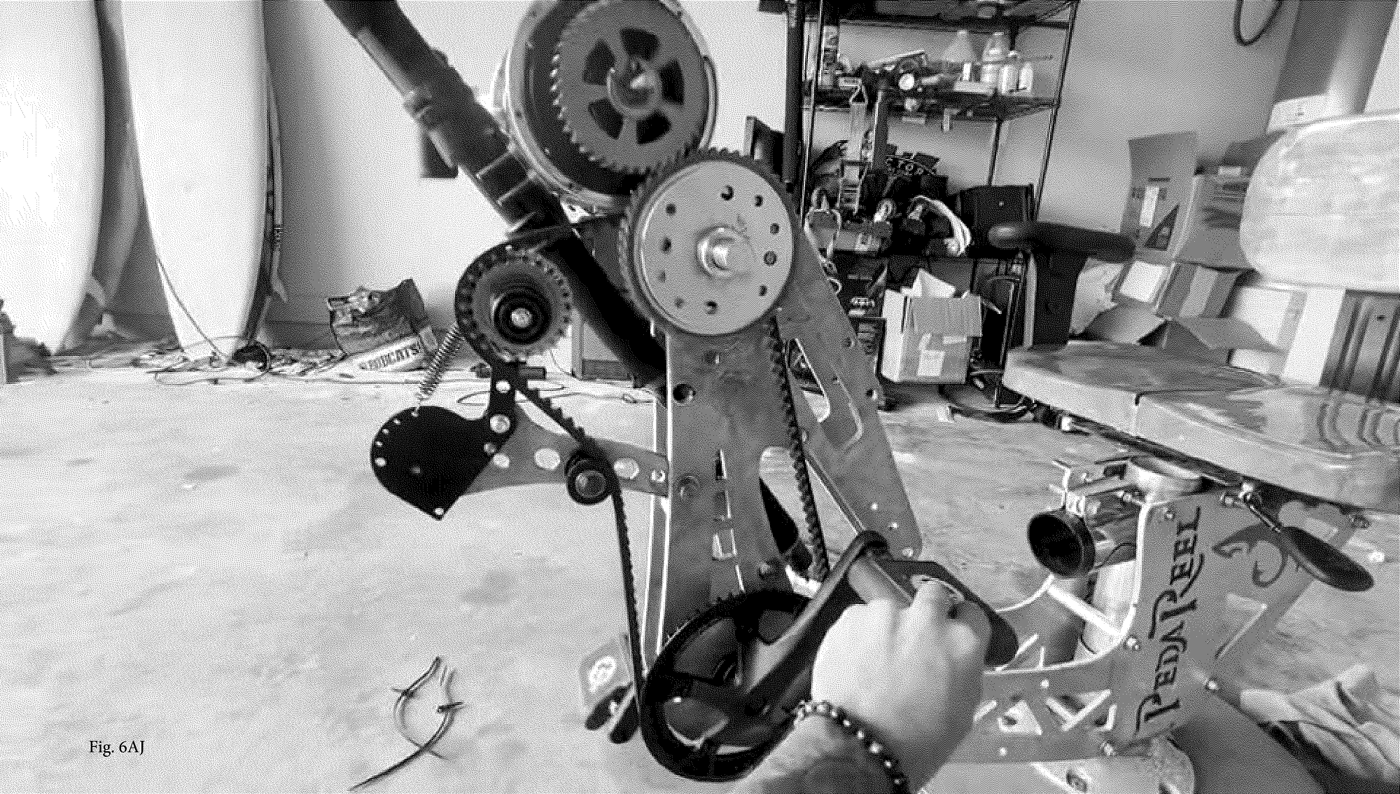

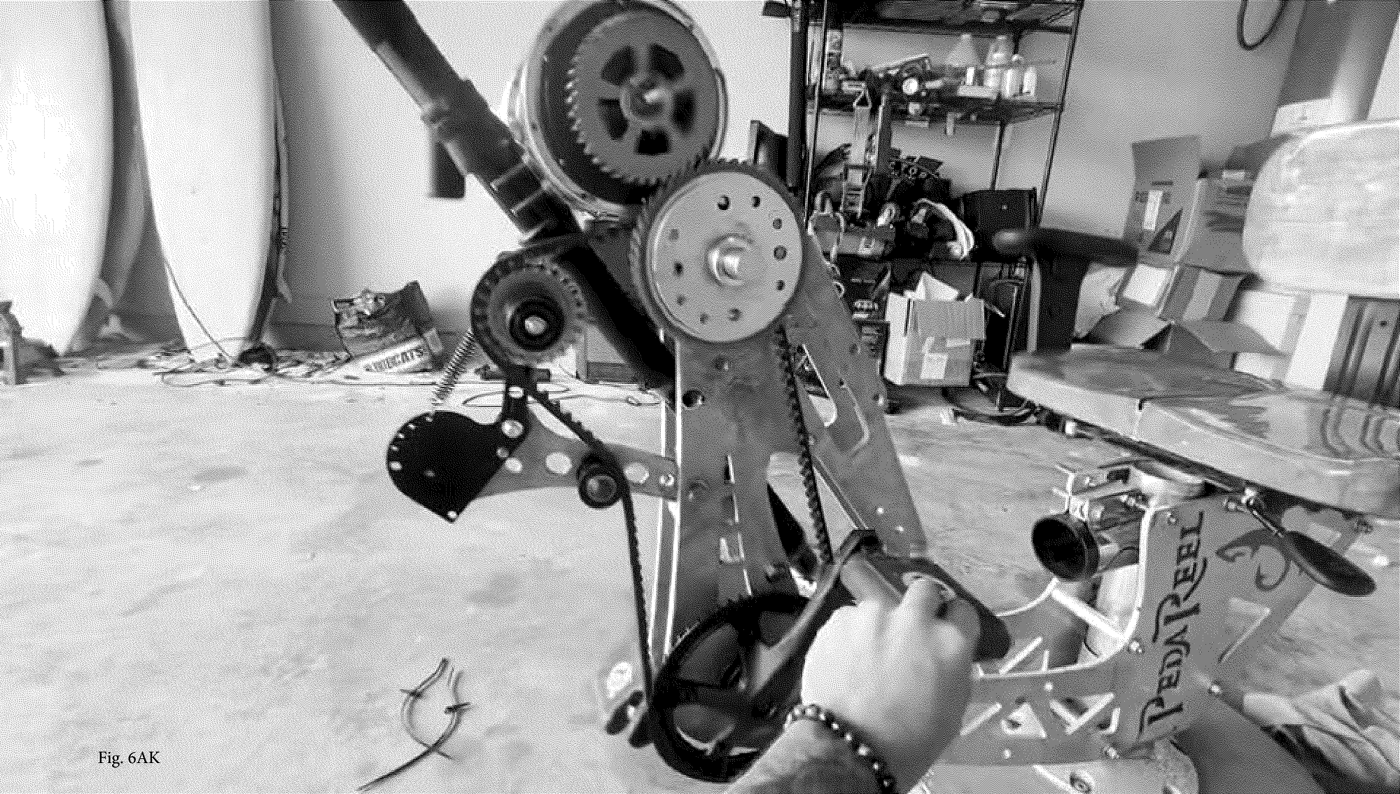

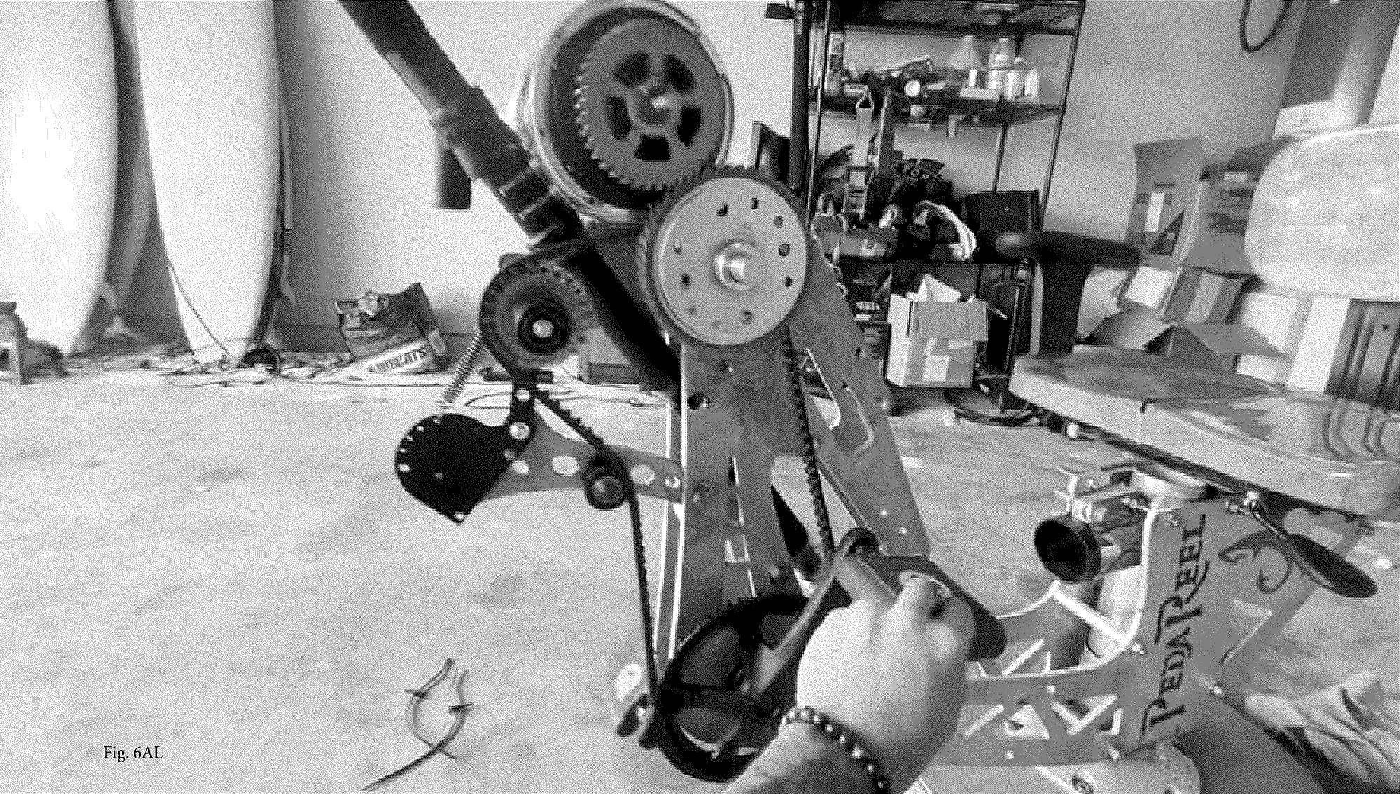

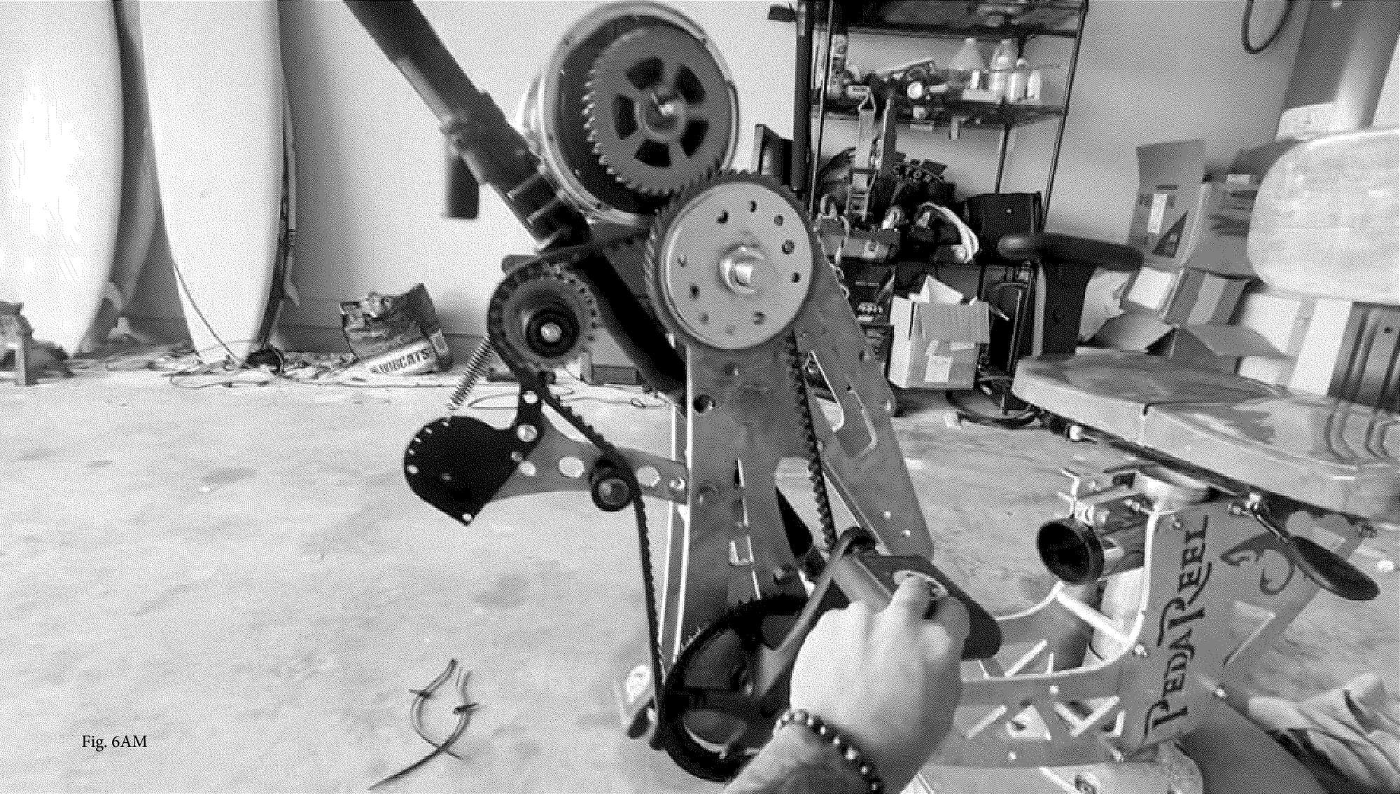

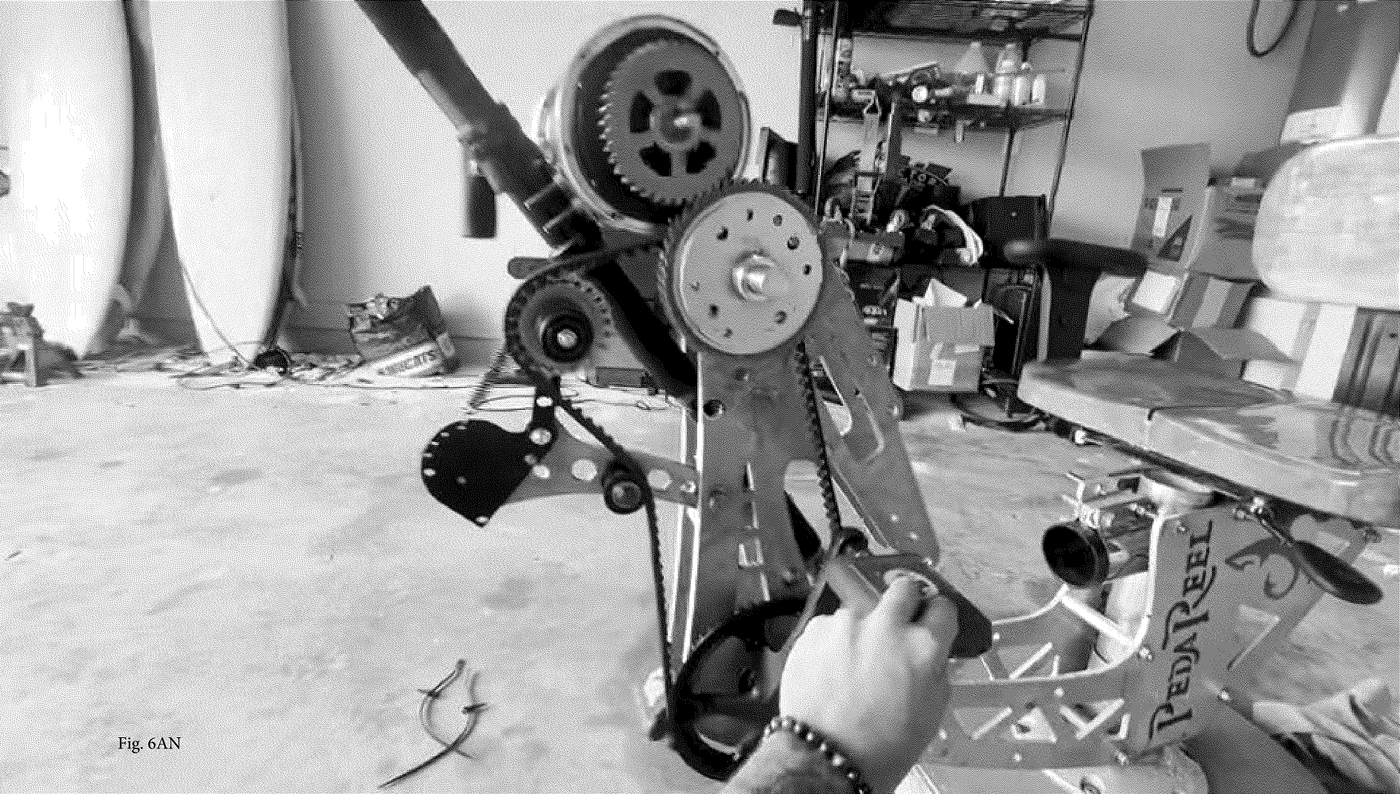

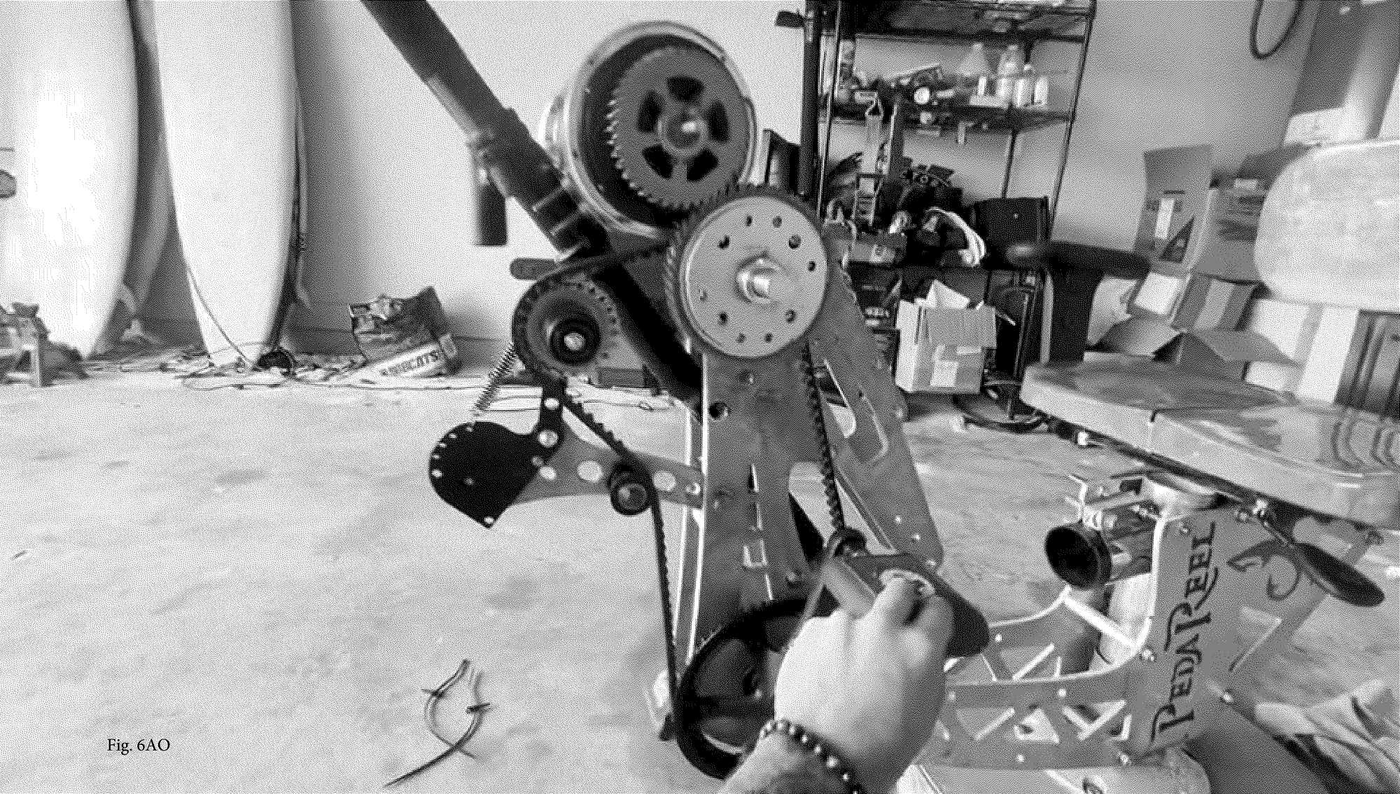

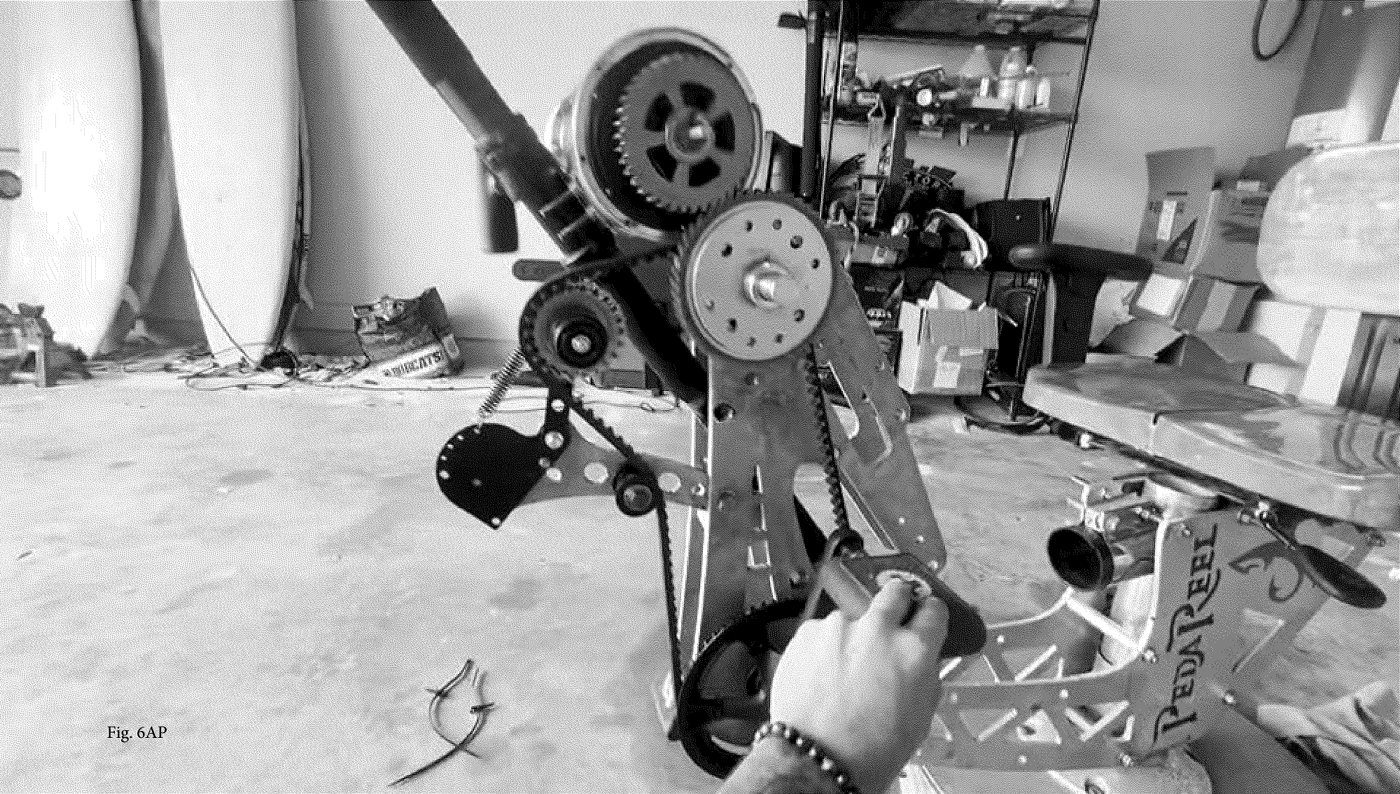

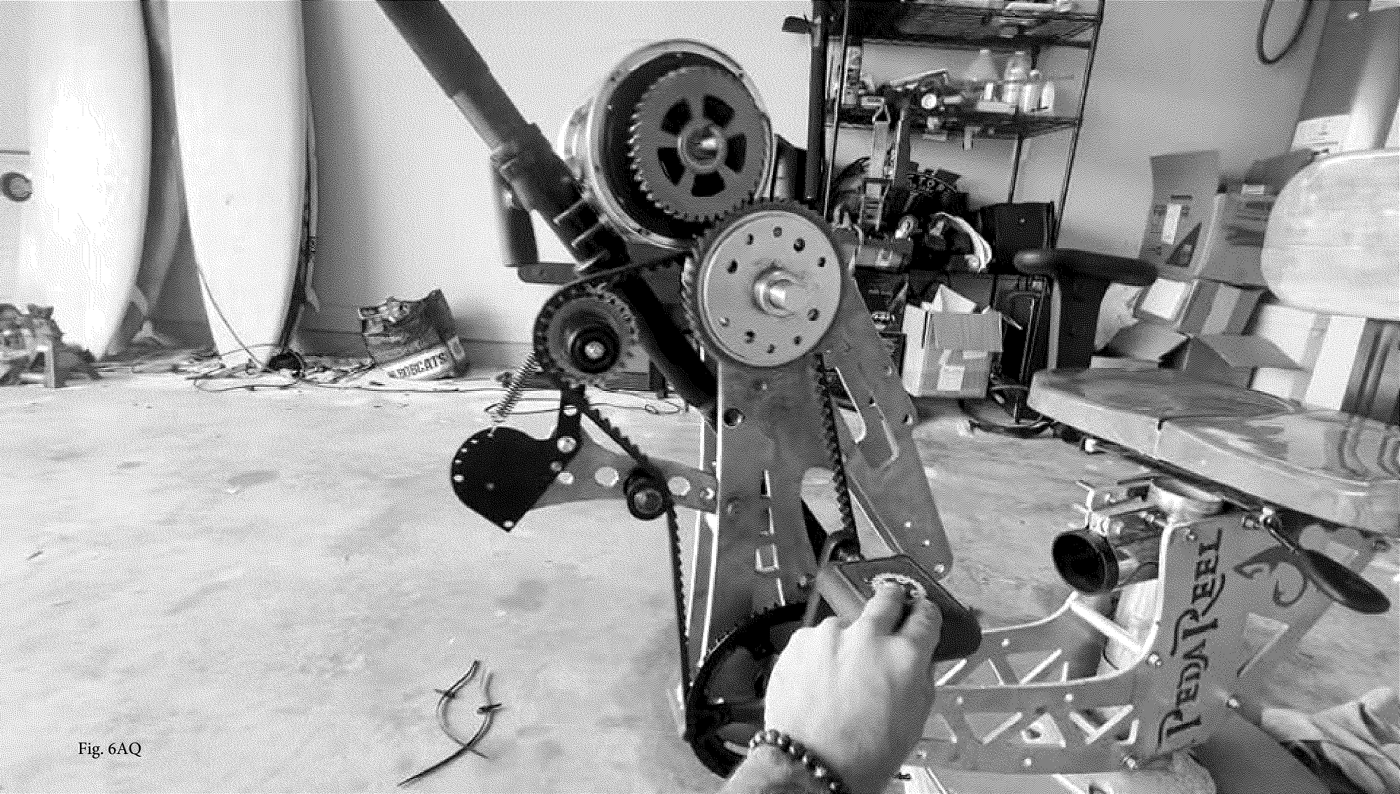

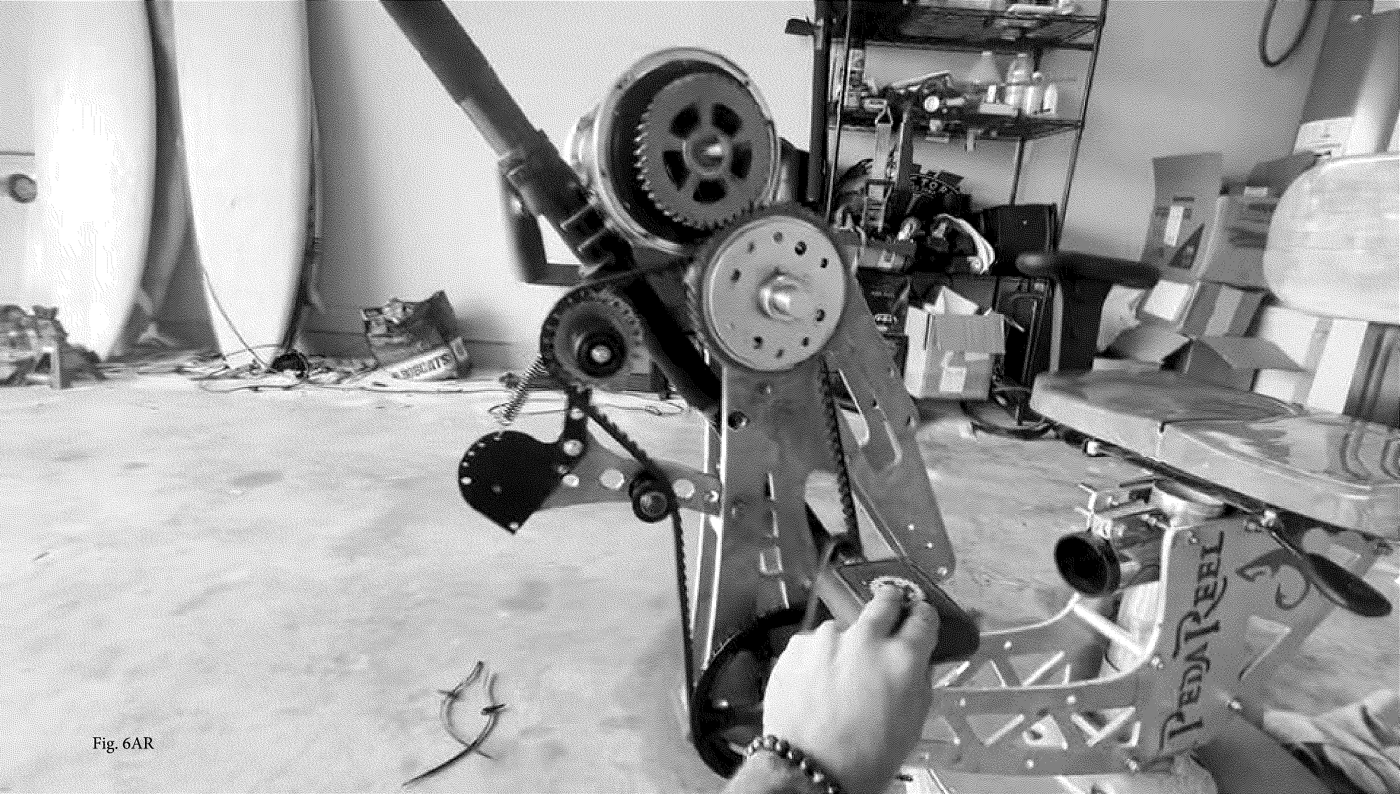

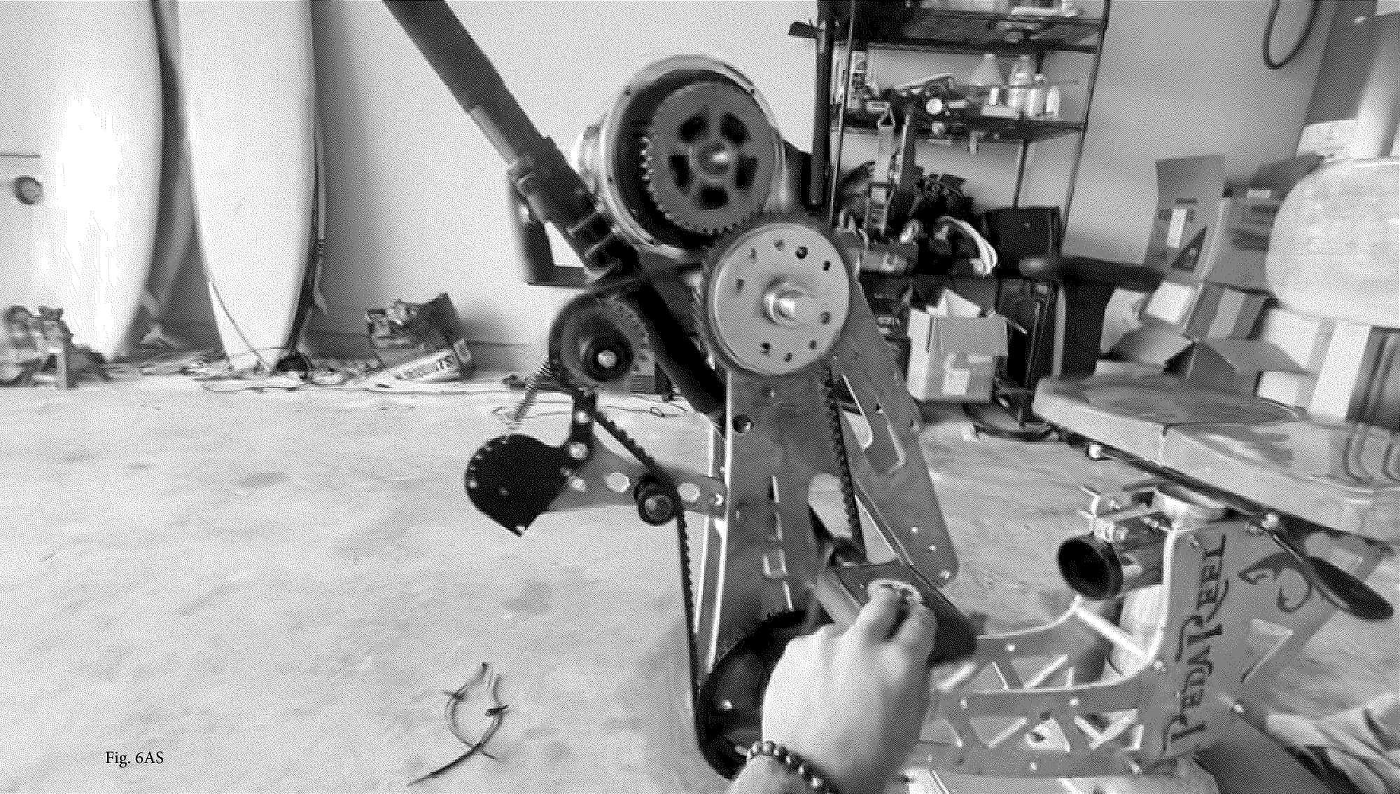

In one embodiment, an upright portion of the fighting chair that supports the reel and rod can be fixed or adjustable in height and/or angle relative to the deck of the boat. While one embodiment gimbals the fighting chair to a pedestal mounted to a boat deck, another embodiment can fixedly or rotatably mount the fighting chair to a trailer mount of a truck or other vehicle such as shown in FIG. 6. In another embodiment, the foot operated adapter mechanism is not part of a “fighting chair” but instead is part of any other structure such as conventional seat, a fishing kayak, an exercise bike, etc. allowing the angler to pedal while fishing.

All patents and publications cited above are hereby incorporated by reference.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. An adapter comprising:
a spool shaft configured to rotate a spool in a line-retrieval rotational direction to retrieve fishing line onto the spool; and
a mechanical coupling arrangement mechanically connected between at least one rotary foot-operated rotatable pedal and the spool shaft, the mechanical coupling arrangement being configured to:
(a) apply rotational energy developed by the at least one rotary foot-operated pedal to the spool shaft to rotate the spool in the line-retrieval rotational direction to retrieve fishing line onto the spool, and
(b) decouple the at least one rotary foot-operated pedal from interfering with rotation and controlled drag of the spool in a line-deployment rotational direction while deploying fishing line from the spool.

2. The adapter of claim 1 wherein the line-retrieval rotational direction is opposite the line-deployment rotational direction.

3. The adapter of claim 1 wherein the mechanical coupling arrangement comprises a one-way clutch coupler.

4. The adapter of claim 1 wherein the spool is part of a fishing reel.

5. The adapter of claim 1 wherein the mechanical coupling arrangement comprises at least one chain or toothed belt.

6. The adapter of claim 1 wherein the at least one rotary foot-operated pedal comprises a left foot pedal and a right foot pedal.

7. The adapter of claim 1 further comprising a rod holder mounted to project from or near the spool.

8. The adapter of claim 1 wherein the mechanical coupling arrangement comprises first and second sprockets, the first sprocket connected to the at least one rotary foot-operated pedal, the second sprocket connected to the spool shaft, the first and second sprockets being coupled by a one-way clutch to rotate together only in a predetermined rotation direction by a belt or chain.

9. A fighting chair comprising:
structure having a seat thereon, the structure being supported on a pedestal configured to allow the seat to rotate,
a rod holder disposed on the structure,
a reel mount separate from the rod holder disposed on the structure,
foot pedals rotatably mounted to the structure, and
a mechanical coupling that couples rotational energy from rotating the foot pedals to cause a reel mounted on the reel mount to retrieve line.

10. The fighting chair of claim 9 wherein:
the reel includes a spool shaft connected to rotate a spool in a line-retrieval rotational direction to retrieve fishing line onto the spool; and
the coupling is mechanically connected between the foot pedals and the spool shaft, the mechanical coupling arrangement being configured to:
(a) apply rotational energy developed by the foot pedals to the spool shaft to rotate the spool in the line-retrieval rotational direction to retrieve fishing line onto the spool, and
(b) decouple the foot pedals from interfering with rotation and controlled drag of the spool in a line-deployment rotational direction while deploying fishing line from the spool.

11. The fighting chair of claim 10 wherein the line-retrieval rotational direction is opposite the line-deployment rotational direction.

12. The fighting chair of claim 9 wherein the coupler comprises a one-way clutch coupler.

13. The fighting chair of claim 10 wherein the spool is part of the reel and is configured to hold windings of fishing line.

14. The fighting chair of claim 9 wherein the mechanical coupling arrangement comprises at least one chain or toothed belt.

15. The fighting chair of claim 9 wherein the foot pedals comprise a left foot pedal and a right foot pedal.

16. The fighting chair of claim 9 wherein the rod holder is mounted to project from or near the spool and is mounted to the structure independently of the reel.

17. The fighting chair of claim 9 wherein the mechanical coupling arrangement comprises first and second sprockets, the first sprocket connected to the pedals, the second sprocket connected to the spool shaft, the first and second sprockets being coupled by a one-way clutch to rotate together only in a predetermined line retrieval rotation direction by a belt or chain.
